(19) United States
(12) Patent Application Publication
(10) Pub. No.: US 2003/0018558 A1
(43) Pub. Date: Jan. 23, 2003

(54) System, method and computer program product for online financial products trading

(76) Inventors: Reid R. Heffner, Arlington, VA (US); Gabriel D. Minton, Keedysville, MD (US); Jonathan Poletti, Middletown, MD (US); Dean Sondregger, Ashburn, VA (US); Kathy E. Kelbaugh, Voorhees, NJ (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/730,825

(22) Filed: Dec. 7, 2000

Related U.S. Application Data
(63) Continuation-in-part of application No. 09/475,278, filed on Dec. 30, 1999, now abandoned.
Application No. 09/475,278 is a continuation-in-part of application No. 09/270,837, filed on Mar. 18, 1999, now Pat. No. 6,233,566.
(60) Provisional application No. 60/114,578, filed on Dec. 31, 1998.

(51) Int. Cl. G06F 17/60

(52) U.S. Cl. 705/37

(57) ABSTRACT

A system, method and computer program product are provided for an online, centralized financial products exchange system which automates and standardizes the secondary market process by applying a data transformation and mapping process to loan information and instantly matching available loans and loan pools with the purchasing criteria of buyers. The system transforms the loan information that is entered by the user into a standardized data format. Data is filtered before being forwarded to a subscriber using a pre-defined criteria selected by the subscriber. The system includes a plurality of Web servers for receiving and providing loan information from and to subscribers on several Web clients and a database server for searching the predefined rules to match potential buyers with sellers. The system also includes a database for storing information relating to negotiations (i.e., bidding) for the sale of loans and for storing predefined rules for pre-registered buyers and sellers. The system further includes a database and server for storing risk/return information that is made available to subscribers for analysis.

### CROSS-REFERENCE TO RELATED APPLICATIONS

This is a continuation-in-part application of the application entitled “System, Method and Computer Program Product for Online Financial Products Trading”, U.S. application Ser. No. 09/475,278, filed Dec. 30, 1999, pending, which is a continuation-in-part application of the application entitled “System, Method and Computer Program Product for Online Financial Products Trading”, U.S. application Ser. No. 09/270,837, filed on Mar. 18, 1999, pending, the disclosure of which are incorporated herein in their entirety by reference, and which claims the benefit of application Ser. No. 60/114,578, filed Dec. 31, 1998.

### BACKGROUND OF THE INVENTION

1. Field of the Invention

The present invention relates generally to a centralized exchange system for creating a marketplace to buy and sell financial products, and more particularly to a centralized exchange system for the trading of loans.

2. Background Art

Over the past several years, there has been an explosion of computers, and thus people, connected to the global Internet and the World-Wide Web (WWW). This increase of connectivity has allowed computer users to access various types of information, disseminate information, and be exposed to electronic commerce activities, all with a great degree of freedom. Electronic commerce includes large corporations, small businesses, individual entrepreneurs, organizations, and the like, who offer their information, products, and/or services to people all over the world via the Internet.

Financial products are one of the types of products available through electronic commerce activities. Consumer loan products, one example of financial products available through electronic commerce, are typically divided into two categories—conforming (or conventional) loans and non-conforming (or non-conventional) loans. Conforming loans are low risk loans and include traditional primary residence mortgage loans to consumers with good credit histories and loans to consumers who qualify under certain government-backed loan programs (e.g., Federal Housing Administration (FHA) or the Veterans Administration (VA)).

In contrast to conforming loans, non-conforming loans pose a higher risk for lenders than conforming loans. Non-conforming loans include loans to consumers with bad credit (e.g., due to bankruptcy or foreclosure), non-income verification loans (e.g., loans to consumers who have been self-employed for less than 2 years), loans for non-owner occupied properties, loans for non-conventional properties, some commercial (business) loans, and High-Loan-To-Value (HLTV) loans. Generally, non-conforming loans are loans that do not meet the underwriting guidelines of Fannie Mae or Freddie Mac.

For example, HLTV loans are typically obtained by consumers, who by using equity in their homes as collateral, consolidate other (e.g., credit card) debt. These types of loans involve a lender who loans a consumer an amount of money in excess of 100% of the consumer's equity in their home. For example, an “HLTV 125” loan refers to a loan made to a consumer for 125% of the value of their home.

In more detail, an “HTLV 125” loan would work as follows. A consumer who owns a home valued at $100,000, and has a first mortgage on that home for 80% of the value (i.e., $80,000), would have $20,000 in equity. If the consumer has credit card debts and wanted to borrow money to consolidate these debts, a lender may offer the consumer an HLTV loan. In one scenario, the consumer may be able to obtain a loan for the $20,000 equity in their home, and borrow against an additional 25% of the value of the home (i.e., another $25,000) for a total loan of $45,000. As such, there would now be loans covering 125% of the value of the consumer's home.

Under the current tax laws, this type of loan provides the consumer (i.e., borrower) with a tax advantage because a certain amount of the interest paid on this loan can be deducted on the borrower's income tax returns. In contrast, any interest paid on credit card debt cannot be deducted. Further, the interest rate that a borrower may be able to obtain for an HLTV loan is often less than the interest rate charged by most credit card companies, but amortized over a longer period of time. Thus, consolidating by obtaining an HTLV loan, lowers the borrower's monthly payments and allows the borrower to repay debts owed more quickly. As such, these types of loans are often attractive to consumers.

Non-conforming loans generally are also attractive to lenders because the market will often allow lenders to charge a higher interest rate than on a conventional first mortgage loan (although this interest rate is still lower than that charged by credit card companies). Because lenders are offering the borrower a loan for more than the value of the collateral (e.g., the borrower's home), however, there is a certain amount of risk involved in making such loans. As such, lenders have developed certain rules (based on criteria, such as underwriting criteria) to minimize their risks and exposure when making non-conforming loans.

An example criterion used by lenders include identifying potential borrowers in a certain income bracket. This income bracket must be high enough so that there is small likelihood of default, but not so high that the borrower is likely to prepay the loan—thereby decreasing the amount of interest collected by the lender over the life of the loan.

Another criterion often considered by lenders making loans is the borrower's credit rating. A consumer's credit rating is an indication of their ability to pay outstanding debts. Credit rating companies, such as Trans Union Corporation of Chicago, Ill. Experían, Inc. (formerly TRW) of Orange, Calif. and Equifax, Inc. of Atlanta, Ga., collect certain information on individual consumers and assign each a credit rating based on this information.

One method of obtaining a credit rating is known as a “FICO score” which is based on a mathematical model developed by Fair, Isaac, and Company, Inc. of San Rafael, Calif. A FICO score is based on many factors including how a consumer pays their bills, outstanding debt, how long a consumer has had credit, types of credit a consumer has, and how many times a consumer has recently applied for or opened new lines of credit.

Borrowers are typically graded according to their borrowing habits. “A” borrowers have credit ratings which indicate that they will be able to repay a loan. The ratings given to borrowers fluctuate between institutions, with each institution defining loan borrowing criteria a little differently. For example, instead of just an “A” borrower, an institution may have an A− or B+ category for borrowers.

Loans can also be extended to “sub-prime” borrowers—individuals with “B” or “C” credit ratings. These subprime borrowers have relatively lower credit scores. Loans in this case may be the borrower's first mortgage on a home, e.g., for which the borrower has a risky credit rating, but they have collateral, such as a home, which has not been previously mortgaged. Similarly, loans can also be extended to borrowers who are seeking a “jumbo” loan—a loan of $225,000 or more. All of these types of loans, because of the various risks associated with each, often command a higher interest rate than conforming loans.

Loan Life Cycle

Referring to FIG. 1, a time line of a typical loan life cycle 100 is shown. The first phase in the loan life cycle 100 is a marketing phase 104. In marketing phase 104, marketing companies target certain potential borrowers to receive advertisements offering loans. For example, potential borrowers may be targeted by geographic region (e.g., by zip code or area code). This advertising can be distributed through many sources, such as via telephone advertising campaigns, via mass mailings, or via the Internet.

The second phase in the loan life cycle 100 is a loan origination phase 108. In loan origination phase 108, the potential borrower contacts the lender (e.g., mortgage bank), or a broker working with a lender, by phone or electronic mail, to request a loan. Usually, this first contact between the potential borrower and the lender is telephonic, as call centers are typically set up to handle responses to the advertising campaigns. After being switched away from the call intake portion of the call center, certain information is collected from the consumer by a loan agent. The loan agent also works with the potential borrower to agree on a loan amount, interest rate, points, duration or term of the loan and other features of the loan. The loan agent then sends this information to a loan processor and a loan underwriter for approval.

The loan processor processes the paperwork necessary for completing the loan and the underwriter makes sure the underwriting guidelines are met. During the underwriting process, the underwriter decides whether to make a loan to a potential borrower based on credit, employment, assets and other factors and then matches the risk of making such a loan to an appropriate rate and term or loan amount. Underwriting guidelines are the rules that the underwriters use to assign risk to a particular loan and to determine whether or not to approve the loan for a particular rate, term and loan amount. As such, the underwriter validates the interest rate and points assigned by the loan agent. If these validated terms are acceptable to both the lender and borrower, the loan is approved, and the loan agent then works with the loan closer to finalize the loan, issue a check, and forward it to the borrower.

The loan may then enter a third phase, known as a loan wholesaling phase 112. Once the lender has made the loan, they often try to sell the loan to investors, e.g., mortgage bankers, insurance companies, institutional investors, etc. Alternatively, a loan may be transferred within a company to a different department that handles the wholesaling of loans. Lenders may flow loans to mortgage bankers (i.e., pass a single loan at a time), or send bulk loans to mortgage bankers (i.e., pass several loans referred to as a “pool” of loans). The mortgage banker then separately pools the purchased loans and advertises the loan pools to look for investors. The role of the mortgage banker is to buy loans from the loan origination organization (e.g., mortgage bank) or lender, and then pool them in such a way to make them attractive to investors.

Mortgage bankers have also developed rules that they use to decide which loans to purchase and how to pool them for sale. These rules are based on many of the same criteria used by the lender in determining whether to originate a loan to the borrower. Similarly, loan origination organizations or lenders consider the rules of the mortgage bankers when making loans, so that their loans look attractive to the mortgage bankers.

The mortgage banker pools the loans and advertises to investors who may be interested in purchasing a pool of loans. For example, a typical pool may consist of 300 loans with an estimated total value of $30 million or may consist of 3000 loans with an estimated total value of $300 million. The potential investor, typically a bank, securitization company or another mortgage banker, will review the information for each loan in the pool and either accept, decline, or reserve its decision for each loan in the pool. Then, the investor may send a revised pool back to the mortgage banker with an offering price to buy the revised pool. The mortgage banker then may add other loans to the pool and resend the pool to the investor for review. This negotiation (or bidding) continues until a sale is made or rejected. The rejected loans may be used in other pools or may be used directly for securitization, as discussed below.

Once an investor purchases or otherwise acquires a pool of loans, the loans may enter a fourth phase, referred to as a securitization phase 116. In securitization phase 116, the investor groups several pools of loans together into a larger pool, and uses them collectively as collateral to back securities (i.e., mortgage-backed securities such as bonds). These larger pools can then be offered for sale to buyers on the secondary market. Typically, these groups of loan pools are valued in the range of $50 million-$1 billion. Because the company that purchases the loan pools and uses them to back securities is personally responsible, there is a great deal of risk involved in these type of transactions.

Naturally, investors of the loan pools have developed certain rules for evaluating the suitability of the loans for securitization. However, the mortgage bankers' rules used for grouping certain loans together in a pool may be different from the rules used by the investor in deciding which loans it would like to purchase in a pool and the rules used by lenders in making the underlying loans in the first place. For example, the mortgage banker in an attempt to sell the low risk and high risk loans together, may want to group together loans made to borrowers with high FICO scores with loans made to borrowers with lower FICO scores. However, the investor may have rules which do not allow the purchase of any pool with a loan made to a borrower having a FICO score less than a predetermined amount. As a result, negotiations between the mortgage banker and the investor must occur in order to decide on a pool and a price that is suitable to both parties. It is important to note that although the rules are devised as guidelines for buying and selling loans, these rules may be disregarded or altered on a case-by-case basis. Further, each entity described above may frequently change its rules based on market conditions and other relevant factors.

The process for selling loans or loan pools and then negotiating about the sale is currently ad hoc. Generally, an investor will learn about a pool by calling a particular seller to see what loans or loan pools are available. The seller will then send the investor information about the loan or loan pool generally on a spreadsheet, such as Microsoft® Excel. The investor may reconfigure the information into their preferred format on the spreadsheet, delete or mark those loans from the pool that they do not wish to purchase, and send the spreadsheet with the revised pool back to the seller. This process is often clumsy and inefficient, requiring a lot of manual data re-entry between the parties.

Further, there is no mechanism, apart from person-to-person (e.g., face-to-face or over the telephone) interaction, for determining what loans or pools are for sale, what rules are being used to pool the loans, and what rules are being used by the investors to determine whether to buy certain loans. The tools that are available, such as program sheets or rate matrices, are not dynamic, i.e., they are not updated in real-time to reflect current market conditions. Instead, the existing tools are all static as they are typically updated through a manual process.

The investors service the loans, either themselves or through a separate servicing firm, and create a mortgage-backed security based on the assets (i.e., future income stream) of the pooled loans. The mortgage-backed security has an assigned interest rate based on the future capital of the pools of loans that are being securitized. The mortgage-backed securities are then generally sold, either directly or through brokerage companies, to buyers in the open market. It is important to note that the servicing rights to these loans can be sold separately from the loans. In short, the seller may be marketing to two buyers: one for the loans and one for the servicing rights to the loans.

The mortgage-backed securities are always securitized by the pool of loans, so that the loans can never be transferred again throughout the remainder of their life cycle 100. Prepayment of loans is a problem, because if a loan is prepaid the mortgage-backed security is no longer backed by all of its original underlying assets. Companies that securitize these loans have attempted to predict the amount of prepayment of loans in the pools and work this figure into a yield, however many companies have failed because they could not accurately predict the rate of prepayment or default.

The loan also follows a separate track with the consumer, concurrently with the first track described above. As shown in FIG. 1, once the loan is approved and the money is sent to the borrower, the loan enters a servicing phase 120. Servicing phase 120 consists of a servicing company sending a coupon book or monthly notice to the borrower which indicates when monthly payments are due and the amount of the payment. If the borrower is late on a payment, the servicer will contact the borrower to discuss the missed or late payment. This servicing is very methodical, in that servicing companies will often have predefined time periods for certain actions. For example, the servicing company may place a telephone call to a delinquent borrower after his payment is 10 days late, and write a letter to the delinquent borrower after his payment is 30 days late, and so on.

If the borrower becomes insolvent or delinquent in their payments, the loan enters the next phase, referred to as a claims phase 124. In claims phase 124 the servicing company may enter a claim against the borrower in a bankruptcy proceeding, or file a lawsuit in court to foreclose on the mortgaged property or secure an order to garnish the borrower's wages. When the value of the loan is greater than the value of the underlying collateral, lenders are reluctant to enter this phase, because it generally results in the lender losing money. In particular, when one of these loans is used to back a security, and the borrower defaults on the loan, the collateral used to back the security disappears. This has, in the past, lead to the demise of many securitization companies that back securities with such loans.

On both tracks, the loan then enters a final phase, referred to as a loan termination phase 128. Generally the loan enters loan termination phase 128 when the loan has been fully paid, be it at the end of the loan term (e.g., 30 year fixed loan) or earlier (i.e., prepayment).

Many financial institutions participate in the buying of mortgages that they either maintain in portfolio (and may or may not service), resell at a later time, or pool together to form a mortgage-backed security, used as a financial instrument for investors. Over time, some of these mortgages become non-performing or are re-financed by the borrower, thereby changing the value of the portfolio. In order to maintain and increase their mortgage portfolio, the buying institutions take advantage of all avenues of loan acquisition. Since the buying institutions are limited in their ability to saturate the marketplace themselves, they rely on correspondents to keep their loan pipeline full. The buyer would end up spending inordinate amounts of time and money to open up offices, but with the use of correspondents they can acquire loans from any part of the country. Additionally, from the consumer's point of view, they may be more likely to deal with a local institution rather than a remote one.

Correspondents are organizations that may be able to fund their own loans, or they may use a warehouse line of credit to close the loan in their own name. They may even hold onto the loan for a short time. These organizations can be mortgage banks, local banks or similar lending institutions. They may choose to sell only a portion of the loans that they originate to a buyer. Various situations can cause this to happen. It may be a local bank that wishes to originate mortgages for the community, but because of deposits, can only maintain a small portion of the loans in their own portfolio.

The relationship between a correspondent and a buyer is based on training, communication and trust. Large buying organizations spend time and money in training their network of correspondents. This is done to save them on the back end, so they can be assured of getting the documents delivered in the manner that is necessary for their internal procedures and systems. They also have to train their correspondents in their programs and rate sheets. These documents are the primary method of continual communication between the buyer and the seller. It is essential that the correspondent keep up-to-date on the latest programs and rates so that the loans they originate can be sold to the buying institution. Many buying institutions will negotiate with correspondents to forecast future production. If the correspondents exceed their agreed to volume, the buying institution may even provide a sliding scale for bonuses. As time goes on, correspondents may also be afforded a greater degree of authority to act on behalf of the buying institution. Some correspondents are designated as having “delegated underwriting” authority. This means that the buyer trusts the correspondent enough to allow it to underwrite the buyer's loans and allows the correspondent to bypass the internal underwriting process of the buying institution.

Buying institutions are always interested in expanding their correspondent network and increasing correspondent volume. Buying loans from correspondents allows the buying institutions to expand nationwide without incurring the overhead of opening offices and employing additional people. Typically, the buying institution assigns an Account Manager to manage and track various correspondents. This is also the person who responds to any concerns that a correspondent may have about a new buying program or rate sheet. Maintaining relationships with correspondents is competitive, especially if loan originations decrease for market reasons.

Therefore, in view of the above, what is needed is a system, method and computer program product for an online (i.e., Internet, Intranet, or Extranet) system for buying and selling financial products. Such a system would create a “marketplace” in which investors (i.e., buyers) and sellers of these financial products could go to place their products for sale, to ascertain what financial products are for sale, and to determine what the price is in the “marketplace” for certain types of products.

Further, what is needed is a system, method and computer program product that archives all of the loan information and selection and pricing information for access by its users in a standardized format.

Still further, what is needed is a system, method and computer program product that automates correspondent delivery of loan products to improve and expand the relationship between a buying institution and its correspondent and to increase profitability.

### BRIEF SUMMARY OF THE INVENTION

The present invention is a system, method, and computer program product for the online trading of financial products. The invention receives loan information for a loan from a subscriber and stores that loan information in a database. The subscriber can designate a list of individuals to whom notifications of the loan information should be sent. These individuals are notified and allowed to access the loan information via the system of the invention. Each individual is allowed to submit a bid on the loan and the subscriber can accept the bid to complete a trade.

The invention further provides a system, method and computer program product for evaluating financial products. This invention receives loan information for a plurality of loans in a loan pool from a first subscriber and receives a program matrix including a list of criteria from a second subscriber. The invention then compares the loan information for the loans in the loan pool against the list of criteria in the program matrix and provides the results of the comparison to the second subscriber to show which loans in said loan pool meet the subscriber's criteria. The subscriber can have different program matrices for different types of loan products.

The invention also allows the second subscriber to create credit slots with a list of criteria for each of said credit slots. The invention compares the loans in the loan pools to the credit slot criteria and places each loan in the loan pool in its slot. Based on the credit slotting and a pricing model received from the second subscriber, the invention can automatically price the pool and automatically submit a bid on the pool to the first subscriber. The invention can also calculate a price for a pool based on a yield calculation which is determined by the percent yield that the subscriber wishes to recover.

The invention further provides a system, method and computer program product for trading servicing rights for loans. This invention receives loan information and servicing information for a loan and stores that loan and servicing information in a database. The subscriber can later refresh the loan information and servicing information to update the information. The refreshed loan and servicing information is stored in a database. The invention can provide output to the user showing how the loan information and servicing information changed over time.

The invention further provides a system, method and computer program product for performing automated due diligence of a loan. The invention receives loan detail information for the loan electronically from a subscriber and also receives scanned loan information from loan documentation for the loan. Loan detail information is extracted from the scanned loan information using optical character recognition. The invention then compares the extracted loan detail information with the electronic loan detail information to identify discrepancies.

The invention further provides a system, method and computer program product for trading future loan pools. The invention receives weighted average loan information for a future loan pool from a first subscriber and allows a second subscriber to review this future loan pool and submit a bid on it. The first subscriber can then accept the bid to complete the trade.

One advantage of the present invention is that it provides a centralized “marketplace” for trading in certain types of financial products, including loan products, future loan pools to be created, and servicing rights.

Another advantage of the present invention is that it provides for private trading if a subscriber does not wish to open up his trading activity to all members of the marketplace.

Another advantage of the present invention is that it allows the buyer to enter his own program matrices and pricing models to enable the system to automatically credit slot and price the loans in a loan pool.

Another advantage of the present invention is that it provides for automated due diligence of the loans in a loan pool after a trade has been completed.

Further features and advantages of the invention as well as the structure and operation of various embodiments of the present invention are described in detail below with reference to the accompanying drawings.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a time line showing the typical life cycle of a loan;

FIGS. 2A and 2B are block diagrams illustrating the system architecture of a first embodiment of the invention, showing network connectivity among the various components;

FIG. 3 is a high level block diagram showing the interfaces that occur during the operation of the exchange system according to the first embodiment of the invention;

FIG. 4 is a block diagram illustrating the software architecture according to a first embodiment of the invention, showing communications among the various components;

FIG. 5 is a flowchart showing the data flow between the centralized exchange system and a marketing company, according to the first embodiment of the invention;

FIG. 6 is a flowchart showing the data flow between the centralized exchange system and a loan origination company, according to an embodiment of the invention;

FIGS. 7-14 are exemplary graphical user interfaces according to a loan origination system of the invention;

FIGS. 15A-15D are flowcharts showing the buying and selling of loans using the centralized exchange system, according to the first embodiment of the invention;

FIG. 16 is a flowchart showing the interaction between the centralized exchange system and a trust company, according to an embodiment of the invention;

FIG. 17 is a flowchart showing the data flow between the centralized exchange system and a servicing company, according to an embodiment of the invention;

FIGS. 18 and 19 are exemplary graphical user interfaces according to an embodiment of the invention;

FIG. 20 is a block diagram of an exemplary computer system useful for implementing the invention;

FIGS. 21A-21C and 22-24 are exemplary graphical user interfaces to enable a subscriber to engage in trading according to an embodiment of the invention

FIG. 25 is a block diagram illustrating data flow and formatting between the exchange system and a subscriber;

FIG. 26 is a block diagram illustrating the data transformation and mapping (DTM) process of the invention;

FIGS. 27A, 27A-1 and 27B are block diagrams illustrating the system architecture of a second embodiment of the invention, showing network connectivity among the various components; and

FIG. 28 is a high level block diagram showing the interfaces that occur during the operation of the exchange system according to the second embodiment of the invention.

FIG. 29 is a sample program matrix to be used in the present invention.

FIG. 30 is a sample credit slotting matrix to be used in the present invention.

### DETAILED DESCRIPTION OF THE INVENTION

TABLE OF CONTENTS

| I. | Overview | |
|---|---|---|
| II. | Criteria for Evaluating a Loan | |
| III. | System Architecture | |
| IV. | Secure System Interfaces | |
| V. | Software/Hardware Architecture | |
| VI. | System Operation | |
| | A. | Marketing |
| | B. | Loan Origination |
| | C. | Exchange System 200 |
| | D. | Trust (Due Diligence) |
| | E. | Servicing |
| | F. | Securitization |
| | G. | Brokerage |
| | H. | Credit Rating |
| | I. | Risk/Return |
| VII. | Environment | |
| VIII. | Data Transformation and Mapping Process | |
| IX. | Subscriber Tools | |
| X. | Value Added Services | |
| | A. | Automated Underwriting |
| | B. | Automated Pricing |
| | C. | Rate Locking |
| | D. | Loan Product Comparison Mapping |
| | E. | Credit Scoring/Credit Updates |
| | F. | CRA Qualification |
| | G. | Appraisal Updates |

| | |
|---|---|
| XI. | Conclusion |

I. Overview

The invention relates to a system, method, and computer program product for analyzing, valuating, buying and selling financial products, such as loans. The loans contemplated for use with the invention include, for example, conforming and non-conforming loans, such as fixed, adjustable, and balloon mortgages, residential mortgage loans, multi-family mortgage loans, commercial mortgage loans, farm mortgage loans, consumer and commercial installment loans, small business loans, student loans, vehicle/boat/plane loans and leases, and business equipment leases.

Although the embodiment described herein relates specifically to loans, it would be apparent to one skilled in the relevant art(s) that the invention could also be used for analyzing, valuating, buying and selling a variety of other financial products, including, for example: (1) revolving lines of credit, such as credit card accounts and home equity lines of credit, (2) annuities, (3) insurance products, (4) consumer and commercial assets, such as certificates of deposit, and (5) servicing rights.

In an embodiment of the invention, an organization provides a centralized exchange system for loans. Subscribers to the system (i.e., brokers, correspondents, mortgage bankers, servicing companies, investors, capital markets brokers, etc.) may engage in trading that optimizes the types of loans being originated by lowering the risk associated with loan origination thereby maximizing return on each loan.

The centralized exchange system of the invention creates a marketplace for trading in financial products, such as loan products. What is meant by marketplace, is a central service that each entity in the above-described loan life cycle can use for handling of loans. This type of system is referred to as an “end-to-end” system, because it is developed for each entity from the beginning to the end of the loan life cycle 100. The centralized system can also handle just a portion of the “end-to-end” system by integration with a subscriber's system. For example, if a subscriber has its own loan origination system, the system of the invention can be integrated with this subscriber's system to allow for originated loans from the subscriber's system to be uploaded into the system of the invention for sale.

Some of the features provided by the system of the invention include loan origination, loan pooling, publishing loans and loan pools for sale, and negotiating for sale of loans or loan pools. Further, the centralized exchange system provides connection to certain service providers for services such as automatic institution of due diligence investigations and/or loan servicing. The centralized exchange system also archives and/or warehouses trading data, servicing data and other loan data to provide risk-return information based on certain criteria (e.g., mortgage insurance data, future loan value indices, pricing models, and historical valuation data). Still further, the centralized exchange system stores subscribers' trading rules and can notify a subscriber when loan products complying with its rules are published. The centralized exchange system may also notify subscribers (e.g., by electronic mail, pager, telephone, cellular telephone, personal digital assistant, facsimile, etc.) when an offer for a loan or loan pool has been made and/or when an offer has been accepted or rejected.

Such a system could allow industry participants such as brokers, correspondents, mortgage bankers, servicing companies, investors, and capital markets brokers to intelligently originate and trade in loans not only to better hedge against risks, but also to speculate for profit.

In addition, information such as whether an applicant or census tract of property qualifies under the Community Reinvestment Act (CRA), will also be available. The information on loans which would qualify under the CRA would be helpful to buyers who are looking to fulfill federally mandated requirements for the purchasing of CRA-type loans. By flagging loans that meet CRA requirements, the invention offers buyers a centralized location to quickly find qualified loans and meet their federal purchase obligations.

In one embodiment of the invention, additional value added services may also be available to the subscriber, such as automated underwriting, automated pricing, rate locking, loan product comparison mapping, credit scoring, credit updates, CRA qualification, and appraisal updates.

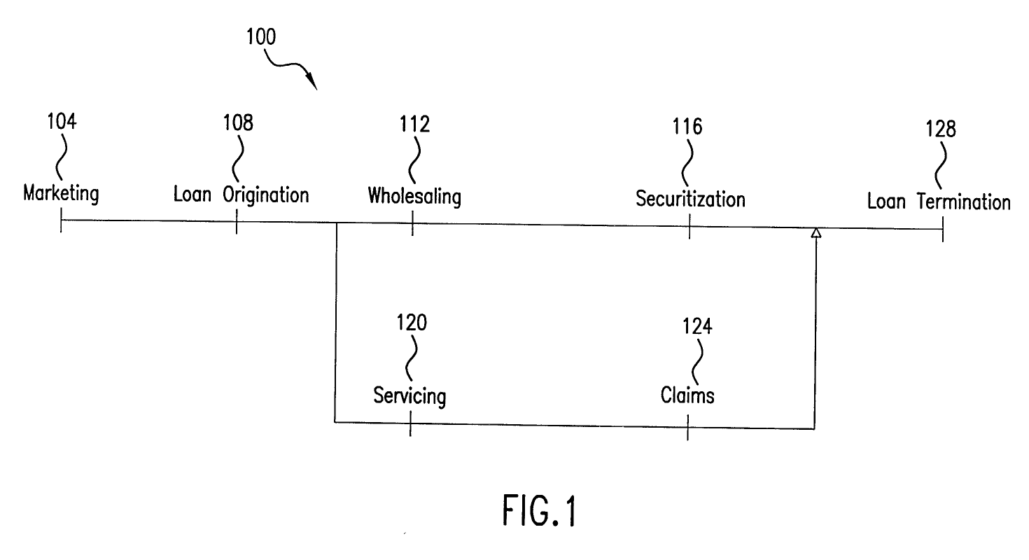

The centralized exchange system provider organization supplies an infrastructure, secure protocol, and facilities so that subscribers may utilize the network to address their trading needs with little or no modification to the subscriber's current infrastructure required for use of the system of the invention. As detailed above with reference to FIG. 1, the invention addresses the trading needs of the subscribers summarized in Table 1 below. The subscriber names presented in Table 1 are given by way of example, and, as will be apparent to one skilled in the relevant art(s), may vary according to industry custom.

TABLE 1

| | DESCRIPTION (PHASES |
|---|---|
| SUBSCRIBER | OF LIFE CYCLE 100) |
| Marketing Company | Entities that advertise lenders' financial |
| | products to Consumers (phase 104). |
| Broker | Individuals hired on an agent basis who |
| | bring together borrowers and lenders (phase |
| | 108). |
| Mortgage Bank | Banks or other lending entities that market |
| Correspondent | and originate loans directly to consumers. |
| | They typically then sell the individual loans |
| | or loan pools (phases 104-108). |
| Servicing Company | Entities that, on behalf of owner of the loan, |
| | monitor and collect monthly payments from |
| | the Borrower, and may institute proceedings |
| | against borrower who are delinquent or in |
| | default (phases 120-124). |
| Mortgage Banker | Entities that purchase loans (in flow or in |
| | bulk) from different Lenders and then |
| | separately pool them together for resale |
| | (phase 112). |
| Investor | Entities that purchase loan pools from |
| | wholesalers and group the pools together |
| | to create mortgage-backed securities (i.e., |
| | securitization), which are then typically |
| | sold in the secondary market (phases 116). |
| Capital Markets | Entities that act on an agent basis to |
| Broker/Brokerage Company | bring together Investors and Buyers (phase |
| | 116). |
| Securities Credit Rating | Entities that, typically on behalf of brokerage |
| Agency | companies, rate (i.e., determine over- |
| | capitalization) the mortgage-backed |
| | securities created by Investors (phase 116). |
| Securities Buyer | Individuals or Entities that purchase |
| | (and trade) mortgage-backed securities |
| | (phase 116). |

Each subscriber of the centralized exchange system supplies the system with information about its trade activities with each of the other subscribers on the system. The centralized exchange system uses this information along with market data in several ways as will be described below.

The invention is described in terms of the above example. This is for convenience only and is not intended to limit the application of the invention. In fact, after reading the following description, it will be apparent to one skilled in the relevant art(s) how to implement the following invention in alternative embodiments (e.g., other types of loans and other financial products).

The terms “subscriber,” “user,” “person,” “buyer,” and “seller” are used interchangeably throughout herein to refer to those who would access and use the exchange system of the invention.

II. Criteria for Evaluating a Loan

The embodiment of the invention discussed herein relates to the trading of loans, and, thus, relates to the valuation of the loans and loan pools. In the relevant art(s), certain criteria are commonly used for the valuation of loans. In an embodiment of the invention, subscribers can create, remove and modify rules, based on these criteria, to set up a subscriber's own “preselected rules” to filter the loan or loan packages before purchase. Examples of these loan valuation criteria are provided in Table 2 below.

TABLE 2
LOAN VALUATION CRITERIA

Loan Amount
Credit Score
Appraisal Value of Property
Total Monthly Income
Total Monthly Debt
Assets and Liabilities
Term of Loan
Type of Loan
Interest Rate
Loan/Value Ratio
Debt/Income Ratio
Purchase Balance
Original Balance
State

As will be apparent to one skilled in the relevant art(s), many other criteria may exist on which subscribers may wish to base their purchase rules.

An example of a preselected rule that a buyer may use is if the buyer wants to purchase only those loans with an interest rate of 13% or greater and a loan/value ratio of 115 or less. Different buyer companies create their own rules, according to their business model. Companies use these rules to filter available loans to minimize risks associated with purchasing loans. These rules can be preselected and incorporated into a Rules Based Filter in the exchange system of the invention. Further, the subscribers can access historical loan data via the system of the invention to develop new rules to further assist in minimizing risk.

In one embodiment, subscribers can monitor other subscriber's rules in order to originate or acquire loans or loan pools that will be easy to sell and that will command a higher price. Further, each subscriber can post program matrices, underwriting guidelines, and partner due diligence requirements, which assist sellers in determining potential buyers for their loan or loan pools and which assist buyers in analyzing the criteria used to originate loans that are for sale.

III. System Architecture

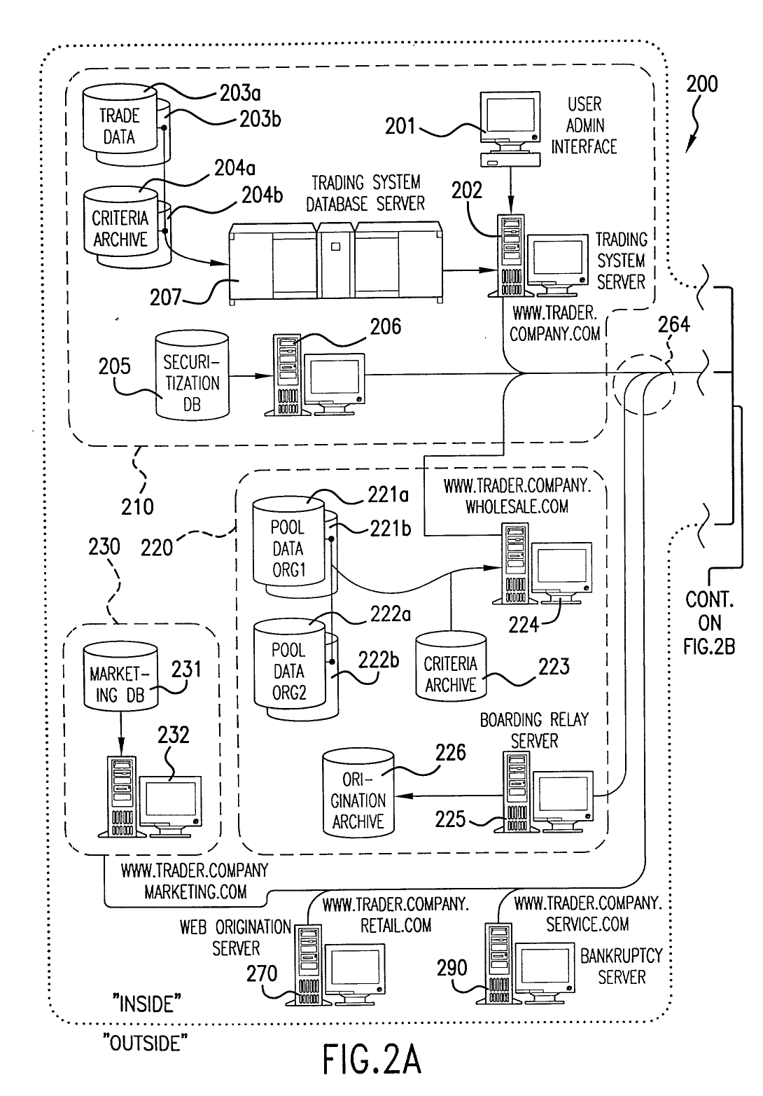

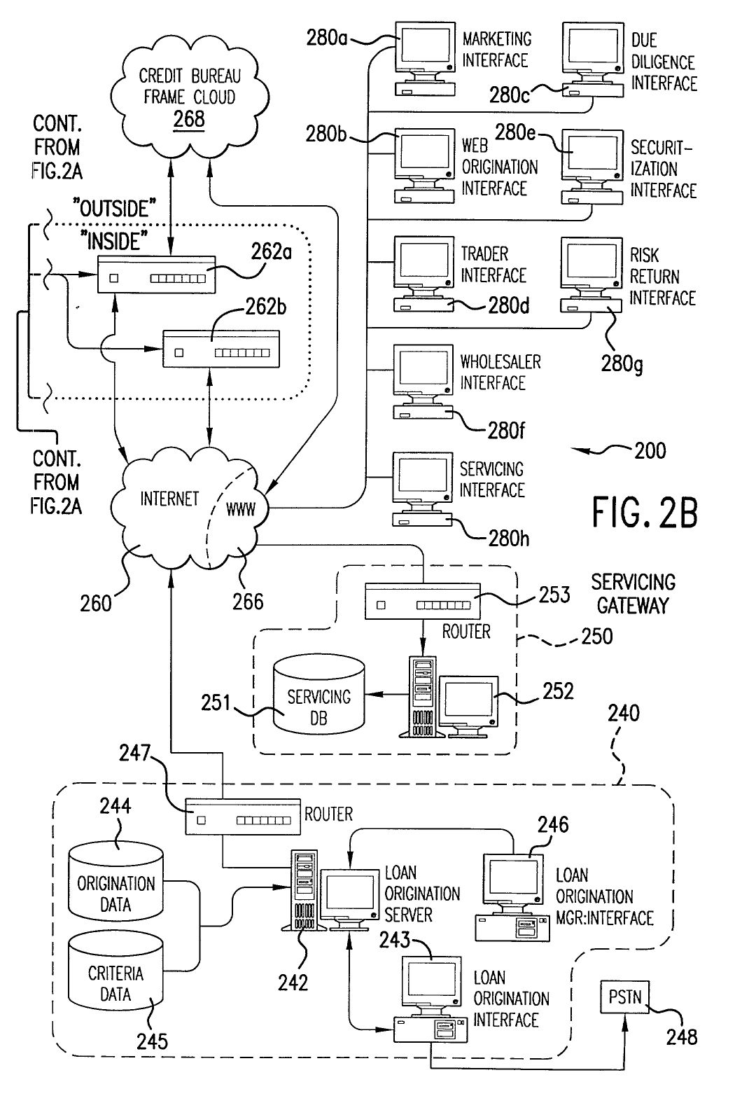

Referring to FIGS. 2A and 2B, block diagrams illustrating the physical architecture of a centralized exchange system 200, according to a first embodiment of the invention, showing network connectivity among the various components, is shown. It should be understood that the particular centralized exchange system 200, shown in FIGS. 2A and 2B, is for illustrative purposes only and does not limit the invention.

The components of the exchange system 200, as shown in FIGS. 2A and 2B, are divided into two regions—“inside” and “outside.” The components appearing in the inside region refer to those components that the exchange system provider organization would preferably have as part of their infrastructure in order to create a marketplace for online trading of financial products and provide the services contemplated by the invention. As will be apparent to one skilled in the relevant art(s), all of components “inside” of the centralized exchange system 200 are connected and communicate via a private wide or local area network (WAN or LAN 264).

In contrast, the components appearing in the outside region refer to the infrastructure that the subscribers to the exchange system 200 would obtain or already have in place in order to participate in the exchange system 200. In this embodiment, the inside components and the outside components are connected via a secure exchange through the global Internet 260, running a secure communications protocol (e.g., secure sockets layer (SSL)), which includes the Worldwide Web (WWW) 266. In one embodiment, the connection to the Internet 260 is through a router. In this embodiment, the router may be replicated (“mirrored”) for fault tolerance, as shown in FIG. 2B as routers 262a and 262b. As is well-known in the relevant art(s), routers, available from vendors such as Cisco Systems, Inc. of San Jose, Calif., forward packets between networks.

The exchange system 200 includes a trading subsystem 210. The trading subsystem 210 serves as the “back-bone” (i.e., trading processing system) of the invention. The trading subsystem 210 includes a trading server 202 and an exchange system database server 207. The trading server 202 provides the “front-end” for the trading subsystem 210. Trading server 202 is a typical Web server process running at a Web site which sends out web pages in response to Hypertext Transfer Protocol (HTTP) requests from remote browsers (i.e., certain subscribers of the exchange system 200). That is, trading server 202 provides the graphical user interface (GUI) to certain users of the exchange system 200 in the form of Web pages. In an embodiment of the invention, trading server 202 may be implemented using a Windows NTT™ server platform, and database server 207 may be a Sun SPARC station platform running the Solaris operating system.

The exchange system database server 207 includes a trade database and a trading criteria archive. In an embodiment of the invention, these two databases are mirrored for fault tolerance and thus shown as databases 203a and 203b and archives 204a and 204b. The trading subsystem 210 also includes a securitization server 206 connected to a securitization database 205.

The trading subsystem 210 also includes an administrative workstation 201 (e.g., an IBM™ or compatible PC workstation running the Microsoft® Windows 95/98™ or Windows NT™ operating system) that may be used to update, maintain, monitor, and log statistics related to the trading server 202 and the exchange system 200 in general (e.g., check cards, network connections, software, hardware, etc.).

The exchange system 200 may also include a portfolio subsystem 220. The portfolio subsystem includes a portfolio server 224 that provides a GUI to certain users of the exchange system 200 in the form of Web pages. The portfolio server 224 is connected to one or more organization pool databases. In a first embodiment of the invention, there is an organization pool database that stores data for each organization that subscribes and posts pools to the exchange system 200. For example, FIG. 2A shows an organization 1 pool database and an organization 2 pool database. Both of these databases are mirrored for fault tolerance and thus shown as pool databases 221a and 221b and 222a and 222b, respectively. The portfolio server 224 is also connected to a wholesaling criteria archive 223.

The wholesaling subsystem 220 also includes a boarding relay server 225 which is connected to an origination archive 226. The relay server 225 allows data from the origination subsystem 240 (described below) to be collected and archived into the origination archive 226. This allows loan data to be immediately accessed by other subscribers of the system 200 (e.g., the servicing subsystem 250).

The exchange system 200 may also include a marketing subsystem 230. The marketing subsystem 230 includes a marketing database 231 connected to a marketing server 232 that provides a GUI to certain users of the exchange system 200.

The exchange system 200 may also include an origination server 270 and a bankruptcy server 290 that each provide a GUI to certain users of the exchange system 200. These two servers complete the inside region of the exchange system 200.

Within the outside region of exchange system 200 may be a loan origination subsystem 240. While one loan origination subsystem 240 is shown in FIG. 2B, it will be apparent to one skilled in the relevant art(s) that a plurality of loan originating entities, each with their own loan origination subsystem 240 infrastructure, may subscribe to the exchange system 200 and thus access the above-described components inside of the system.

The loan origination subsystem 240 typically includes a loan origination interface 243 workstation. In an embodiment of the invention, a consumer (i.e., borrower) would call into the subsystem 240 via the public service telephone network (PSTN) 248 to apply for a loan. A customer service agent, working for the loan originating entity would gather the information using a GUI on the interface workstation 243. Again, while one origination workstation 243 is shown in FIG. 2B, it will be apparent to one skilled in the relevant art(s) that a loan origination entity will employ a plurality of customer service agents within a call center, thus necessitating a plurality of workstations 243. The workstation 243 is connected to a loan origination server 242. Server 242 provides the back-end processing of the loan origination subsystem 240. The server 242 is connected to an origination database 244 and a criteria database 245. The loan origination subsystem 240 also includes a manager workstation 246 which allows the manager of the loan origination entity to manipulate the data in the criteria database 245 and perform supervisory functions over the customer service agents using the workstations 243. The loan origination subsystem 240 also includes a router 247—similar in functionality as routers 262a and 262b described above—which allows origination data to be securely uploaded to the inside of the exchange system 200 via the Internet 260.

During the loan origination process, the loan origination subsystem 240, via router 247 and the Internet 260, may obtain credit history data from a credit service bureau represented by a frame cloud 268.

The outside region of exchange system 200 may also include a servicing subsystem 250. The servicing subsystem 250 typically includes a servicing server 252 connected to a servicing database 251. Many servicing companies utilize mortgage service software such as the Mortgage Servicer Systems software available from Financial Industry Computer Systems (FICS) Group of Brussels, Belgium. Thus, the servicing database 251 could contain FICS data which would interface with the exchange system 200 via a router 253—similar in functionality as routers 262a, 262b and 247 described above—and the Internet 260.

While one servicing subsystem 250 is shown in FIG. 2B, it will be apparent to one skilled in the relevant art(s) that a plurality of loan servicing entities, each with their own loan servicing subsystem 240 infrastructure, may subscribe to the exchange system 200 and thus access the above-described components inside of the system. Loan servicing entities would provide exchange system 200 subscribers, via the router 253 and the Internet 260, with information about each loan such as prepayment, delinquency, default, etc. In an embodiment of the invention, this information can be provided as continuous live data or via pre-scheduled (i.e., nightly, weekly, etc.) batch uploads. This allows exchange system 200 subscribers to have up-to-date information about each loan within a pool for risk management analysis.

Also located in the outside region of the exchange system 200 are a plurality of workstations 280a-h which, via the WWW 266 (and thus, Internet 260), access the components inside of the exchange system 200. As will be described in more detail below, FIG. 2B shows a workstation representative of each type of subscriber of the exchange system 200. As will be apparent to one skilled in the relevant art(s), each type of subscriber would be provided a different set of GUI screens to access their respective functions of interests within the exchange system 200. Accordingly, as suggested by FIGS. 2A and 2B, each type of subscriber would access a different subsystem inside of the exchange system 200 (each with their own URL and servers providing the GUI screens). It would be apparent to one skilled in the relevant art(s) that in lieu of a workstation, the subscriber could use a remote device, such as a cellular phone with display screen, two-way text pager or personal device assistant (PDA), such as a Palm Pilot™ device, to access the system 200, as discussed in further detail below.

In one example, rather than calling into the loan origination subsystem 240 as described above, consumers may use the workstation 280b to apply for a loan. During processing of the loan, the system 200, via router 262a and/or 262b and the Internet 260, may obtain credit history data from a credit service bureau represented by the frame cloud 268.

In an alternative embodiment of the invention, the workstations 280, and thus subscribers, may also access the exchange system 200 by a direct telephone dial-up connection without the need to go through the WWW 266 or the Internet 260.

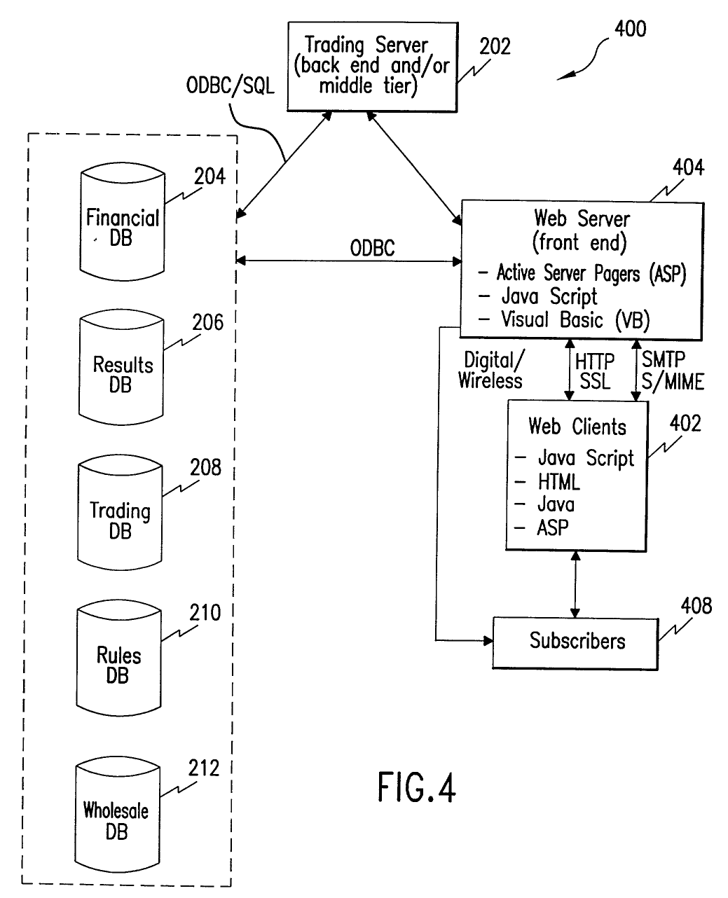

In an embodiment of the invention, all of the servers (202, 206, 224, 225, 232, 270, and 290) described above would be implemented using a Windows NT™ server platform. Furthermore, each workstation (201, 243, 246, and 280) described above can be realized with a PC workstation running the Microsoft® Windows operating system. The software and hardware architecture of exchange system 200 is described in more detail below with reference to FIG. 4.

While a set of servers (i.e., servers 202, 206, 224, 225, 232, 270, and 290) are shown in FIGS. 2A and 2B for simplicity of explanation, it will be apparent to one skilled in the relevant art(s) that exchange system 200 may be run on a single server as well as in a distributed fashion over a plurality of the servers connected via LAN 201. Further, in an alternate embodiment of the invention, exchange system 200 may be structured as a multi-tier system rather than the client-server model presented herein.

FIGS. 2A and 2B, also for simplicity of explanation, illustrates only one workstation 280a-h for each type of subscriber to the exchange system 200. As will be apparent to one skilled in the relevant art(s), however, the workstations 280a-h represents the GUI interface provided to each type of subscriber and thus, a plurality of workstations 280a-h would exist in the system 200, each possibly residing at different physical locations and used by different subscribing entities.

Similarly, while several databases (i.e., databases 203a, 203b, 204a, 204b, 205, 221, 222, 223, 224, and 231) are shown in FIGS. 2A and 2B, it will be apparent to one skilled in the relevant art(s) that exchange system 200 may utilize databases physically located on one or more computers which may or may not be the same as their respective servers. Exchange system 200 may also utilize a different scheme for allocating where the data within the system physically resides.

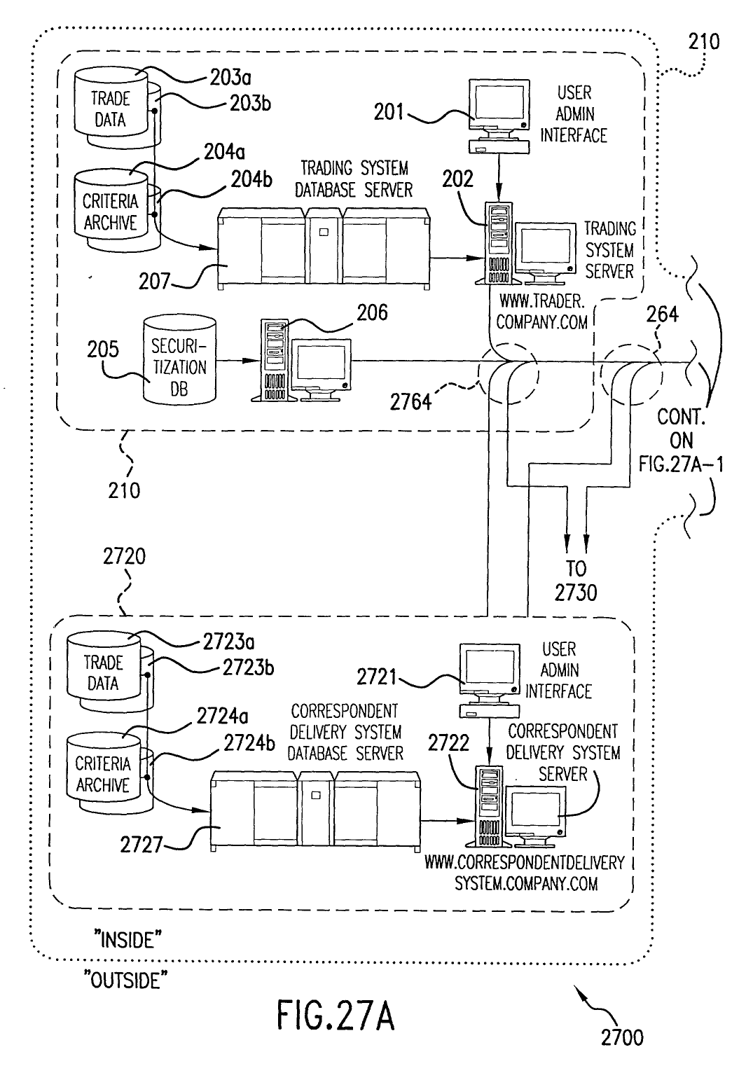

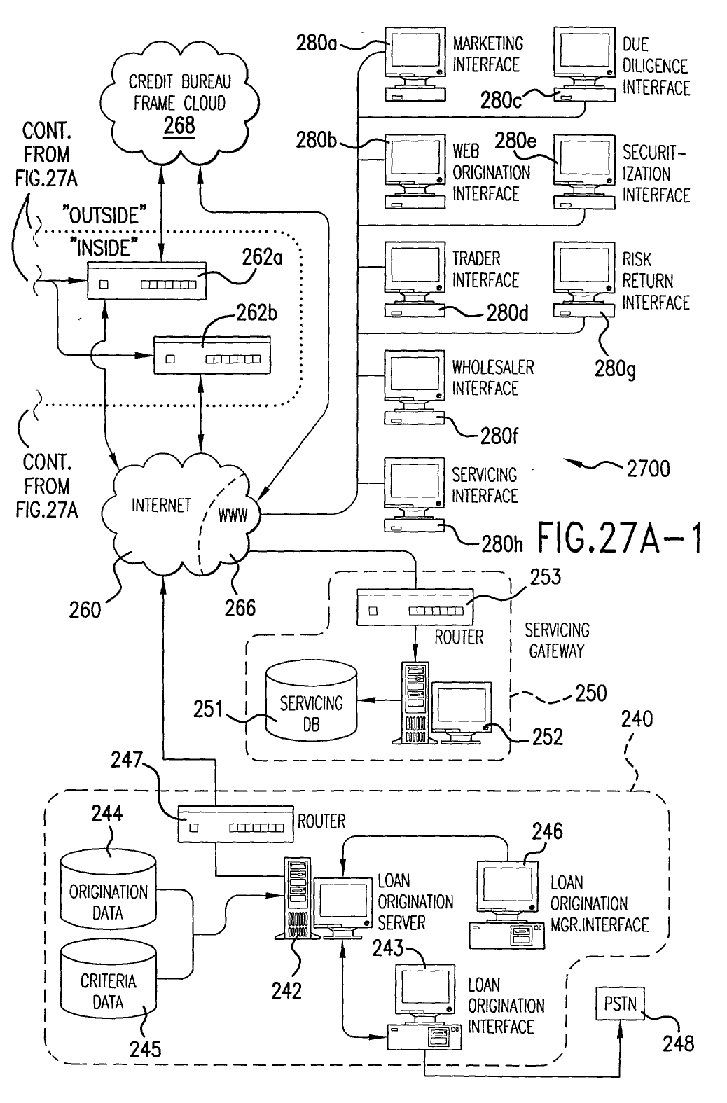

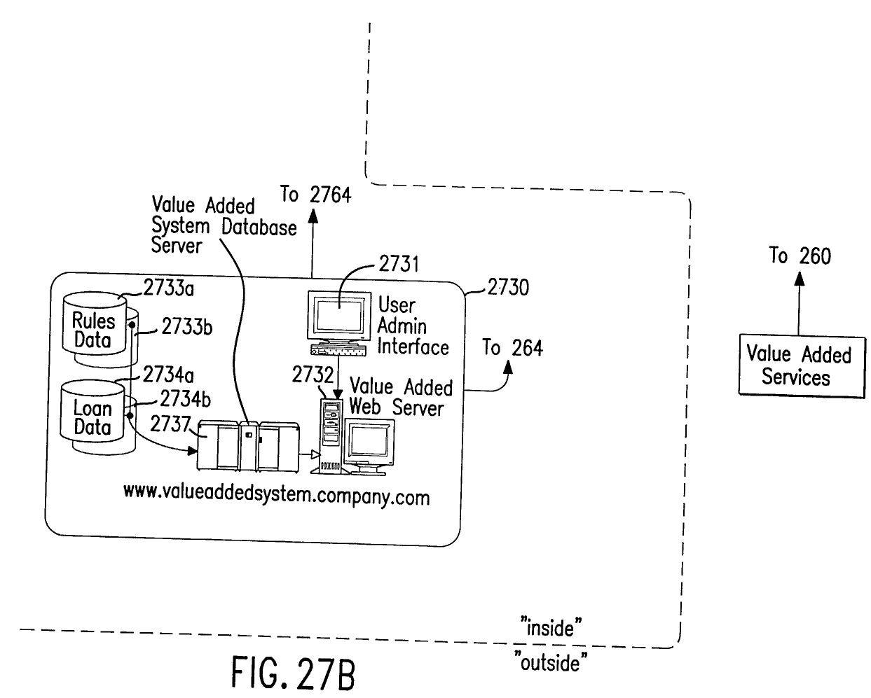

In a second embodiment of the invention, illustrated in FIGS. 27A, 27A-1 and 27B, the exchange system 2700 functions in much the same manner as exchange system 200. In FIG. 27A, the portfolio subsystem 220 is replaced by a correspondent delivery system 2720. The correspondent delivery system 2720 is shown in lieu of the portfolio subsystem 220 for ease of explanation. However, in another embodiment, the exchange system of the present invention could include both the correspondent delivery system 2720 and the portfolio subsystem 220.

Correspondent delivery system 2720 allows a subscriber to send loan(s) to another particular subscriber. In one embodiment, a subscriber may enter a contract with another subscriber to purchase a pre-set number of loans. Correspondent delivery system 2720 delivers these loans directly from the seller to the buyer.

Correspondent delivery system 2720 includes a correspondent delivery server 2722 and a correspondent delivery system database server 2727. Correspondent delivery server 2722 provides the “front-end” for correspondent delivery system 2720. Server 2722 is a typical Web server process running at a Web site which sends out web pages in response to Hypertext Transfer Protocol (HTTP) requests from remote browsers (i.e., certain subscribers of the exchange system 2700). That is, server 2722 provides the graphical user interface (GUI) to certain users of exchange system 2700 in the form of Web pages. In an embodiment of the invention, server 2722 may be implemented using a Windows NT™ server platform, and database server 2727 may be a Sun SPARC station platform running the Solaris operating system.

Correspondent delivery system database server 2727 includes a correspondent delivery database and a correspondent delivery criteria archive. In an embodiment of the invention, these two databases are mirrored for fault tolerance and thus shown as databases 2723a and 2723b and archives 2724a and 2724b.

Correspondent delivery subsystem 2720 also includes an administrative workstation 2721 (e.g., an IBM™ or compatible PC workstation running the Microsoft® Windows 95/98™ or Windows NT™ operating system) that may be used by the correspondent organization subscriber to update, maintain, monitor, and log statistics related to server 2722 and exchange system 2700 in general (e.g., check cards, network connections, software, hardware, etc.).

As shown in this embodiment in FIG. 27B, exchange system 2700 further includes a valued added subsystem 2730. Value added subsystem 2730 represents one or more subsystems that allow subscribers to perform various value added services, such as automated underwriting, automated pricing, rate locking, loan product comparison mapping, credit scoring, credit updates, CRA qualification and appraisal updates.

For example, in the case of automated underwriting, the system 2700 and subsystem 2730 allow subscribers to run selected loans through an automated decision engine to perform automated underwriting on the selected loan(s). Similarly, in the automated pricing system, the system 2700 and subsystem 2730 allow subscribers to run selected loans through an automated pricing engine to automatically assign a price to each selected loan. Each of the value added services listed above will be discussed in further detail below in Section X.

Value added subsystem 2730 includes a value added system server 2732 and a value added system database server 2737. Value added system server 2732 provides the “front-end” for each of the value added services available through subsystem 2730. Value added system server 2732 is a typical Web server process running at a Web site which sends out web pages in response to Hypertext Transfer Protocol (HTTP) requests from remote browsers (i.e., certain subscribers of the exchange system 2700). That is, server 2732 provides the graphical user interface (GUI) to certain users of exchange system 2700 in the form of Web pages. In an embodiment of the invention, server 2732 may be implemented using a Windows NT™ server platform, and database server 2737 may be a Sun SPARC station platform running the Solaris operating system.

Value added system database server 2737 includes a rules database and a historical loan data archive. In an embodiment of the invention, these two databases are mirrored for fault tolerance and thus shown as databases 2733a and 2733b and archives 2734a and 2734b.

Value added subsystem 2730 also includes an administrative workstation 2731 (e.g., an IBM™ or compatible PC workstation running the Microsoft® Windows 95/98™ or Windows NT™ operating system) that may be used by the subscriber to update, maintain, monitor, and log rules, filters and statistics related to server 2732 and exchange system 2700 in general (e.g., check cards, network connections, software, hardware, etc.).

As will be apparent to one skilled in the relevant art(s), all of components “inside” of the system 2700 are connected and communicate with routers 262a and 262b via a private wide or local area network (WAN or LAN 264). Similarly, all of the components “inside” of the system 2700 are connected and communicate with each other via a private wide or local area network (WAN or LAN 2764). More detailed descriptions of the components of exchange systems 200 and 2700, as well as their functionality, are provided below. However, a summary of the databases in each system is provided in Table 3 below.

TABLE 3

| DATABASE | DESCRIPTION |
|---|---|
| Trade Data 203a, 203b | Contains results data, pool negotiating |
| | (bidding) data, and financial data (e.g., prime |
| | rate, Dow Jones Industrial Average, etc.) |
| Trading Criteria Archive | Contains rules used by subscribers to identify |
| 204a, 204b | loans and loan packages to purchase. An |
| | example rule may be: |
| | [(FICO > 400) AND (Appraisal_Value_{—} |
| | of _Property > $300,000)] |
| Securitization 205 | Contains mortgage-backed securities (e.g, |
| | bond) data and criteria |
| Pool Data Org N 221, 222 | Contains data of published pools for each |
| | of N mortgage bankers that subscribes to |
| | exchange system 200. |
| Wholesale Criteria | Contains rules used by mortgage bankers to |
| Archive 223 | identify loans and loan pools to purchase. |
| Origination Archive 224 | Contains origination data uploaded from |
| | origination entities subscribing to exchange |
| | system 200. |
| Marketing 231 | Contains list of contacts (i.e., people), |
| | and correlations to financial products likely |
| | to be or actually owned, and financial |
| | products they are likely to purchase. |
| Origination Data 244 | Contains information gathered from |
| | borrowers and stored locally at each |
| | loan origination subsystem 240 |
| Origination Criteria 245 | Contains rules used by loan originators |
| | to identify consumers whom to approve |
| | loans to. |
| Servicing 251 | Contains data relevant to servicing of |
| | loans such as payment history, default, |
| | call (enforcement) history, etc. |
| Correspondent Trade Data | Contains data relating to the loans trans- |
| 2723a, 2723b | ferred from a particular correspondent |
| | subscriber to a particular buyer and data |
| | relating to loans refused by buyer. |
| Correspondent Criteria | Contains rules used by buyers to accept |
| Archive 2724a, 2724b | and approve loans from correspondent |
| | subscribers. |
| Automated Decision Rules | Contains rules used to perform automated |
| Data 2733a, 2733b | underwriting of a loan. |
| Automated Decision Loan | Contains loan data on loans processed |
| Data Archive 2734a, 2734b | through the automated decisions subsystem. |

IV. Secure System Interfaces

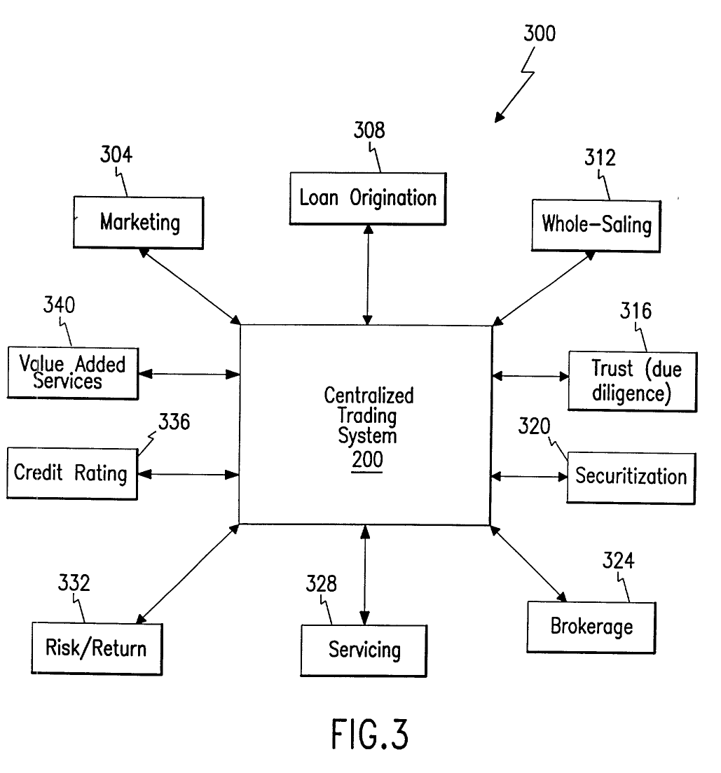

Referring to FIG. 3, a high level block diagram shows the secure system interfaces 300 that occur during the operation of exchange system 200 according to an embodiment of the invention. As shown by the arrows connecting the various interfaces to system 200, subscribers (e.g., brokers, correspondents, mortgage bankers, servicing companies, investors, capital markets brokers, etc.) can access system 200 in order to upload and/or download information. As will be apparent to one skilled in the relevant art(s), such system access described below can occur via workstations 280a-280h, where the corresponding server (e.g., 202, 206, 224, 225, 232, 270, and 290) provides a GUI, and data is passed to and from databases 203a, 203b, 204a, 204b, 205, 221, 222, 223, 224, and 231, as applicable.

A secure marketing interface 304 allows marketing companies to access system 200 via workstation 280a. Marketing companies retrieve information from system 200 such as which of their mailings resulted in loans being originated. Further, marketing companies can retrieve information from system 200 relating to which loan applicants, who were originally targeted by their mailings, were denied loans. Further, the marketing companies can access rules predefined by the loan originators (e.g., zip codes, age, geographic region, etc.), so that they can accurately target those potential borrowers that fit within the originators' requirements. Interface 304 also shows that the marketing companies send information back to system 200. Such information may include a list of those individuals who received a mailing regarding a specific loan product.

A secure interface 308 allows data flow between system 200 and a loan origination company (i.e., a bank or other commercial lender) via loan origination subsystem 240. A loan originator will collect loan origination information from an applicant (i.e., consumer), usually via the telephone or via the applicant entering some origination information via workstation 280b. This information is then forwarded by system 200 to loan origination subsystem 240 via the WWW 266.

The loan originator will then use the information collected to process the loan and forward information regarding whether the application was approved or denied to the system 200. This information is then archived in origination archive 226 so that it may be accessed in some form by other subscribers of the system 200.

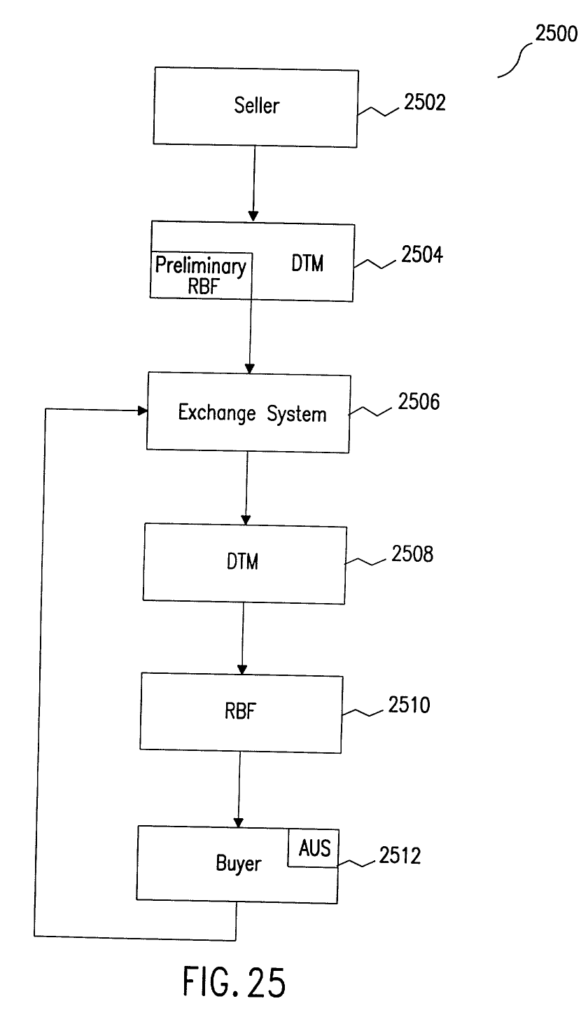

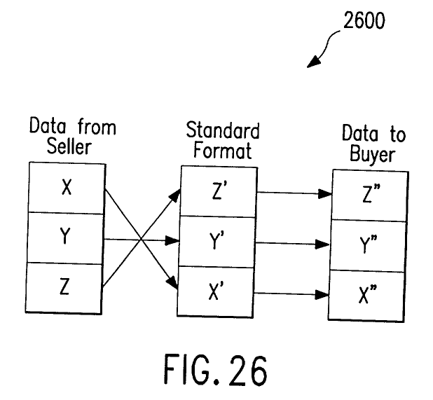

The loan originator, once it has originated a loan or a pool of loans, may send information concerning the loan(s) to the system 200 to post or publish the loans for sale to mortgage bankers. Once system 200 receives the loan information, it can perform data transformation and mapping, as discussed below with reference to FIGS. 25 and 26, to convert the data to a standardized data format. System 200 may also perform certain validation checks on the data and notify the loan originator and/or flag the loan data if any discrepancies or unusual data is found.

The subscriber can either publish the loan(s) so that they are accessible to all subscribers on system 200, or they can publish the loan(s) to be accessible to only a select group of individuals for private trading. These individuals can be either subscribers or non-subscribers to the system 200. This private trading is discussed in further detail below.

A secure interface 312 allows mortgage bankers to access system 200, via workstation 280f or a remote device, as discussed above, to (1) pool its own loans together for resale, and/or (2) search for loans that have been posted for sale by loan originators or other mortgage bankers for sale.

In the first instance, an investor may use workstation 280f to review its loans and to search through the loan data using various criteria to select particular loans to be pooled together for sale. These loan pools are stored in databases 221 and 222. Once a mortgage banker has created a loan pool, he can publish it by sending it to the exchange system 210 to be published.

In the second instance, an investor can use workstation 280d to access system 200 to look for loans for sale. The investor then inputs an offer for certain loans that meet his predefined rules. The investor can also input comments on a particular loan or loan pool for system 200 to send to the seller. These comments can be in addition to or in lieu of a bid. In addition to being able to search for loans that meet his criteria, the investor can also input credit slotting rules so that the system 200 can analyze a pool, using the investor's credit slotting rules, to categorize the loans in a loan pool. Once the loans are slotted, system 200 can use the investor's pricing model to automatically generate a price for the pool.

As discussed in further detail below, the mortgage bankers' predefined rules, that were created, deleted and/or modified by the subscriber, are archived in criteria archive 223 and are accessible to the loan originators. As such, the loan originators can review these predefined rules before originating a loan to make sure that its loans will be attractive to the mortgage bankers. This process maximizes returns.

In one embodiment of the invention, the mortgage bankers can register with system 200 to be notified if any loans are posted for sale that fall within its predefined rules. Such notification can be made via electronic mail, any type of digital/wireless communications (e.g., by pager, telephone, cellular telephone, facsimile, personal digital assistant, etc, possibly using Hand-held Device Markup Language (HDML), Voice Markup Language (VoxML), eXtensible Markup Language (XML), or other similar computer language) or simply upon accessing system 200 via a GUI dialogue box. Further, a seller can contact a particular buyer via system 200 if it has a loan for sale that it believes the buyer would be likely to purchase. In this private trading scenario, the seller can request system 200 to notify both members and/or non-members of system 200 that the seller has published a pool on the system.

The mortgage bankers can search the available loans on system 200 using various search criteria, either based on the mortgage bankers' predefined rules, or based on some other criteria, to quickly locate those loans that meet their requirements. For example, if a mortgage banker wants to purchase only loans made to borrowers having a FICO score greater than 600 and an interest rate of 13% or greater, the mortgage banker could use system 200 to search for loans having these criteria. Similarly, the mortgage banker could have predefined rules, using these criteria, so that they can be notified when such loans, meeting these criteria, are posted for sale.

Once the investor makes an offer for a loan that is accepted by the seller, the mortgage banker must perform a due diligence analysis on the loan to be purchased to make sure it is a valid loan. In an embodiment of the invention, mortgage bankers can authorize system 200 to automatically initiate transfer of loan files from the seller to a trust company and/or loan custodian upon purchase of a loan by the mortgage banker. The mortgage banker can select one or more particular trust companies and/or loan custodians in advance for all of its loans.

In one embodiment, the mortgage banker simply enters an address to which a hard copy of the loan file is to be sent. In another embodiment, the documents in the loan file are scanned and uploaded to the exchange system of the invention. Once the exchange system receives authorization from the seller, the data file containing the scanned documents from the loan file is transferred to the mortgage banker (e.g, the buyer), transferred directly to the buyer's trust company to perform the due diligence analysis of the loan, or transferred directly to the buyer's loan custodian for safekeeping.

A secure interface 316 allows trust companies to access system 200 via workstation 280c. Upon receipt of the loan files, the trust company will perform a due diligence analysis on the loan (or on a statistical sampling of several loans from a pool of loans). The due diligence analysis will ensure that the supporting documentation provided by the borrower matches the information the lender relied on in approving the loan (i.e., the information entered into the loan application). Once the due diligence is completed, the trust company will forward a certificate to the mortgage banker which includes verification of the authenticity of the loan(s).

In another embodiment, system 200 uses optical character recognition to extract data from the scanned loan documents and compares this data with the data input electronically by the seller to perform an automated initial due diligence on each loan.

Once the mortgage banker has accumulated several loans, the workstation 280f, as discussed above, can be used to post or publish a pool of these acquired loans for sale.

A secure interface 320 allows securitization companies to access system 200 to (1) search for loan pools that have been posted on system 200 for sale by mortgage bankers and (2) to sell mortgage-backed securities that they have created and backed with their loan pools.

In the first instance, the securitization companies access system 200 via workstation 280d to look for loan pools for sale and to review information for each loan in a pool and individually accept, deny, or suspend its decision for each loan within the pool. This will result in a revised loan pool for which the securitization company may make an offer. The mortgage banker can then access, via interface 312, the revised loan pool, and either accept the securitization company's offer, create another pool to offer for sale, or reject the offer.

As discussed above, the seller, in this case the investor, can access the securitization companies' predefined rules, which are stored in the securitization database 205, before posting a loan pool so that a pool that will look particularly attractive to a buyer/investor can be created, thereby maximizing their chances of selling the pool. In one embodiment of the invention, the securitization companies can ask to be notified by system 200 if any loan pools are posted that fall within its predefined rules. Such notification can be made via electronic mail, any type of digital/wireless communications (e.g., pager, telephone, cellular telephone, facsimile, personal digital assistant, etc., possibly using HDML, VoxML, XML, or other similar computer language) or simply upon accessing the system 200 via a GUI dialogue box. Further, a seller can contact a particular securitization company via system 200 if it has a loan pool for sale that it thinks the securitization company would be likely to purchase.

The securitization companies can search the available loan pools on system 200 using various search criteria, either based on the predefined rules, or based on some other criteria, to quickly locate those loan pools having loans that meet its requirements. Further, the securitization companies can search within a selected loan pool to automatically decline or accept particular loans within a pool that have certain criteria. For example, if a securitization company desires to purchase only loan pools having loans made to borrowers having a FICO score greater than 650 and an interest rate of 12% or greater, the securitization company could use system 200 to search for loans having these criteria. Similarly, the securitization companies could have predefined rules, using these criteria, so that it can be notified when such loan pools, meeting these rules, are posted for sale.

Once the investor has acquired several loan pools, it can access system 200 via workstation 280e to group together the loan pools to back a security (i.e., create a mortgage-backed security). As shown in FIG. 3, an interface 324 allows the brokerage companies to be able to access system 200 via a workstation 280d to look for mortgage-backed securities for sale and to negotiate to buy and sell the mortgage-backed securities.

Because the loans are being used as collateral to back a security, they cannot be resold. As such, the securitization company is responsible for servicing the loans for the remainder of their lifetime. This task is often delegated to a servicing company, as discussed below.

A secure interface 328 allows a servicing company, via workstation 280h, to access the exchange system 200 to acquire loan information on the loans it has been asked to service and to provide information back to system 200, such as payment history, prepayment rates and/or default.

In another embodiment, servicing rights can be traded via system 200. As discussed in further detail below, the seller can publish loans for which he wishes to sell the servicing rights separately from the loans on system 200. Servicing companies can access system 200 via workstation 280h to review and bid on these servicing rights. Further, the seller can periodically update the loan information on the loans so that the servicing information is kept up to date.

A secure interface 332 allows trading organization personnel, via the administrative workstation 201, as well as all subscribers via workstation 280g, to access exchange system 200 in order to perform certain risk management functions. For example, a mortgage banker who is thinking about purchasing a particular loan, may access data in database 203a to determine what a fair price for a particular loan or loan pool might be, based on previous trades of similar loans.

A secure interface 336 allows a credit rating agency, typically hired by the brokerage firm to rate a mortgage-backed security, to access exchange system 200 to review the payment history and risk-return information in order to rate a particular security. For example, the credit rating agency can review the payment history of the loans used to back a particular mortgage-backed security, to determine whether the loans are likely to be prepaid or go into default.

A secure interface 340 allows subscribers to access various value added services available via exchange system 200, such as automated underwriting, automated pricing and other value added services, as discussed below in Section X.

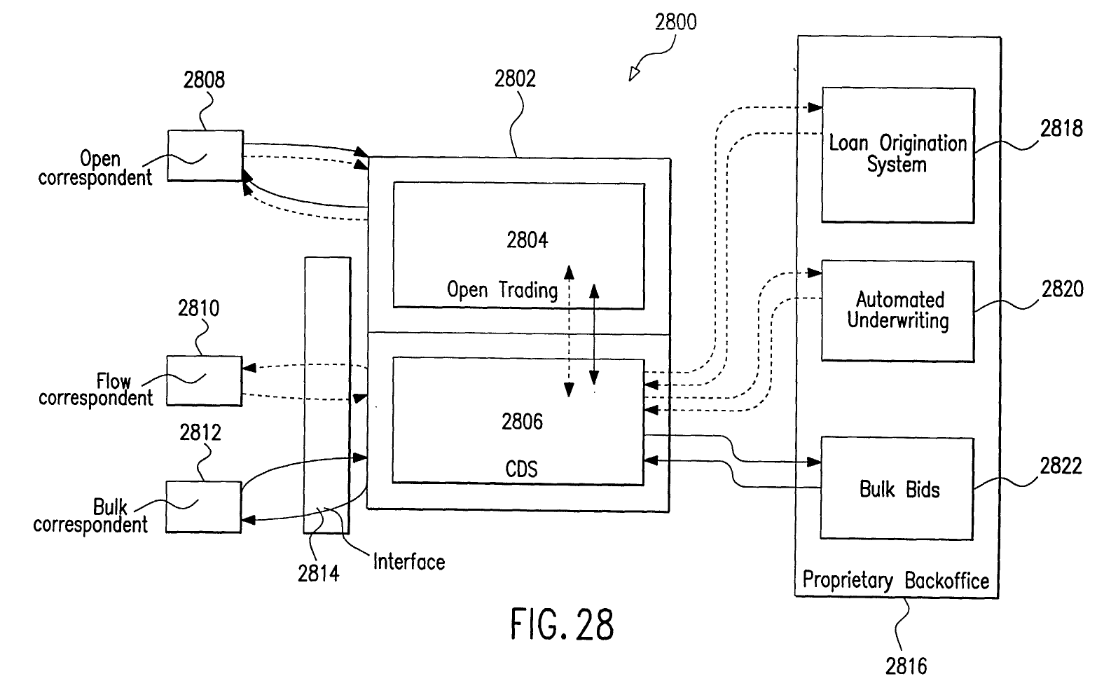

Referring now to FIG. 28, a second embodiment of the present invention shows the secure system interfaces 2800 that occur during operation of exchange system 2700. A centralized trading system 2802 is provided. In this embodiment, system 2802 is divided into an open trading platform 2804 and a correspondent delivery system (CDS) platform 2806. Open trading platform 2804 is that part of system 2802 that is open for access by all subscribers for trading loans via exchange system 2700, as described above with respect to FIG. 3.

CDS platform 2806 is a portion of system 2802 that is dedicated to a particular business-to-business transfer of loans. Particular correspondents who have contractual obligations to a particular buyer to provide the buyer with loans can use CDS platform 2806 to pass these loans to the buyer. The correspondent can forward these loans one-by-one, i.e., flow, or several at a time, i.e., bulk. The arrows shown in FIG. 28 differentiate between flowed loans, shown with the dashed-line arrows, and bulk loans, shown with the solid line arrow.

As shown by the arrows connecting the various interfaces to system 2802, subscribers can access system 2802 in order to upload and/or download information. As will be apparent to one skilled in the relevant art(s), such system access described below can occur via workstations 280a-280h or via remote devices, where the corresponding server (e.g., 202, 2722 and 2732) provides a GUI, and data is passed to and from databases 203a, 203b, 204a, 204b, 205, 2723a, 2723b, 2724a, 2724b, 2733a, 2733b, 2734a and 2734b, as applicable.

A secure interface 2808 allows open correspondent subscribers to access open trading platform 2804 of system 2802 via a workstation, as described above with reference to FIG. 3.

Secure interfaces 2810 and 2812 allow data flow between flow or bulk correspondent subscribers and CDS platform 2808 of system 2802. In the embodiment shown in FIG. 28, secure interfaces 2810 and 2812 link subscribers to system 2802 via an interface 2814. For example, a particular buyer can use CDS platform 2806 to receive loans from its correspondents. The buyer can provide a link on its own interface 2814 (e.g., a Web site) to system 2802. As such, in one embodiment, the flow and loan correspondent subscribers would access their dedicated buyer's Web site and upload the loan information via secure interfaces 2810 and 2812. The loan information is passed through interface 2814 to CDS platform 2806. In one embodiment, the transfer of data is transparent to the flow and bulk correspondent subscribers. As would be apparent to one skilled in the art, in another embodiment the flow and/or bulk correspondent subscribers could access CDS platform 2806 directly, rather than accessing it through interface 2814.

In the case of bulk interface 2812, this interface includes a GUI that allows the subscriber to select which loans to include in the bulk transfer, similar to the interface discussed above with respect to workstation 280f which can be used by a seller to create a pool of loans for sale on the exchange system.

Once the CDS platform 2806 receives the loan data, it performs data transformation and mapping, as discussed below with reference to FIGS. 25 and 26, to convert the data to match the data formats used by the buyer. CDS platform 2806 will then make an automated determination whether submitted loans meet purchase criteria as defined by the buyer company by performing automated underwriting of the loan. This eliminates the need for manual review of the loan information. Loans meeting the criteria and data validation checks will be identified and available for sending to a proprietary backoffice 2816. Loans not meeting the criteria and/or data validation checks will be flagged for the buyer company to either override or send back to the correspondent subscriber with a reason for the rejection. The CDS platform 2806 may also perform other automated functions, such as automated pricing, slotting or loan classification, and rate locking of loans passed through the platform.

The data is then passed, in bulk or flow, to backoffice 2816 of the particular buyer. As shown by way of example only, a backoffice 2816 may include a loan origination interface 2818, an automated underwriting interface 2820 and/or a bulk bids interface 2822. Loan origination interface 2818 actually boards the loans sent by the correspondent onto the buyer's backoffice system. Automated underwriting interface 2820 is used to pass the loan data through the buyer's own underwriting program. Bulk bids interface 2822 is used to allow a buyer to accept or decline individual loans in a bulk sale and to make pricing decisions on a bulk loan sale. As would be apparent to one skilled in the relevant art, the system of the invention could be configured to transfer the loan data to various other interfaces/systems, suited for a particular buyer's backoffice system. Further, it would be apparent to one skilled in the relevant art that the system of the invention could be configured to allows subscribers to choose from among multiple backoffices 2816 so that a subscriber could shop the loan to several different prospective buyers via CDS platform 2806.

In an embodiment of the invention, the subscriber also has access via CDS platform 2806 and/or open trading platform 2804 to various subscriber tools and value added services, discussed in detail below in Sections IX and X.

Backoffice 2816 will send information back to the subscribers via CDS platform 2806. This information may include, for example, whether the buyer will fund a particular loan application, whether the buyer will accept a closed loan (e.g., already funded), and/or whether additional loan information is required by the buyer before the loan(s) will be approved. If a loan is approved, the trade may continue, as discussed above with regard to due diligence, etc. If the buyer refuses to accept a particular loan, the correspondent subscriber could then use open trading platform 2804 to try to sell the loan on system 2802 to another buyer.

Forward Offerings (TBA Sales)

In some cases, a buyer and seller may agree on a contract for a pool to be created in the future (“TBA”). The system of the present invention can be used to sell these TBA pools on the open trading platform 2804. In such a case, the seller would post a profile of a pool of loans it plans to originate in the future. In selling these loans, the seller commits to transfer the loans to the buyer at a specified price, provided the loans meet the profile. Thus, the pool posted by the seller is not an actual portfolio, but is instead an estimate of what characteristics a group of loans will have when they are originated.

The profile posted by the seller can include any of a variety of data elements and an expression of what the buyer can expect the values to be for the originated loans. For example, the profile may describe weighted averages of the data in the pool to be created. The TBA pool may also have set tolerances, so that, for example, no loan in the pool can have a LTV higher than the set tolerance. The seller can then publish the TBA pool on the open trading platform 2804 and buyers can bid to purchase this pool. Once an agreement has been reached, the parties can set up the commitment and flow the loans to the buyer via the CDS platform 2806, so that as each loan is originated, it can be sent to the buyer to satisfy the commitment. System 2800 can then track the loans as they are passed from the seller to the buyer over the CDS platform 2806, to ensure that the seller is meeting the commitment.

In one example of a TBA sale, a correspondent plans to originate $300 million in conventional mortgages in the next 90 days. The correspondent can assembly a $300 million package for sale as TBA loans and provide only high-level information on the loans. Since the loans do not yet exist, there is no true loan level data, but sellers can make reasonable guesses on average loan characteristics such as loan balance, credit score, LTV and geographic distribution. A sample forward loan offering might include the following details:

$15 million of flow servicing, delivered monthly

FHLMC Gold and GNMA I product (Fixed-rate, 30 year) where at least 50% of loans will be FHLMC product and where for GNMA loans, FHA/VA ratios will be roughly 50%

Weight Average Coupon (WAC) of the pool will be between 7.4% and 7.9%

Weighted Average Servicing Fee (WASF) of the pool will be between 0.45 and 0.50%

Loans will be for properties in Ohio, Indiana, Nebraska and Illinois and no more than 30% of the loans will be concentrated in one state

At least 80% of properties will be owner-occupied

All properties will be single-family homes

At least 90% of loans will have escrows

No loans will be seasoned more than 4 months

The system will allow users to create profiles and to specify as appropriate: floors, ceilings, means, buckets and exclusions. Each of these terms will be described in detail. The system allows the user to create a floor for a particular data field (e.g., LTV, FICO, etc.) as the minimum value which loans will have for that data field. For example, the user can set a floor of a minimum FICO for any loan in the pool to be 600. Similarly, the system allows the user to set ceilings for data field. A ceiling is the maximum value which loans in the pool will have for the particular data field. For example, the user can set a ceiling of a maximum LTV of 105 for any loan in the pool.

The system also allows users to set means for a particular column of data, which is the weighted average value of the loans in the pool. For example, the user can set the mean Unpaid Principal Balance (UPB) to be $120,000 for each loan in the loan pool.

The system further allows users to specify buckets, which are percentages of the pool fitting certain characteristics (e.g., Property Type buckets could specify that 20% of the loans will be condos, 70% will be single family homes, and 10% will be duplexes). Finally, the system allows users to set exclusions such as specifications that no more than a specified percentage of a pool will have a certain characteristic. For example, no more than 20% of the loans will have FICO under 600. Alternatively, the exclusion could be that the loans contain none of a certain characteristic, such as no loans in the pool can be for property located in California.

Any of these profile characteristics can be specified either on the pool level or the loan level.

Further, the system allows users to describe two calculated data elements: (1) loan age, i.e., original loan term minus the remaining loan term; and (2) loans with escrow, i.e. whether the current escrow balance has a value.

The user can post the profile on the open trading platform and either publish it as an open pool, for viewing by all subscribers, or targeted to specific potential buyers. Users can also update or revise a profile and place a date-stamp on the profile after each update. In addition to posting the profile for the loan or loan pool, sellers can also post an offer price, a start date for delivery of the loans and an expiration date for the offering.

Buyers can browse for, view and bid on forward loans or pool profiles in the same way that they browse for actual, existing loans and pools on the system, as described above.

Commitment Tracking for Forward Offerings

The system allows users to track the delivery of the offerings that were sold as a TBA sale.

In one embodiment, the loans are passed through two filters on the system in order to enable tracking of the pool. The first filter is a loan filter. The loan filter compares the loan detail information for that particular loan against any preset tolerances (e.g., ranges) to make sure that the loan complies with the commitment. The second filter is a pool filter. The pool filter calculates averages of certain statistics for the pool based on all of the loans that have been added to the pool by the seller to make sure that the pool is meeting the commitment.

The seller can also use this tracking feature to determine what types of loans he needs to purchase or originate in order to meet the commitment. For example, if the seller promised that the weighted average of FICO scores for the loans in the pool would be 720, and the seller has already produced 50% of the loans in the pool, the seller can use the tracking feature to see if the weighted average for the FICO score for the pool is on target. If the weighted average is 700, then the system could calculate that the remaining loans must be made to borrowers having FICO scores of 740 or higher, in order for the seller to make the commitment. Further, the tracking system allows the seller to assess risk if he is having difficulty meeting a commitment. For example, if the seller has several commitments to fulfill, he may use the tracking system to compare which commitment he is more likely to fulfill and what the payoff fees are if he does not fulfill a commitment.

Buyer Axes

The system, similar to the forward offerings described above, also allows buyers to post products that the buyer wants or is willing to buy. In the preferred embodiment, the buyer would be able to post a profile, just like that used for a forward offering, including floors, ceilings, means, buckets and exclusions, for a loan or loan pool that he would like to buy and sellers would be able to offer to sell loans or pools which meet the criteria. Further, the buyer can specify the bid price, total volume, number of loans, start date for deliver and expiration date for the axe. This allows buyers to indicate those loans or pools for which the buyer may be willing to pay above market value.

An axe is just an indication of interest rather than a formal bid. The transaction occurs when the seller responds with a formal offer and the buyer accepts. Up until that point there is no implied commitment, as there is with a forward offering.

Just as described above for trading loans and servicing rights, the system of the present invention would allow potential sellers to search the buyer axes for loans or pools that meet their product offerings. Alternatively The seller can then make an offer in response to an axe. In such a case, the seller's offer might be a counteroffer to the axe, that would include: a specified set of loans or a specified pool, or a forward sale profile, or an acceptance of the buyer's axe as a forward sale offer, or an offer price. The counteroffer would then be forwarded to the buyer who posted the axe and the trading would continue as a standard trade of a pool or forward offering.

In one embodiment, the system allows buyers to posts axes anonymously, i.e., they are not linked to a particular institution. If a seller makes a counteroffer and the buyer accepts, then the buyer's identity is revealed.

One advantage of the system of the present invention is that it provides for creation of business relationships and development of those relationships through use of the system. For example, buyers and sellers who may not have otherwise engaged in business dealings may begin a business relationship of loan trading on-line using the system of the present invention. The system, by providing loan detail on-line and background information on each member, provides a certain comfort level to the members to initiate transactions with unknown entities. The system thus gives the users a better picture of the partner with whom they wish to deal.

Further, after conducting one or more deals through the open trading platform 2804, the parties may have developed a good working relationship, so that they become business partners and enter into loan commitment agreements. In this case, the parties can then use the CDS platform 2806 of the present invention to flow loans to fulfill their commitment. The subscribers can set up a list of other subscribers with whom they do business, and the system can track the transactions between the subscriber and the other subscribers on his list, to see how the relationship has developed. The system may provide information about the number of deals that have been entered over time, the number of loans involved, and other similar statistics.

V. Software/Hardware Architecture

Referring to FIG. 4, a simplified block diagram illustrating a software/hardware architecture 400 according to an embodiment of exchange system 200, showing communications among the various components, is shown. The architecture 400 of exchange system 200 includes software code that implements the interfaces 300 (via the workstations 280 or remote devices) during the operation of exchange system 200.

Architecture 400 includes a database 402 which represents any one of the collection of database within the inside region of exchange system 200 (i.e., databases 203a, 203b, 204a, 204b, 205, 221, 222, 223, and 224). In an embodiment of the invention, database 402 may be implemented using a high-end object-oriented database product such as ObjectStore™ available from Object Design, Inc. of Burlington, Mass., or a relational database such as Oracle. As is well known in the relevant art(s), in an object-oriented database, data is stored as objects and can be interpreted only using the methods specified by its class. The relationship between similar objects is preserved as are references between objects. This allows queries to be faster than with relational databases because an object can be retrieved directly without a search, by following its object identifier.

The database 402 is connected to a Web server 404 which represents any one of the collection of servers within the inside region of exchange system 200 (i.e., servers 202, 206, 224, 225, 270, and 290). As mentioned above, in an embodiment of the invention, all of the servers would be implemented using a Windows NT™ server platform running (“back-end”) software implemented in a high level programming language such as the C++ programming language.

In an embodiment of the invention, the server 404 software application communicates with the database 402 using a C++ object interface. In the special case of the trading subsystem server 202, the database sever 207 (not represented in FIG. 4) interconnects it to the databases 203a and 204a. In an embodiment of the invention, the server 207 is a Sun SPARC workstation running the Solaris operating system that provides highly scalable hardware solutions. The trading subsystem server 202 then performs the management (i.e., opening, closing, etc.) of sessions.

The database server 207 would communicate with the databases 203a and 204a, and the server 202 using a structured query language (SQL) commands interface.

The sever 404 also provides the secure GUI “front-end” for exchange system 200. The GUI front-end can be customized for each type of subscriber to the system. In an embodiment of the invention, the front-end is implemented using the Active Server Pages (ASP), Visual BASIC (VB) script, and JavaScript™ sever-side scripting environments that allow the creation of dynamic Web pages. The subscriber may use custom software to allow the user to deliver a binary or ASCII file as part of an HTTP form submission.

These Web pages are provided to the subscribers of the exchange system 200 via the workstations 280a-h (collectively shown as “Web Clients” 406), using the Hypertext Transfer Protocol (HTTP) thereby providing the front-end to the subscribers 408 (e.g., borrowers, brokers, correspondents, mortgage bankers, servicing companies, investors, capital markets brokers, etc.). The user interface for Web Clients 406 is browser implemented, using Java, JavaScript™, and Hypertext Markup Language (HTML). As such, the external workstations 222 and the internal workstations 224 may be realized with IBM™ (or compatible) PCS running the Windows NT™ or Windows 95/98™ operating system.

In an embodiment of the invention, as mentioned above, subscribers 408 may request that system 200 notify them if any loans, loan pools, or desired information which fall within its predefined rules are available. As discussed above, such notification can be made via electronic mail, any type of digital/wireless communications or simply upon accessing the system 200 via a GUI dialogue box. Thus, the server 404 also communicates with the Web clients 406 via the well-known Secure Multipurpose Internet Mail Extensions (S/MIME) or Simple Mail Transfer Protocol (SMTP) protocols for electronic mail. Also, the server 404, as suggested by FIG. 4, may also communicate directly with the subscribers 408 by any known digital/wireless communication means (e.g., by pager, telephone, facsimile, cellular telephone, personal digital assistant, etc., possibly running HDML, VoxML, XML, or other similar computer language).

VI. System Operation

A. Marketing

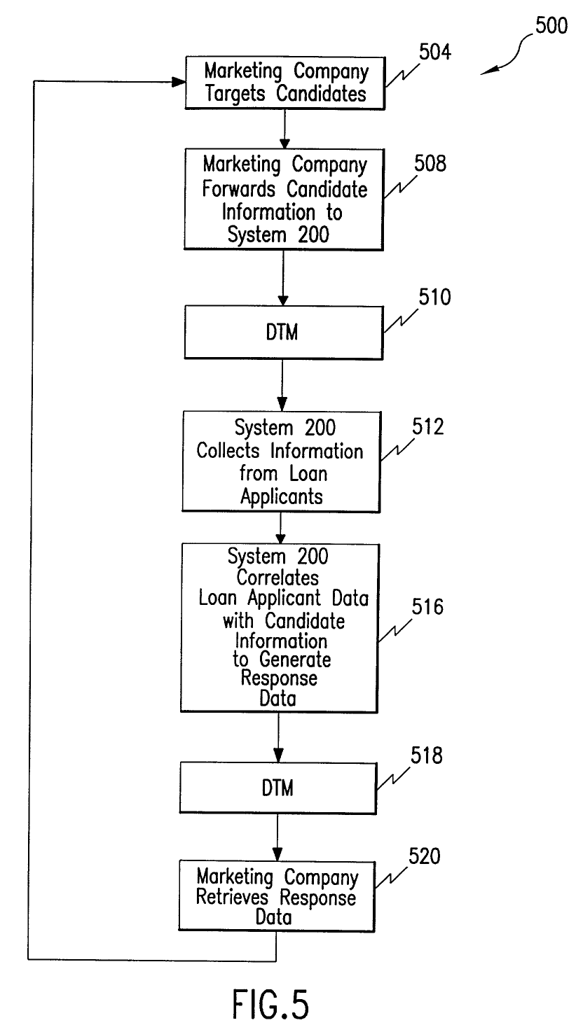

Referring to FIG. 5, a flow chart 500 representing an exemplary interaction between a marketing company and system 200 in an embodiment of the invention is shown.

In a first step 504, the marketing company selects potential loan candidates for a marketing campaign and targets those candidates via direct mailings, TV, print adds, or other similar marketing techniques. In the invention, the potential loan candidates may be targeted based on whether their credit or personal information matches rules predefined by lenders.

In a step 508, the marketing company then sends the relevant data to system 200. This data may include, in the case of direct marketing, a list of the names of each individual who received a mailing. In the case of TV or print ad campaigns, the data may include a set of criteria which was used to target the market for the campaign. For example, the marketing company may have decided to target individuals between the ages of thirty and forty, and with an annual gross income of greater than $75,000. In this case, the TV and print ads would appear on programs or in newspapers and magazines typically seen by people that fit these criteria.

In step 510, the relevant data from the marketing company is translated into an appropriate processing format for system 200 using a Data Transformation and Mapping (DTM) process. The DTM process is further discussed below with reference to FIGS. 25 and 26.

In a step 512, system 200 collects information from loan applicants. This data may come from different sources. For example, the loan applicant may enter the data directly into system 200 by applying for a loan via workstation 280b. Alternatively, a loan agent at the loan origination subsystem 240 may enter the data into system 200 based on the information collected from the applicant via loan origination interface 243 taken over the phone. In the latter case, the collected loan origination information is uploaded from subsystem 240 to system 200 at predetermined intervals. In one embodiment, this upload occurs once daily. This loan applicant information may include, for example, the loan applicant's name, address, age, annual or monthly gross income, how the applicant heard about the particular loan product, and whether the loan applicant's loan was approved.

In a step 516, system 200 correlates or matches the loan applicant information with the candidate information from the marketing company to generate response data, which indicates those applicants who responded as a result of the marketing company's campaign. In one embodiment, system 200 performs some simple validation of the loan applicant information before performing the correlation, in order to validate that the information is complete and accurate. The response data is sent back to marketing subsystem 230 via router 262a and archived in database 231.

In a step 518, system 200 uses the DTM process to send the correlated response data to the Marketing company in a preselected format. The DTM process is discussed below with reference to FIGS. 25 and 26.

In a step 520, the marketing company retrieves the response data from database 231 of subsystem 230, and uses this response data in step 504 to develop the next set of criteria to use to target potential candidates. The response data may be uploaded from loan origination subsystem 240 via router 262a and into database 231 at regular intervals. In one embodiment of the invention, upload of this response data occurs once daily.

This type of marketing information is also valuable for reselling and/or cross selling to particular borrower. As such, the system of the invention also archives the marketing data and borrower information.

B. Loan Origination

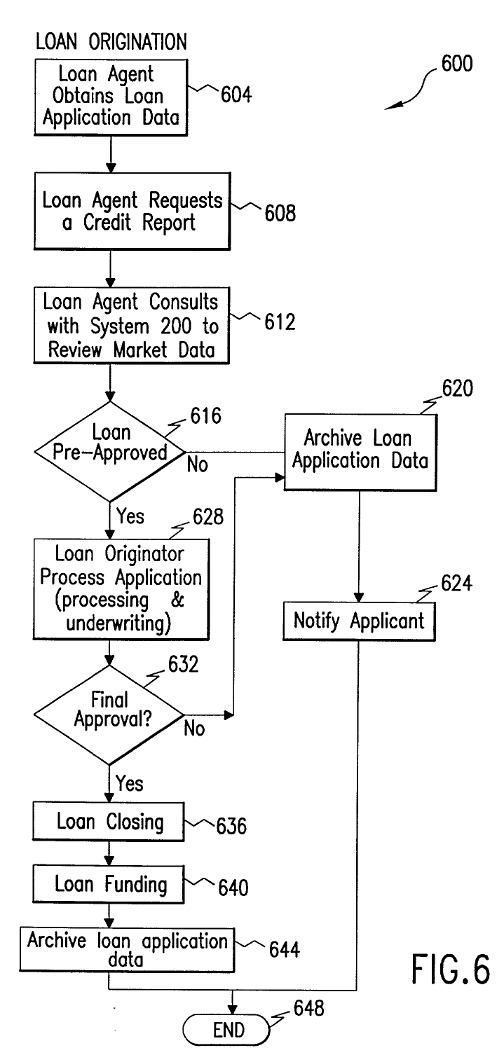

Referring to FIG. 6, a flow chart 600 representing an exemplary interaction between a loan originator and system 200 in an embodiment of the invention is shown.

In a step 604 of flow chart 600, a loan agent at the loan originator obtains loan application data from a potential borrower. This data can be obtained by the loan agent via system 200. For example, if the potential borrower applies for the loan on-line, at the system web site, system 200 will then notify the loan originator of the loan application and may download the loan application data to loan origination subsystem 240 for processing. Alternatively, the loan application data may be obtained by the loan agent via a call center, in which the applicant calls into the call center and provides his information to the loan agent over the telephone. In this case, the loan agent may enter the loan application data via loan origination interface 243 for subsequent uploading to system 200.

When the loan information is received by system 200, the information is translated into the correct processing format using the DTM process which is discussed below in FIGS. 25 and 26. System 200 may also perform simple validation checks on the loan information, such as making sure the borrower's social security number is eleven digits, or making sure that the address for the loan property is complete.

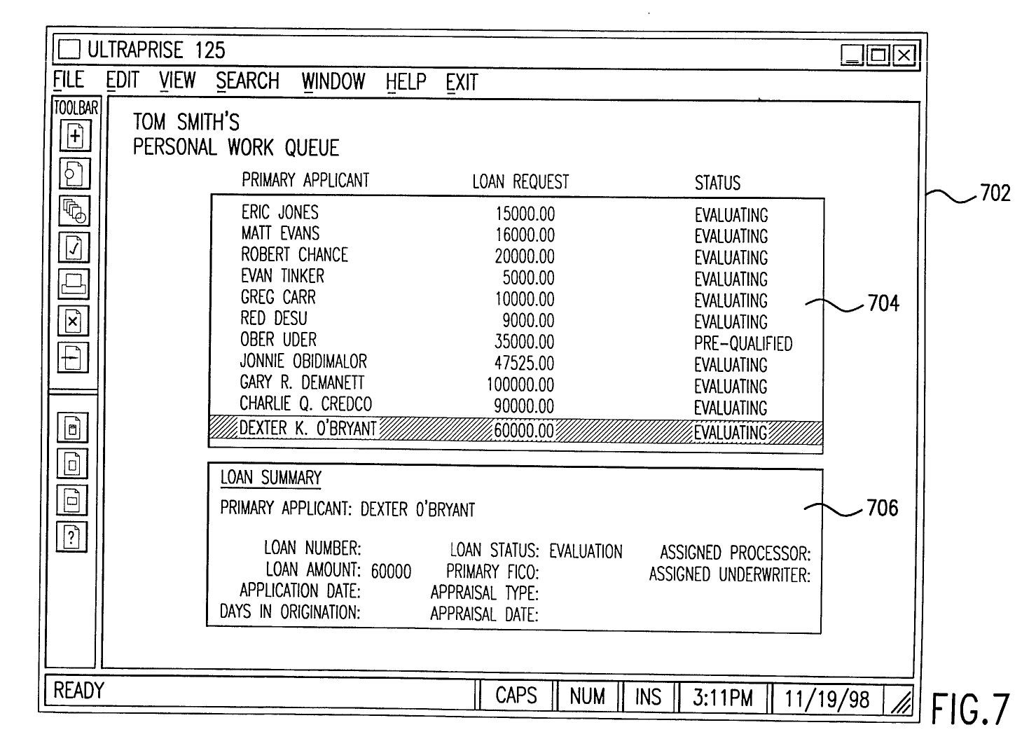

FIGS. 7-14 show exemplary Graphical User Interfaces (GUIs) of an embodiment of a loan origination system for use by a loan agent when interfacing with system 200. In a preferred embodiment of the invention, these GUIs are used on the loan agents'workstation, shown as loan origination interface 243.

As shown in FIG. 7, a loan agent, Tom Smith, has a personal account on system 200, in which his current loan application data is stored. A GUI 702, shown in FIG. 7, includes a window 704 to display the primary applicant's name, the loan request amount and the status of the loan application. GUI 702 also provides the loan agent with a loan summary window 706 to display detailed information for each pending loan application. Each time a new loan application is initiated, the application is added to the loan agent's account.

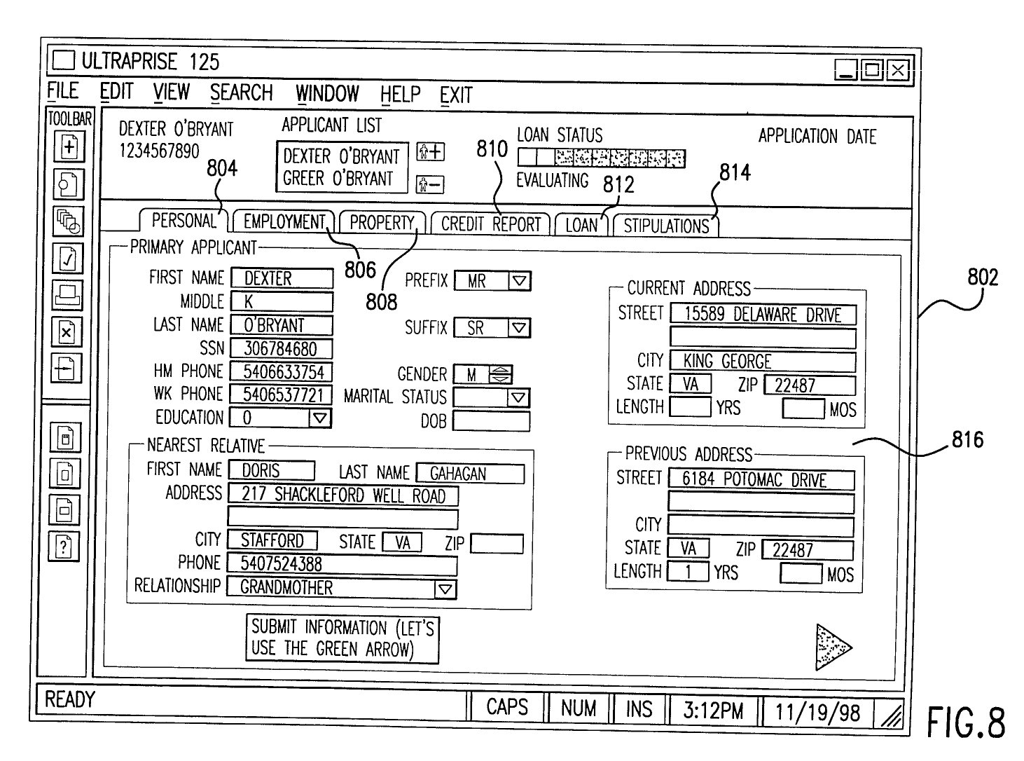

As shown in FIG. 8, to originate or update a loan application, system 200 provides the loan agent with a GUI 802 that is divided into six separate screens, noted by the tabs 804, 806, 808, 810, 812 and 814 across the top of GUI 802. These tabs are labeled Personal, Employment, Property, Credit Report, Loan and Stipulations, respectively.

A GUI 816 corresponding to tab 804 is shown in FIG. 8. GUI 816 permits the loan agent to input each loan applicant's personal information directly into loan origination interface 243. Examples of such personal information include the applicant's name, social security number, phone numbers, date of birth, addresses (current and previous) and nearest relative.

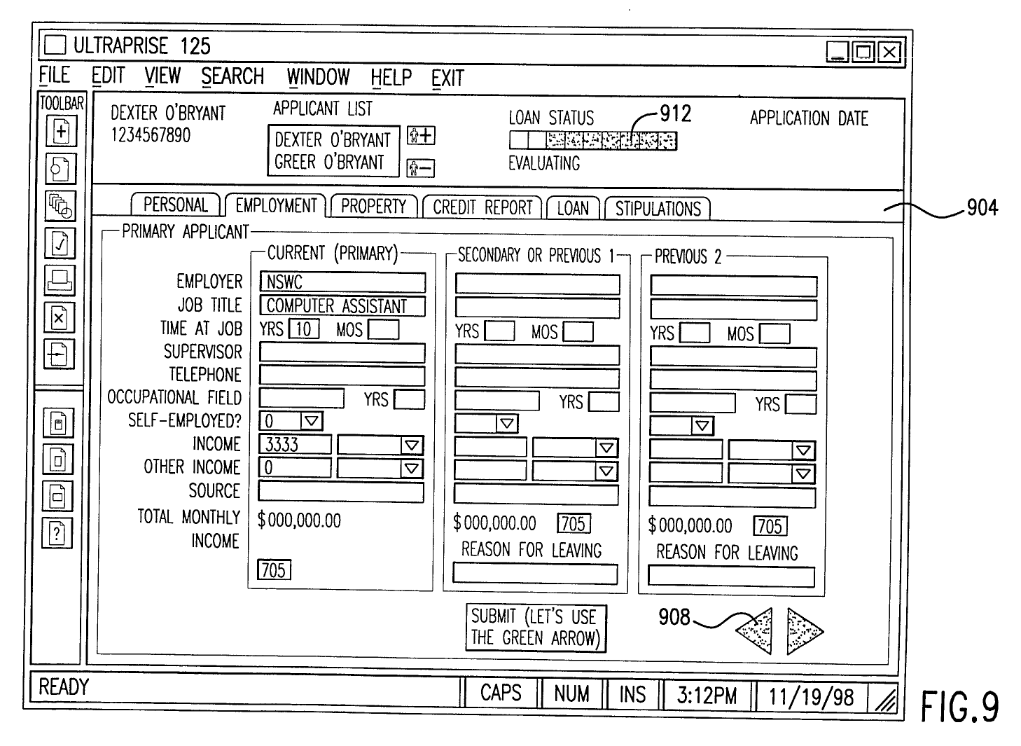

A GUI 904 corresponding to tab 806 labeled “Employment” is shown in FIG. 9. GUI 904 permits the loan agent to input each loan applicant's employment information directly into loan origination interface 243. Examples of such employment information include the name of the applicant's primary and secondary or previous employers, the applicant's job title, time at the job, supervisor, phone numbers, and income. An arrow 908 at the lower right corner of GUI 904 allows the loan agent to easily flip between the GUIs for each tab. Further, a loan status bar 912 at the top of GUI 904 depicts a graphical representation of the status of the loan application. Each of the GUIs shown in FIGS. 7-14 have a similar loan status bar 912.

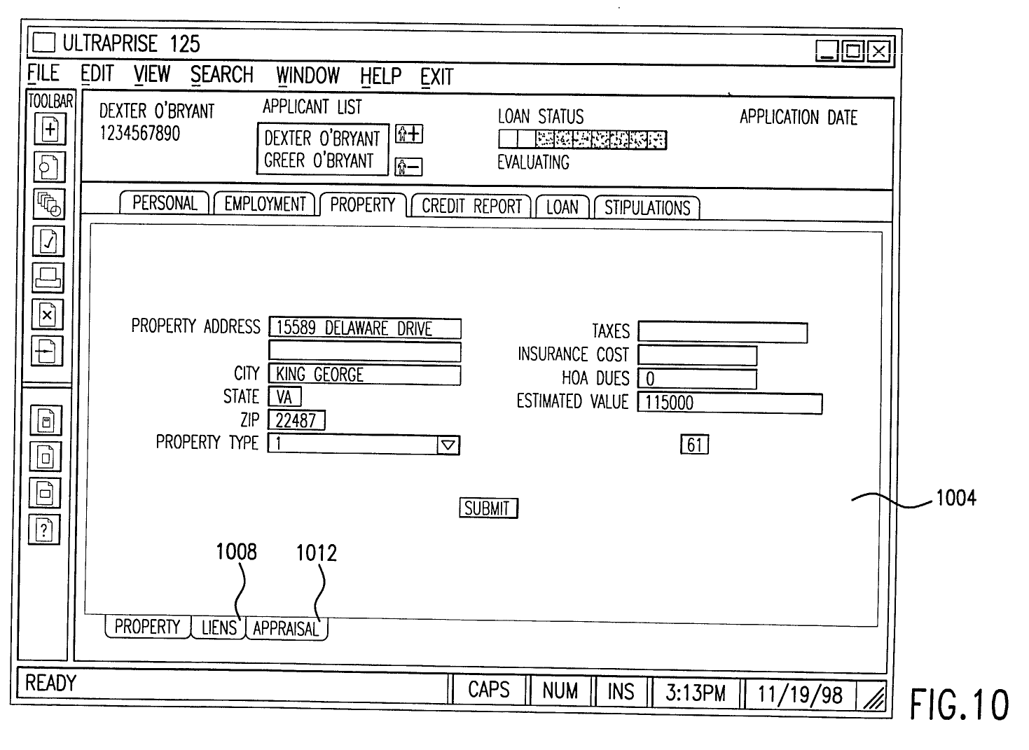

A GUI 1004 corresponding to tab 808 labeled Property is shown in FIG. 10. GUI 1004 permits the loan agent to input information about the loan applicants' property directly into loan origination interface 243. Examples of such information include the property address, property type, taxes, insurance costs, HOA dues and estimated value of the property. Additional tabs 1008 and 1012 at the lower left of GUI 1004 can be used to access additional GUls (not shown) to input information regarding any liens on the property and the appraisal information for the property.

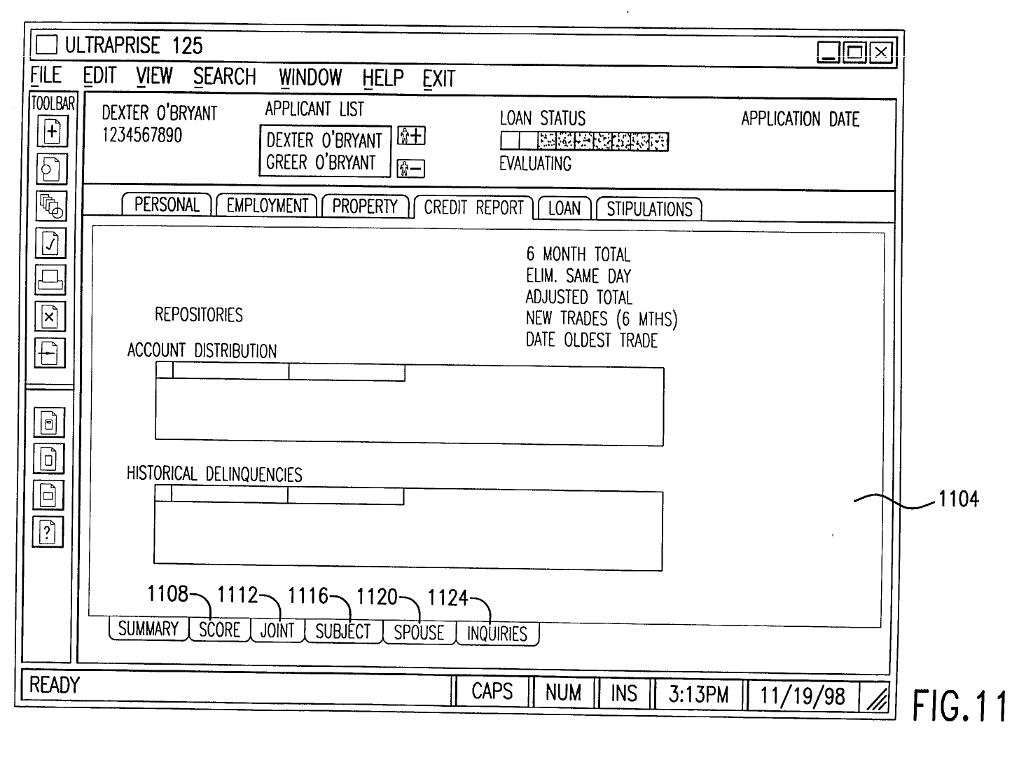

Referring to FIG. 11, a GUI 1104 corresponding to tab 810 labeled Credit Report is shown. GUI 1104 permits the loan agent to access summary information about each loan applicant's credit score from system 200. In one embodiment of the invention, the information relating to credit score is downloaded directly from a credit reporting agency via credit bureau frame cloud 268. Additional tabs 1108, 1112, 1116, 1120 and 1124 appear at the lower left of GUI 1104. Tab 1108 can be used to access an additional GUI (not shown) which includes more detailed information on the applicant's credit score. Tab 1112 can be used to access an additional GUI (not shown) which includes information relating to the credit information for a joint applicant. Tab 1116 can be used to access an additional GUI (not shown) which includes information relating to the loan application. Tab 1120 can be used to access an additional GUI (not shown) which includes information relating to the applicant's spouse's credit report. Tab 1124 can be used to access an additional GUI (not shown) which includes information relating to any inquiries that need to be made to confirm certain loan application information.

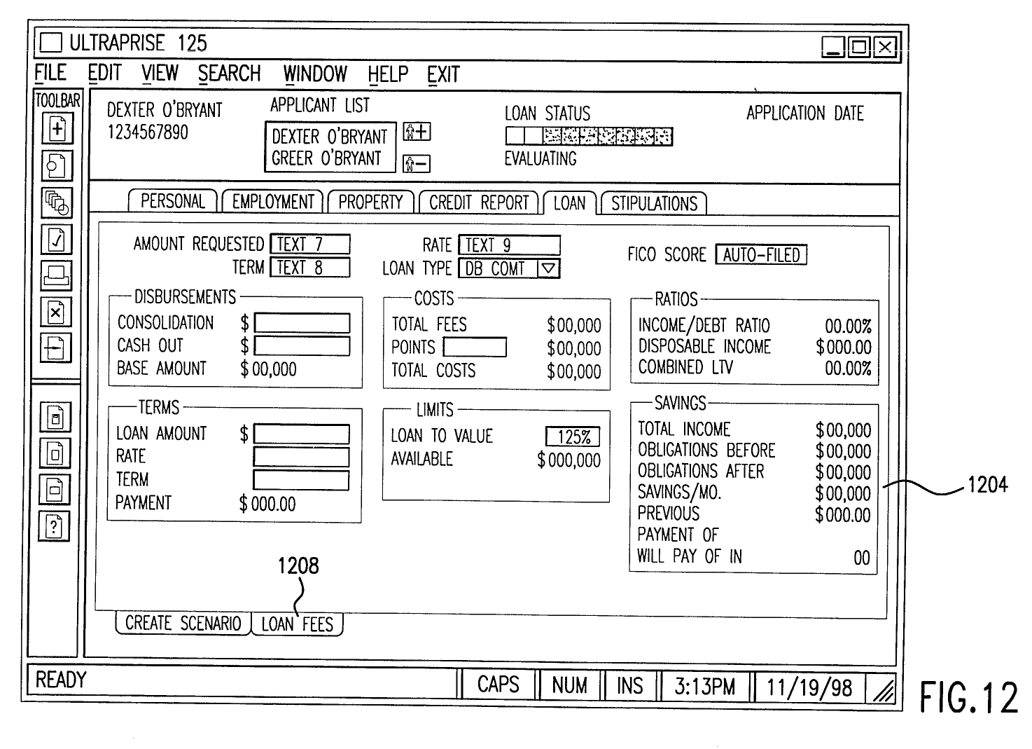

Referring to FIG. 12, a GUI 1204 corresponding to tab 812 labeled “Loan” is shown. GUI 1204 permits the loan agent to input and access information about the loan directly into and from loan origination server 242. Examples of loan information which may be input by the loan agent, include amount requested, term, rate, loan type, points, loan to value ratio. Examples of loan information which are supplied by loan origination server 242 include, FICO Score, income/debt ratio, disposable income, and savings and payment information. An additional tab 1208 appears at the lower left of GUI 1204. Tab 1208 can be used to calculate loan fees associated with the applicant's loan.

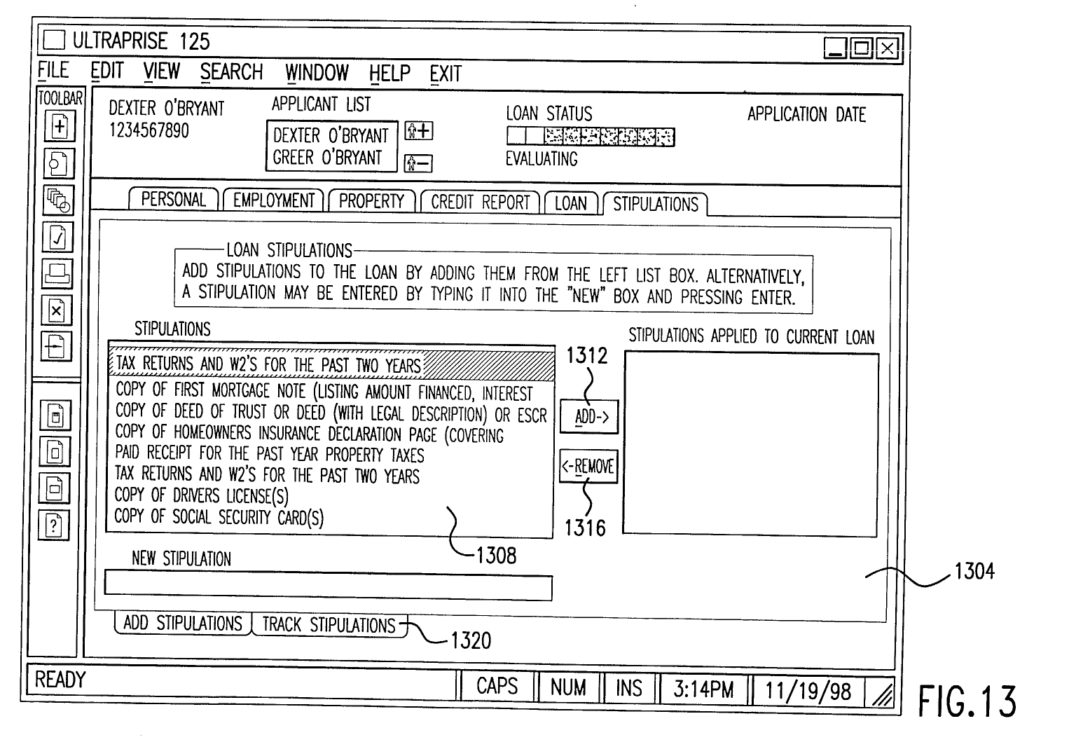

Referring to FIG. 13, a GUI 1304 corresponding to tab 814 labeled Stipulations is shown. GUI 1304 permits the loan agent to set certain stipulations relating to the loan directly into system 200. Common stipulations appear in a window 1308 on the left side of GUI 1304. Examples of such common stipulations include a requirement that for approval, the loan agent must obtain tax returns and W2 forms of the applicant for the past two years. Buttons 1312 and 1316 in the middle of GUI 1304 allow the loan agent to add and remove stipulations from the list in window 1308. An additional tab 1320 appears at the lower left of GUI 1304. Tab 1320 can be used to track the stipulations to mark when all of the stipulations have been met.

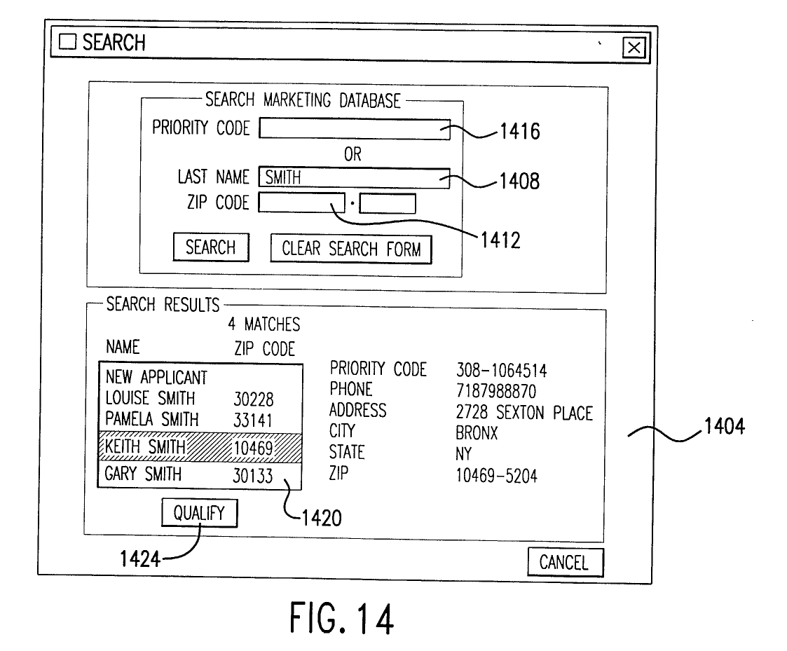

Referring to FIG. 14, a GUI 1404 shows an interface that can be used by the loan agent to search the marketing database for preliminary applicant information. When a loan agent receives a call from an applicant, the marketing database can be searched, using, for example, the applicant's last name and zip code, as shown in windows 1408 and 1412, or using a priority code, as shown in a window 1416, to match the applicant with the pre-existing information in the marketing database. The search results are displayed in a window 1420. As shown in FIG. 14, depending on the detail of the search information, more than one match may appear in window 1420. The particular applicant's name is then highlighted, and the applicant information for that applicant is displayed to the right of window 1420. When the user depresses a button 1424, labeled “Qualify”, the selected applicant's information is automatically entered into GUI 704 so that the loan agent must only verify this information and does not need to manually re-enter this information, thereby saving time.

Returning now to FIG. 6, in a step 608, the loan originator requests a credit report from a credit reporting agency. In the embodiment shown in FIG. 2, this request is sent to the credit reporting agency via credit bureau frame cloud 268. System 200 is configured so that the information obtained from the credit agency is automatically entered into the proper cells in graphical user interfaces of the system.

In a step 612, the loan originator may consult with portfolio subsystem 220 or trading subsystem 210 for market data relating to the types of loans currently in demand and the predefined rules for wholesalers relating to loan purchase. The information obtained by the loan originator is processed in exchange system 200 into a standardized XML format used by the DTM process as referenced below in FIGS. 25 and 26. This will enable the loan originator to know which types of loans to originate, and which types of borrowers look most attractive to the mortgage bankers.

In a step 616, the loan agent then evaluates the applicant's loan information, including credit score, and determines whether to pre-approve the applicant's loan request.

If the loan is not approved, loan application information is archived in a loan application data warehouse of system 200, as shown in a step 620. In the embodiment of the invention shown in FIG. 2, the loan application data warehouse includes, for example, databases 204a, 204b, 226 and 231. As would be apparent to one skilled in the relevant art(s), the loan application data warehouse is a collection of databases, and provides programming logic to allow a user to access all of the data in the databases at the same time. Returning now to FIG. 6, the applicant is then notified that the loan was declined, as shown in a step 624 and the interface between the loan originator and system 200 ends at a step 648.

If the loan is pre-approved, the loan application data is sent to the loan processor for processing and then to the underwriter for final approval, as shown in a step 632. There are similar GUIs (not shown) available through workstation 243 of loan origination subsystem 240 for use by the loan processors and underwriters to process and approve the loan.

In a step 636, the manager of the loan origination company then determines, using workstation 246, whether to give final approval to the applicant's loan request. If final approval is denied, the loan application data is archived in origination archive 226 of the loan application data warehouse, in step 620 and the flow follows as described above. If the loan is given final approval, the loan originator and application proceed through loan closing in a step 636 and funding is provided to the loan applicant in a step 640. Similar GUIs (not shown) are available through system 200 for use in loan closing step 636.

In a step 644, the loan application data for the approved loans is sent to system 200 to be archived in origination archive 226 of the loan application data warehouse, and the interface between the loan originator and system 200 ends at step 648. As explained above, in one embodiment, the loan application data, including both data for approved and unapproved loans, is uploaded to origination archive 226 once daily.

C. Exchange System 200

A person wishing to sell a loan or loan pool may access exchange system 200 via workstation 280d to publish a loan or loan pool for sale. In the case of a loan pool, the seller may first access system 200 via workstation 280f to create the loan pool. Workstation 280f can be used to search currently available loans for a seller using certain predetermined criteria (e.g., FICO score, loan amount, loan term, CRA compliance, etc.) to generate a pool of loans satisfying the search criteria. This pool can then be saved and stored in databases 221 and 222 of portfolio subsystem 220.

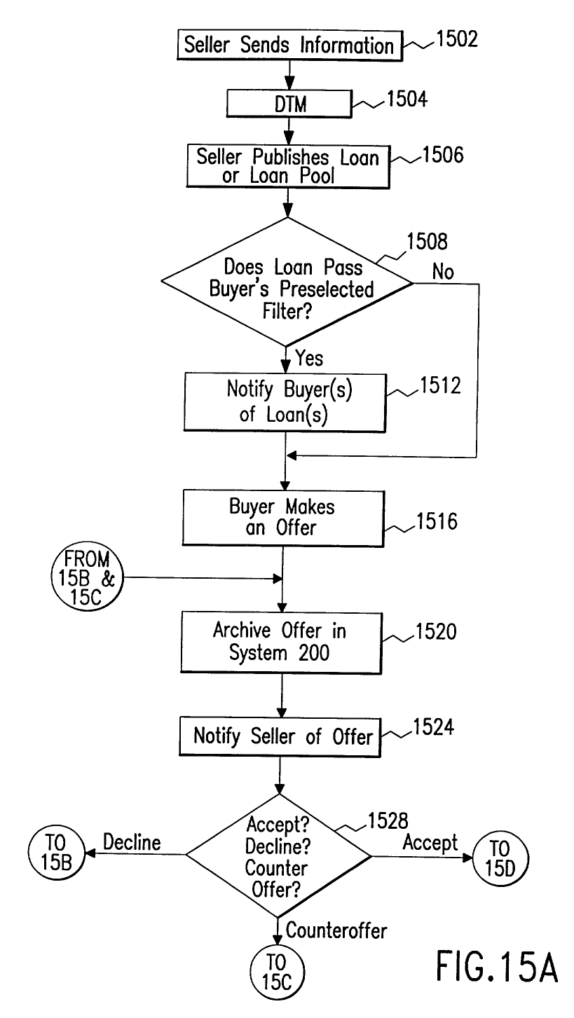

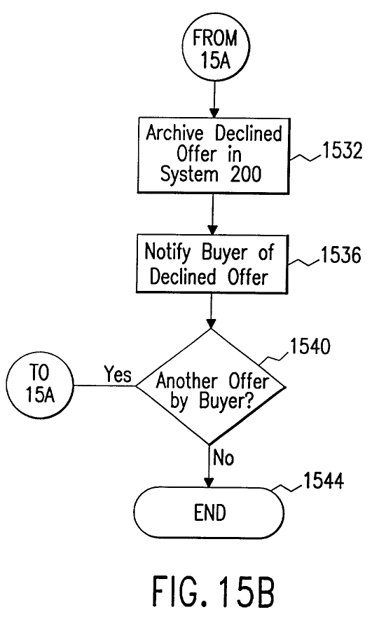

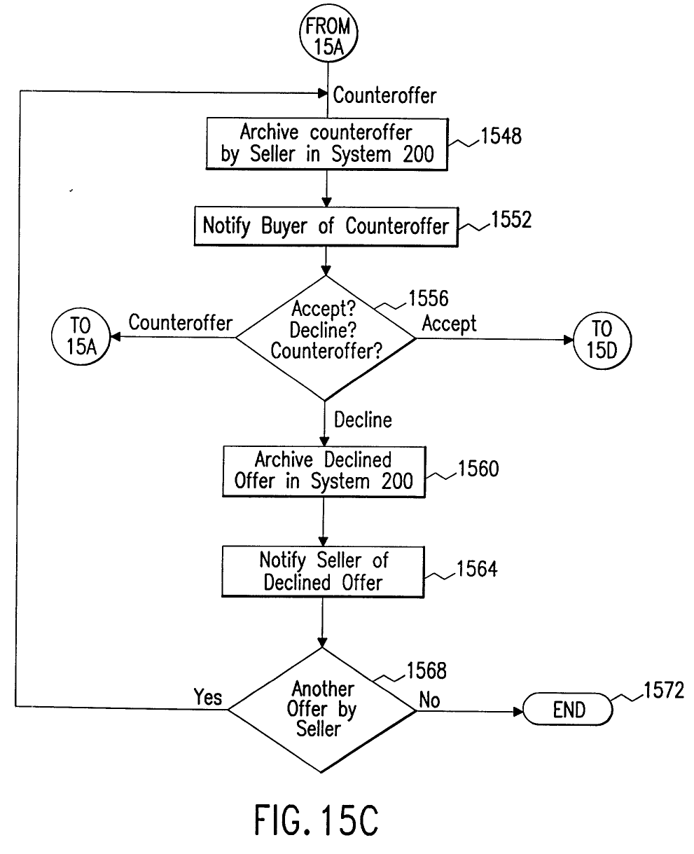

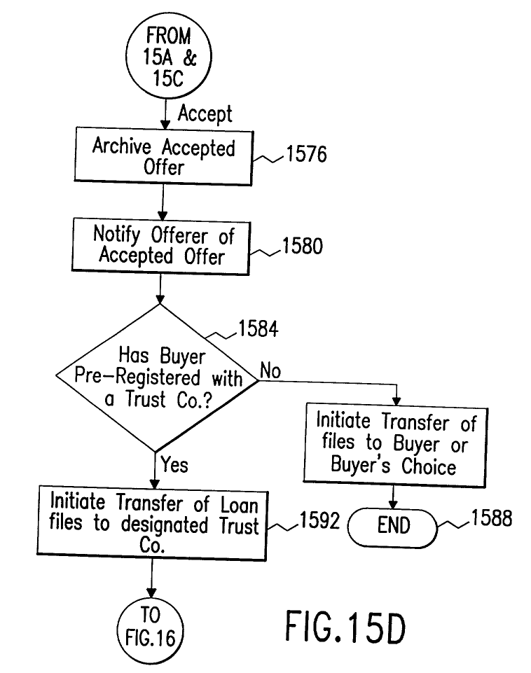

FIG. 15A is an example of bulk trading; however, the same system could be used for trading of a single loan, servicing rights, forward offerings or buyer axes, as discussed in further detail below. As shown in FIG. 15A, a seller wishing to sell a loan or loan pool sends the loan information to the exchange system in step 1502.

In step 1504, the loan information to be published by the seller undergoes a translation using a DTM process or other translation process. Translation products that may be used to implement this translation process include: Data Junction™ by Data Junction Corporation, DTS™ by Microsoft SQL Server. The DTM process of the present invention is described below with reference to FIG. 25.

As the data is being imported to the system, the system checks the data to validate that it is good data. For example, if the data for a loan being imported has a FICO score of less than 300, the system would know that this is incorrect and would send a message back to the sender to confirm and/or correct this data. Alternatively, the system might just flag the file as containing suspect data and post it on the system. In an alternate embodiment, the system might compare the data to comparables received from an independent source, e.g., appraisals of the property. The system could flag those loans whose loan amounts do not match the appraised value of the corresponding property.

In an alternate embodiment, the data is further reviewed after verification, and a preliminary evaluation of the loan data is made. Using predetermined system criteria, each loan or loan pool is given a score based on this preliminary review and analysis. The score could be based on a combination of factors including the reliability of the data, market factors, historical loan data, historical market data, etc. This provides potential buyers with an independent review of the value of the loan or pool using basic validation rules and other criteria that will be available for review by the buyer.

In step 1506, the loan information is published for sale on exchange system 200. The seller can publish the loans either by entering the loan information manually or uploading via workstation 280d or retrieving the loan information from origination archive 226 or databases 221 and 222 of portfolio subsystem 220.

One problem faced by smaller companies is that the larger investors will not consider buying loans from them because their pools are too small. Since the costs per transaction are often high, the larger investors are typically interested in purchasing only large pools of loans at a time. The system of the present invention allows several smaller loan companies to form cooperatives to pool their loans so that they are more attractive to the larger investors who use the system. The system enables this type of cooperative selling by automating the negotiation of terms of a co-op agreement. This makes the process of setting up a cooperative arrangement cost efficient.

In one embodiment, subscribers each have a profile archived in system 200. In the case of a cooperative, the cooperative may have its own profile archived in the system, including profiles of each member of the cooperative. The profile includes the subscriber's contact information, such as, the name of the company for which the subscriber works, the subscriber's telephone number(s), fax number(s), address information and electronic mail address information. The profile also includes a list of all loans or loan pools that have been published by the subscriber for sale in system 200. Other subscribers can access this profile information for review. The subscriber can also access his own profile to update the information therein.

In one embodiment, the subscriber can set up his rules for his profile using the loan criteria to indicate the conditions under which the subscriber wishes to be notified by the system of a published loan or loan pool. The subscriber may mark these predefined rules to be public, available to all subscribers for review, or private, not accessible to other subscribers. Further, the subscriber may opt to have sensitive loan data, such as social security numbers and name, removed until the loan undergoes the due diligence process. In addition, the subscriber may opt to add expiration dates or comments to offers, associate a particular “settle by” date, or have fees calculated automatically with bids.

In another embodiment of system 200, the subscriber can publish loan(s) on the system so that they can be seen only by a select group of potential buyers. For example, when the subscriber imports loan information to system 200, he may be given the opportunity to specify whether all subscribers to the system can view the loan(s) or whether only a specified list of buyers can view and bid on the loan(s). These specified buyers could be subscribers of the system or, perhaps, buyers with whom the correspondent has dealt before or with whom the subscriber would like to deal, but who are not themselves subscribers (e.g., members) of the system.

In the case of members, if a subscriber posts loan(s) and designates a particular set of buyers to see the loan(s) in private trading, a special alert message will appear on those buyers' accounts the next time that they log into the system. Alternatively, the buyers can receive an alert notification via any of the various notification methods described herein. The buyers can then access the loan detail information in a special area of the site that is accessible only to the designated individuals.

Although the preferred embodiment is described as a system in which users must join the system as members or subscribers, this may or may not include payment of any membership fees. In fact, in the preferred embodiment, becoming a member merely entails providing certain information about yourself prior to being able to trade loans on the system. This registers each user of the system and provides a check to make sure that the users are actually in the mortgage loan industry and not simple hackers or pranksters. In this type of environment, success turns on the ability sign up as many members as possible to the system. One way to increase visibility of the trading service and entice new members is through viral marketing.

In the case of non-members, the subscriber must provide the system with some means with which to contact the potential buyer to notify him of the loan(s). In one example, a subscriber provides the system with the name and email address of a potential buyer who is not a current member of the system. The non-member receives an email from the system which notifies that person that the subscriber has posted loan(s) on the system and wishes for the non-member to see these loan(s). The non-member is then provided with an address for the Web site. The non-member does not receive full access to site, however, he can obtain summary information on the specific pool of which he was notified. In this case, the non-member may be shown the name of the subscriber who posted the loan(s) and weighted averages of information in the loan pool. The non-member will then be prompted to become a member of the system to see the full loan detail and place a bid for the loan(s) on-line.

This viral marketing of the trading service allows members to market the service to non-members. The original notification message that was sent to the non-member can also be forwarded to other non-members, who may forward it to other non-members, etc. In this way, non-members can become familiar with the system of the present invention and through use of the system will eventually become subscribers.

The benefit of this private trading system is twofold. First, the subscribers will be able to control who sees certain loan(s) that they post on the site. Second, by allowing the subscribers to send alerts to non-members, the service will be able to expand its membership and increase the number of users of the service.

System 200 also allows subscribers to save certain groups of buyers in a list. For example, the subscriber can create a list of buyers to whom he would like to send his home equity loan pools. Every time the subscriber imports a pool of home equity loans, he can select his pre-defined home equity buyers list so that each party on this list would be notified of the pool. The system would also allow buyers who have been targeted by a particular subscriber to indicate to the system that they do not want to see loans from that subscriber. In essence, the buyer can “turn off” that subscriber so that postings from that subscriber are blocked or filtered out of the buyer's account. In this case, system 200 will notify the subscriber that the buyer has blocked postings from him so that he does not continue to market to that buyer. Further, system 200 will allow the buyer to add comments to the request to block a particular subscriber, so that the subscriber will know why he has been blocked (i.e., “I do not purchase loans from your geographical region,” or “We need to enter into a separate contract before I can purchase loans from you.”)

In an alternate embodiment, subscribers can deselect particular buyers, instead of creating a group. For example, there may be an occasion in which a subscriber would like to post a loan or loan pool for review by all members of the system except for a particular member. In that case, the system will allow the correspondent, when he imports loan(s), to indicate if the loan(s) should not be shown to any particular members.

The system may also allow subscribers to restrict the amount of loan detail information that a member can see about a posted loan until the correspondent evaluates whether he wants to provide the full detail to the particular member. For example, if a subscriber is trying to sell a distress product, such as a defaulting portfolio, he may not want all members on the system to know about this product. As such, the subscriber can select to have the system initially show members only some high-level summary information on the pool. If the buyer is interested, the correspondent may require him to sign a Non-Disclosure Agreement before the member is shown the loan detail information.

In a buyer-driven embodiment of private trading on system 200, the system allows buyers to create a list of sellers. In this case, the buyer will only see loans posted by the selected list of sellers. Although similar to the correspondent delivery system, in which a particular seller and a designated buyer can flow loans over CDS platform 2806, this buyer-driven model differs from the correspondent delivery system, because in this case, the seller is not delivering loans against a preset commitment of a certain volume or type of loan. Instead, the seller is posting the loans, as usual, but the buyer has reserved to deal only with a select group, or even just a single, seller.

After the loan(s) are published, exchange system 200 will test the loan information against the preselected rules for its registered buyers applying a Rule Based Filter (RBF), as shown in a step 1508. The RBF is made up of standard and special components. The standard component comprises basic logic checks and rules established by the database operator. For example, the system may check to ensure that the loan amount is within a certain value range, or check the number of digits within the social security number. The special component is comprised of user-defined rules which are typically applied in flow trading. For example, the user can specify that all LTV ratios above 100 should be blocked.

If the loan survives a particular buyer's filter, exchange system 200 may notify the buyer or buyers of the publication of the loan(s), as shown in a step 1512. This notification can occur in a variety of ways, depending on the buyer's notification preference. For example, the exchange system 200 might send an automatic electronic mail, telephone call, facsimile, or page to the buyer with notification that a loan has been added that meets the buyer's criteria and advising the buyer to check the Web site via workstation 280d or via a remote device. Such notifications can be sent via electronic mail, pager, telephone, facsimile, cellular phone, or hand-held computer.

In addition, the buyer can set up the account to monitor and “push” trading activity information to the user's computer screen-saver or window without having to be logged into the exchange system 200. This process of “pushing” uses the concept of instant messaging to listen for messages from the server and send notification of message to the subscriber's screen. In one embodiment, when the subscriber logs onto system 200, he receives a “buy alert” that displays new loans or loan pools that have entered the system 200 and that meet the subscriber's predefined rules. Also, while the subscriber is logged into his account on system 200, a “buy alert” may flash on the subscriber's computer screen if a new loan or loan pool meeting his predefined rules enters the system.

In one embodiment, a trading company profile may also be provided. If a subscriber is interested in a particular loan pool, he can use the trading company profile to find out information on the company that published the loan pool. This profile can include information such as contact information and contact persons at the trading company, years in business, net worth, financial product offerings, monthly loan volume and so on.

If the loan does not meet any of the buyers'preselected rules and if the buyer was not specifically designated by the seller for private trading, notification step 1512 is skipped and the loan remains published on exchange system 200.

The potential buyer can access the loan information on the system via workstation 280d. As discussed above, it would be apparent to one skilled in the relevant art(s) that the system could also be accessed via any of several remote devices. As such, subscribers can use the system either via a PC or via a remote device (e.g., two-way pager, mobile telephone or PDA). This is particularly useful for enabling deal making even when one or both of the parties are away from their offices.

For example, a subscriber, who imports a loan pool on to the system, designates a select group of buyers for private trading. Each designated buyer is sent a special alert. One of the buyers has set up his account so that special alerts for private trading opportunities are forwarded to him on his PDA. This buyer receives the special alert which notifies him that a special pool has been posted on the system by the seller. Because most remote devices do not have screens large enough to view all of the loan detail, the system is configured to send summary information on the loan pool to remote devices. The buyer can log on to the system via his remote device and see the summary information, the name of the seller, the results of the credit slotting of the loans in the pool using the buyer's own criteria, and a recommended price for the pool using either the buyer's pricing engine or the pricing model set up by the buyer. The buyer can then use his remote device to place a bid.

In the case of a seller using a remote device, the seller can check on the pools that he posted previously on the system to see if there are any bids on the pools and can receive notification of a bid the minute it is submitted by a seller. Once a seller is notified, the seller can use his remote device to log onto the system, see the bid price being offered, compare that price to the seller's price based on the seller's pricing model, and accept the offer immediately so as not to lose out on a good deal.

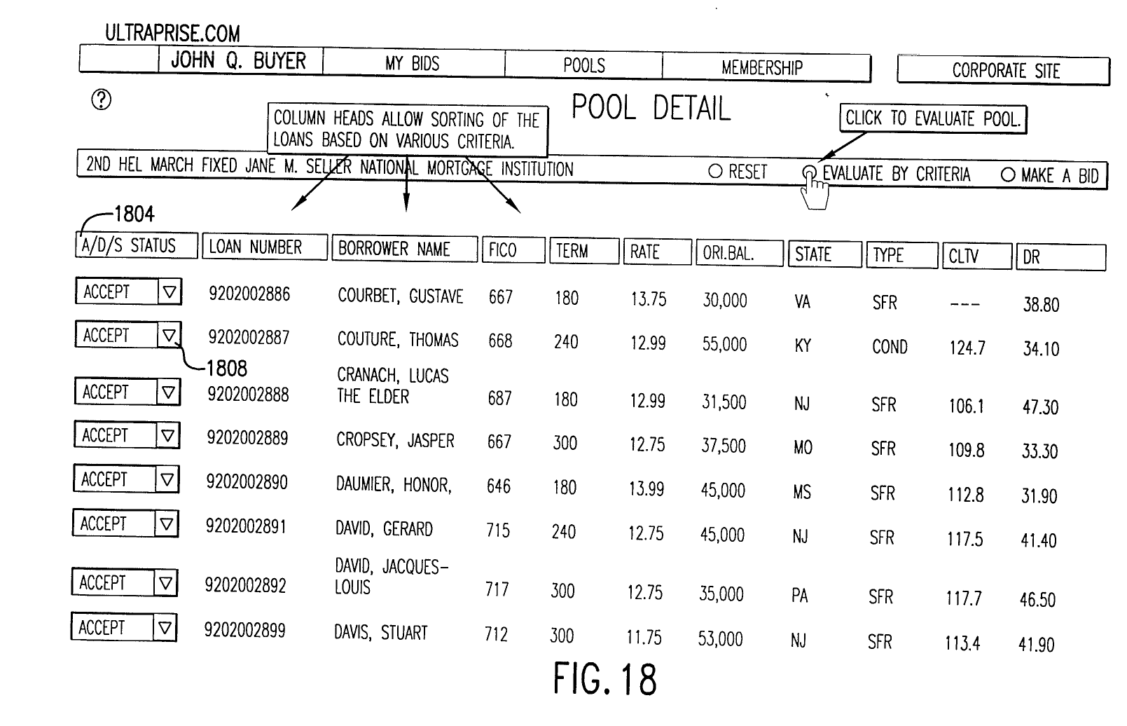

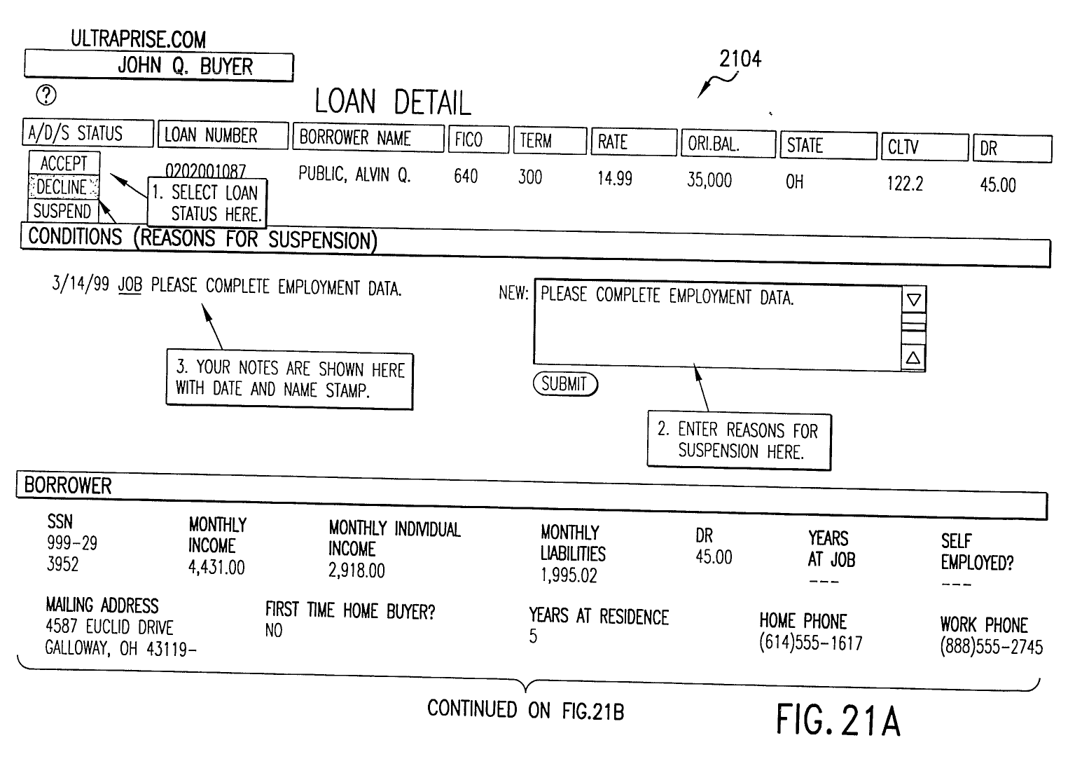

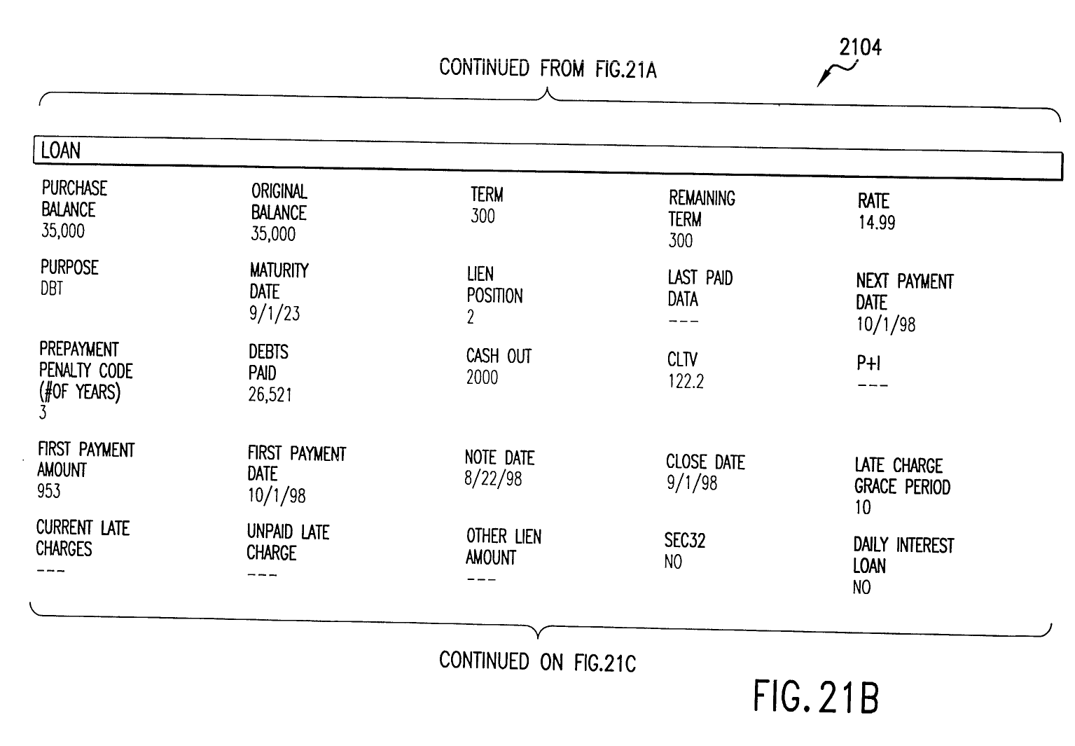

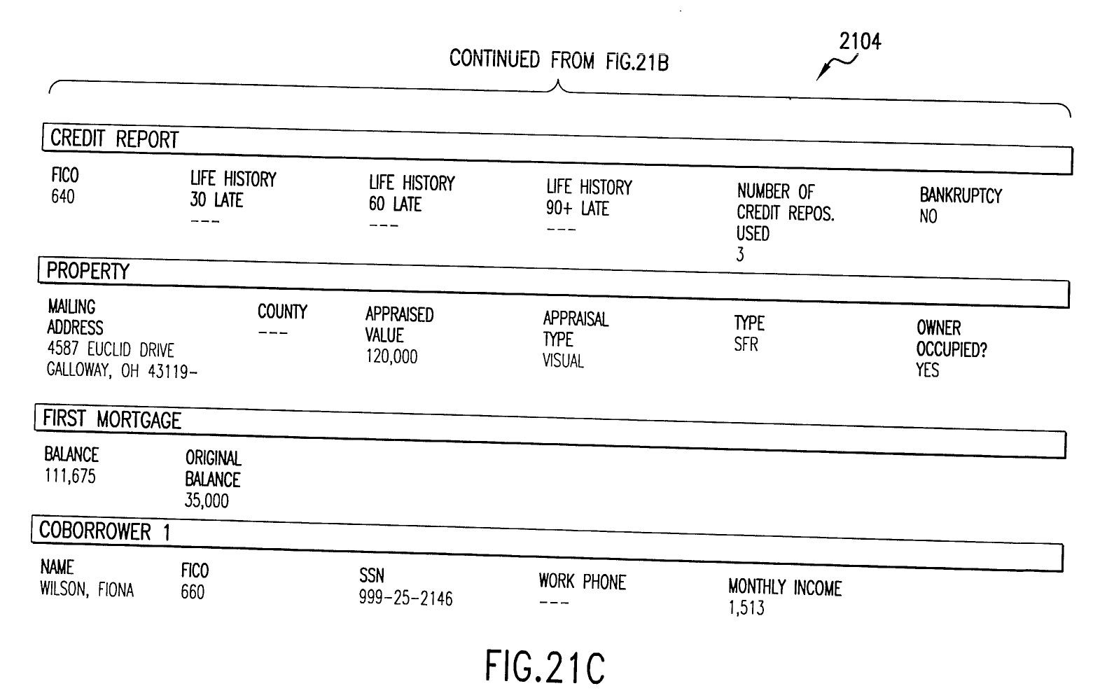

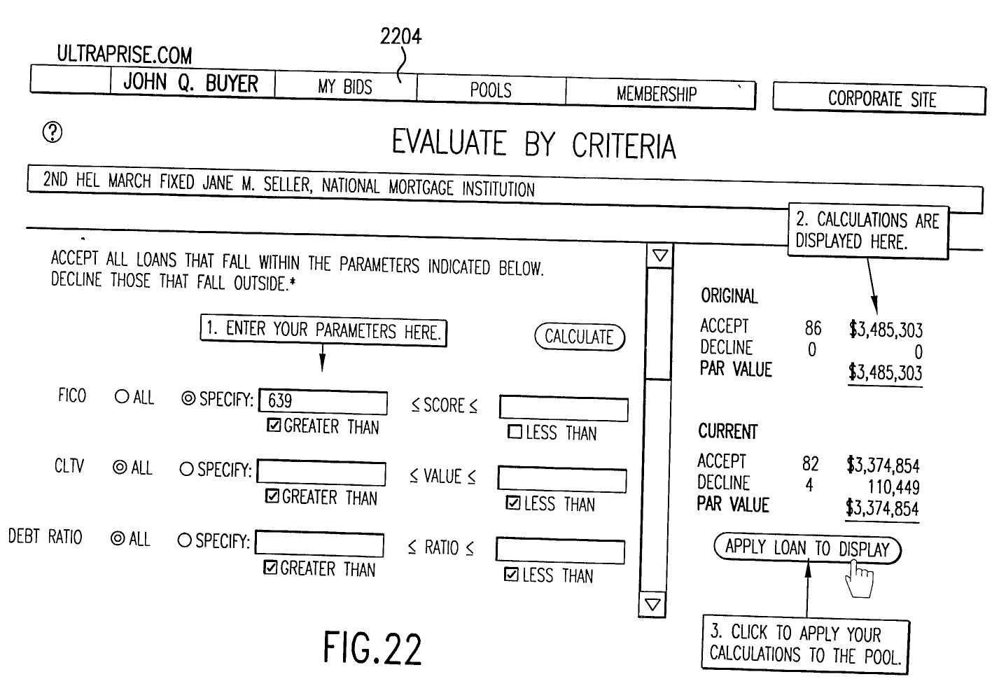

In the embodiment in which the subscriber accesses information on the system via a PC, a GUI 1804 may be provided to the buyer, as shown in FIG. 18. GUI 1804 presents information on each loan in the loan pool offered for sale to the buyer and allows the buyer to search the loan pool using certain criteria. For example, as shown in a GUI 2204 of FIG. 22, the buyer could search the loan pool for all loans with a FICO score greater than 639. Those loans meeting the selected criteria would be automatically accepted, while all other loans would be declined. The user can also manually accept, decline or suspend individual loans in the pool, using pull down arrow 1808 of GUI 1804. In one embodiment, the data in GUI 1804 is provided in a Microsoft Excel spreadsheet format. In order to decide whether to accept a particular loan, the buyer can also review more specific details on each loan in the pool, as shown in a GUI 2104 of FIGS. 21A -21C.

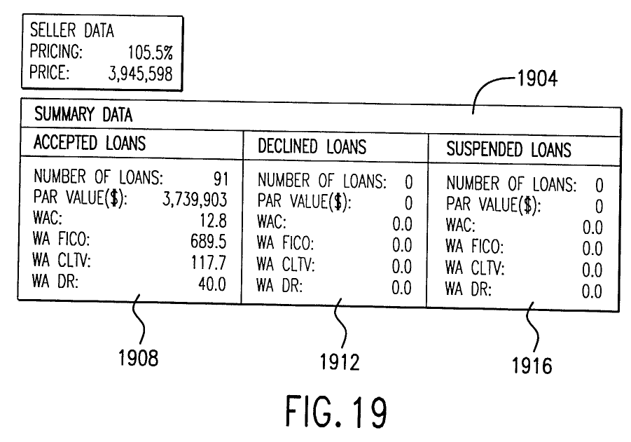

As shown in the lower left of GUI 1804 there are two tabs 1812 and 1816. The tab 1812, labeled “Detail” displays the information shown in FIG. 18. The tab 1816, labeled “Summary” displays the summary information shown in FIG. 19 in a GUI 1904.

The summary data is divided into three windows 1908, 1912 and 1916, which display information for all accepted, declined and suspended loans from the loan pool in FIG. 18. This allows the buyer, after performing a search of a loan pool, to use the summary information to determine what type of offer to make for the remaining, accepted loans from the pool.

In one embodiment, summary information on a pool can also be displayed using graphs, such as bar charts, pie charts, and similar graphs, and stratification reports, which are a break down of the data points in a particular category. For example, a graph of the distribution of all loans in a pool by FICO score may be used to graphically characterize a loan pool. The user will be able to determine how many loans in a pool fall within a particular FICO range. A similar graph can be generated after the buyer performs a search to show only those loans that meet the search criteria. The summary may also include information such as weighted averages of FICO score, loan term, loan rate, combined loan-to-value ratio, and debt ratio of the loans in the pool. This information can be generated both before and after a buyer performs a search.

In one embodiment, the system allows users to select any numerical or data stratification report, whether using certain default reports or creating custom stratification ranges. For example, users would be able to select the starting point for the first stratification group, the ending point for the last stratification group and the number of groups. The minimum and maximum points for the entire data sets are the default entries for the starting point of the first stratification group and the ending point of the last stratification group, respectively. Users can save the reports for viewing or printing. Users can create sets that include standard, dynamic and custom groups. For example, the user could select LTV as a custom group, FICO as a dynamic group or UPB as a standard or default group.

It is common for customers to want to stratify by various levels, so the system allows users to also customize the columns in the table portion of the stratification report. The standard or default stratification report for loans uses seven columns: # of loans, % of Pools UPB, UPB, LTV/CLTV, Maturity, Coupon and Margin. There are four standard or default stratification reports for servicing rights. The first report is by State and has six columns: # of Loans, % of Loans, UPB, % of Pools UPB, T&I Payment, Current Escrow. The second report is by Property Type and has four columns: # of Loans, % of Loans, UPB, % of Pools UPB. The third report is by Loan Purposes and has the same four columns as the second report. The fourth report is by Coupon Rate and has seventeen columns: Loan Amortization Type, Total UPB, # of Loans, Average UPB, Gross WAC, WA Servicing Fee, WA Original Term, WA Remaining Term, WA Loan Amount, P&I, T&I, Average Escrow, Delinquent 30, Delinquent 60, Delinquent 90, Delinquent 120, Foreclose.

The system allows users to select additional columns for the stratification report table from any numeric, percentage or flag database column. If the data column chosen is numeric or a percentage, then the weighted average for each group is displayed. The system also allows users to deselect any of the seven default columns. The system further allows users to save the customized columns as part of a “favorite view.”

Returning now to FIG. 15A, step 1516 represents when a buyer makes an offer for a loan or loan pool. In lieu of or in addition to a bid, the system of the present invention also allows users to send comments or other information to the seller via the system. For example, in one embodiment, a buyer may submit a bid on a loan pool and attach a comment asking that particular seller to send him any other pools having similar loans. Alternatively, a buyer who is not bidding on a particular pool, may still be able to submit a comment on the pool, for example, to tell the seller that the loans in the pool meet his criteria but were originated from an undesirable geographic region. Thereby, prompting the seller to send that buyer other similar loans from a different region. As such, the system enables users upon accessing their accounts to see the number of bids and/or comments that they have received on a particular posted pool.

The buyer can enter his offer and/or comments via workstation 280d or via a remote device, as described above. Exchange system 200 archives all offers made in database 203a, as shown in a step 1520. This information is subsequently used to calculate market prices for different types of loans, which includes fixed, adjustable, and balloon mortgages as well as first-lien (sub-prime, jumbo, conforming) and second-lien (sub-prime, home equity, home non-equity, Title I) products. Offers made by a subscriber can be canceled at any time before a final agreement is reached.

The seller who published the loan(s) is then notified by exchange system 200 that an offer has been made, as shown in a step 1524. Notification can be effected to the seller in any of the same manners as discussed above with respect to step 1512. Alternatively, the seller may have a personal account in exchange system 200 that he periodically checks. Exchange system 200 may notify the seller of incoming offers simply by posting the offer to the seller's account. In an embodiment, the seller may be able to receive notification in multiple locations, and respond to the notification via the same method in which the notification was received. For example, if the subscriber receives notification by pager, then the subscriber can send a message back on the pager to accept or decline the offer.

As shown in a decision step 1528, the seller must then decide whether to accept or decline the offer or whether to make a counteroffer. If the offer is declined, the flowchart continues in FIG. 15B.

As shown in a step 1532 of FIG. 15B, exchange system 200 archives the declined offer in database 203a. This information is also used to calculate market prices for loans.

In a step 1536, exchange system 200 notifies the buyer that his offer has been declined, and queries, as shown in a step 1540, if the buyer has another offer. If the buyer does not make another offer, the flow ends at a step 1544. If, however, the buyer makes another offer, the flow returns to FIG. 15A, at step 1520, which archives the second offer in exchange system 200, checks to see if the loan is still available and notifies the seller of another offer.

Returning to decision step 1528, if the seller makes a counteroffer to the buyer, the flow continues to FIG. 15C. The seller's counteroffer is archived in database 203a of trading subsystem 210, as shown in a step 1548. The buyer is then notified of the counteroffer as discussed above, as shown in a step 1552.

The buyer then must decide whether to accept or decline the counteroffer or make a second counteroffer, as shown in a decision step 1556. If the buyer makes a second counteroffer, exchange system 200 returns to step 1520 in FIG. 15A. The buyer's counteroffer is archived in exchange system 200 and continues as described above.

If the buyer declines the counteroffer, exchange system 200 archives the declined offer in database 203a, as shown in a step 1560. This information is used by exchange system 200 to calculate the market value of loans. In a step 1564, exchange system 200 notifies the seller of his declined counteroffer and inquires if the seller would like to make another offer, as shown in a step 1568. If no further offer is made by the seller, the flow ends at a step 1572. If another offer is made by the seller, the flow returns to step 1548 at the top of FIG. 15C.

Referring back to steps 1528 and 1556, if the seller accepts the original offer or the buyer accepts the seller's counteroffer, the flow then continues as shown in FIG. 15D. As shown in block 1576, the accepted offer is archived in database 203a of trading subsystem 210. This information is used by exchange system 200 to calculate the market prices for loans. Exchange system 200 then notifies the buyer or seller, depending on who made the last offer, of the accepted offer as discussed above and as shown in a step 1580.

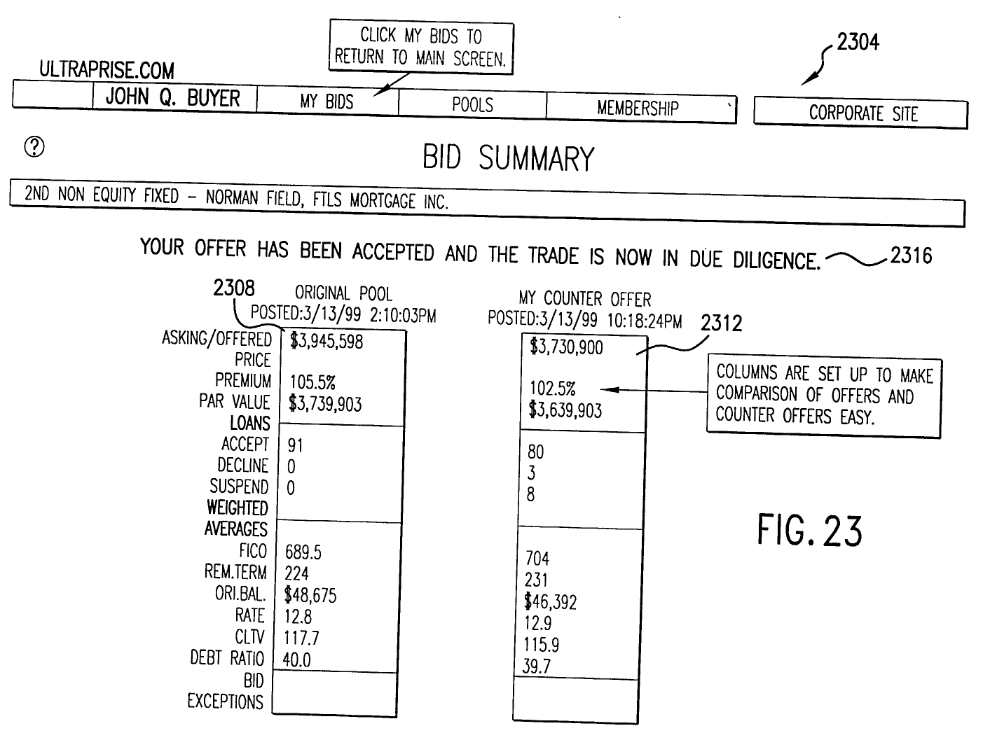

In one embodiment, a bid summary is provided, as shown in a GUI 2304 of FIG. 23. This summary includes the original asking price and detail information on the loans in the pool, as shown in a box 2308. Counteroffer information is provided in a box 2312. The status of the bid is displayed in a box 2316. For example, as shown in FIG. 23, the buyer's counteroffer has been accepted. The buyer may then be given the option to withdraw the offer or confirm acceptance.

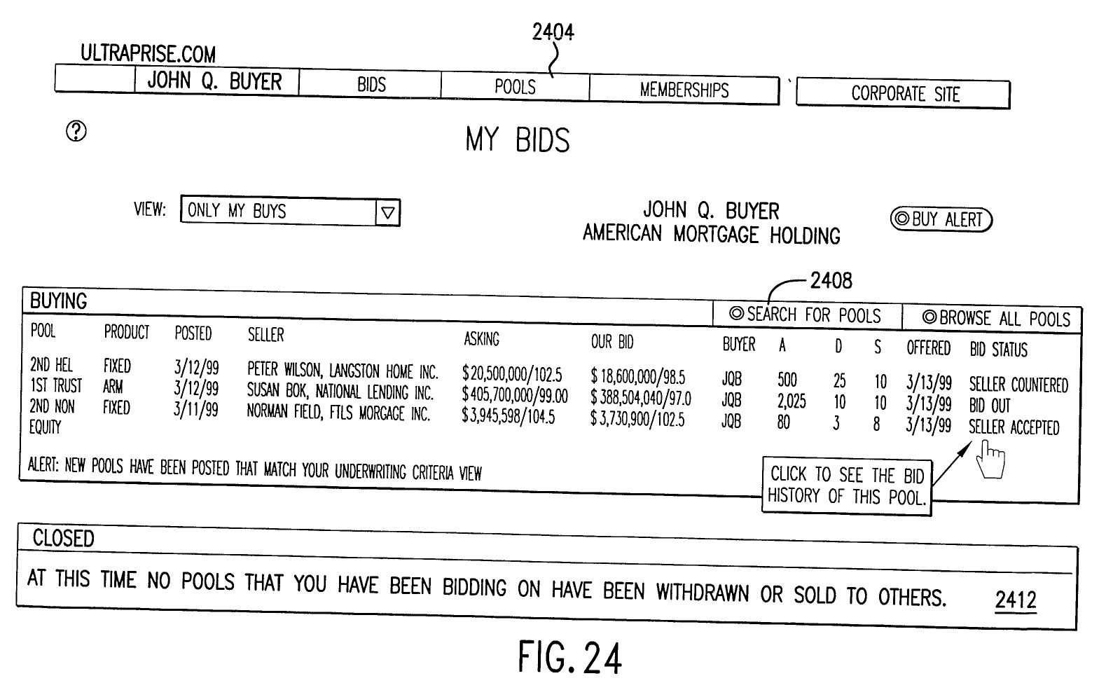

As shown in FIG. 24, the subscriber may also be provided with a GUI 2404 that summarizes the subscriber's buying and selling activity. GUI 2404 shows an example of the subscriber's buying activity. In a box 2408, the pools on which the subscriber has bid are shown. Information on the pool, including the pool number, date of posting, seller and asking price are displayed. Further, the bid information is shown, including the bid price, buyer's name, number of loans accepted, declined or suspended, and offer date. Finally, the status of the bid is displayed. This provides the subscriber with a summary of the up-to-date status of his trading activity. Further, in a box 2412, the subscriber's past trades can be summarized.

Returning now to FIG. 15D, once terms of a trade are agreed upon, exchange system 200 checks to see if the buyer has pre-registered with a trust company, as shown in a block 1584.

In a typical sale, there are many steps from offering to close of the sale. In a conventional sale, the buyer creates an offering memo including the loan detail information about the loans in the pool. Potential buyers then conduct due diligence on the loans in the pool and on the seller. Once the due diligence is completed, one or more buyers may bid on the pool and the seller accepts one of the bids. The parties then enter into a formal Purchase and Sale (P&S) agreement to transfer ownership of the loans to the buyer. This contract usually includes a firm price, representations and warranties by the seller about the loans, and has contingencies to adjust the price to account for loan payments that are made by the borrower between the time that the P&S is negotiated and the actual close of the sale. Either before or after the P&S agreement has been entered into by the parties, the seller then conducts a more detailed due diligence. If something arises during the detailed due diligence, the P&S may have to be renegotiated. The timing and extent of this more detailed due diligence will vary depending on the historical relationship between the parties. For example, if the buyer and seller have entered into many transactions in the past and have developed a relationship based on trust, the buyer may not conduct as detailed a due diligence analysis.

A typical due diligence analysis can range from a simple legal review of the loan documents to a full underwriting analysis. In a legal review, the buyer simply compares the information that was provided by the buyer in the offering memo with the actual information on the loan documents, to make sure that they match up. Finally, after the due diligence, the parties reconcile the purchase price with any changes that have occurred in any of the loans, prior to the buyer paying for the pool. These changes may include payments made by the borrowers on the loans that alter the overall value of the pool, loans that have gone into default, etc.

The present invention creates several efficiencies in the transaction described above. As such, the system dramatically decreases the amount of time from when the offer is accepted to when the close of the sale actually occurs. This simplifies the reconciliation at the loan close considerably and is a more efficient means to close a sale.

First, the system replaces the conventional offering memo with an on-line system, as discussed in detail above, for posting or otherwise providing loans for review by potential buyers. Because the loan detail information can simply be posted for many potential buyers to see all at once, the system of the present invention is much more efficient that having the seller create an offering memo and circulate it to selected potential buyers on an individual basis.

Second, the present invention allows for automated due diligence. The system validates and filters the loan data to flag or cut those loans that have suspicious or incorrect data. Once a bid has been accepted, the buyer can then use document imaging software to input the actual loan documents into the system. Once a document has been scanned and imported to the system, the system can uniquely key each document with a bar code so that it does not have to ever be scanned again. The system of the present invention will then use an Optical Character Recognition (OCR) tool, such as OmniPage™ software available from Caere Corporation, Los Gatos, Calif., to read the characters and extract the data from the scanned images. The seller can designate which loan documents and which pieces of information on these documents are of importance for its due diligence analysis. The system will then compare this information, recovered from the scanned loan documents, with the information that was imported by the buyer into the system to look for any discrepancies. The system will then provide the seller with a detailed report of the analysis. This automated due diligence analysis could also be used by third parties to the sale, such as a warehouse lender that would typically conduct its own due diligence before lending the buyer money to purchase the pool.

In an alternate embodiment, the system links to external services to conduct due diligence or provide information for a due diligence analysis of a loan or pool. For example, the user may be able to go to a common user interface on the Web Site for due diligence and select those external sources to pass the loan information to for analysis. The system saves a historical summary of all external requests made by a user. Preferably, the seller should only be allowed to request due diligence after he has accepted a bid. The user can select a single loan of a pool or an entire pool or just certain loans in the pool on which to conduct due diligence. Once the loans have been selected, the user can select one or more services to access. For example, one third party vendor of external services is a company called Lender's Service, Inc. (LSI). LSI is an aggregator of automated valuation models, and provides collateral assessment, flood determination, title insurance and closing management services. Another example of an external service provider is a company called New City, which provides fraud check against property location, social security numbers, credit checks and employment, etc. using its DISSCO service.

In this embodiment, the external service providers can be segregated by service (e.g., validate collateral, validate borrower credit, validate borrower income, validate borrower assets, validate legal documents). The user is given the option to set up and save his preferences for the specific external service providers and/or particular services that they wish to perform on a routine basis.

Once the user selects a service and service provider, the system synchronously checks for the presence of the required data for the service selected by the user. If the data does not exist, the system will immediately notify the user of what data is missing for which loan(s). If a charge is associated with the requested service, the system can also notify the user of the charge and give him the option to cancel or proceed with the request.

In a preferred embodiment, the system communicates with the external service providers using XML messages through an HTTPS post action to the external service provider. In turn, the external service providers communicate with the system using XML messages.

Third, the system of the present invention enables much of the negotiation of the Purchase and Sale agreement to be automated. In particular, the system allows members to post their standard P&S agreements. If a buyer makes a bid and the seller accepts the bid, the system automatically prompts the buyer to see if the buyer would like to send the standard P&S agreement to the seller. If the buyer chooses to do so, the system will automatically send to the seller's account a copy of the agreement. In one embodiment, the system has standard provisions that members agree to when they sign up as a member on the system. Other provisions of the P&S agreement remain open for negotiation. This will facilitate the negotiation of the P&S agreement by focusing the parties attention on only a few key provisions for negotiation. In an alternate embodiment, the system can set up a standard agreement on-line, allow the parties to negotiate terms on-line, and then enable digital signatures so that the agreement can even be signed on-line.

In an alternate embodiment, the system of the present invention allows the seller to link and unlink documents to offerings posted on the Web site at the time of import or at a later time. Documents posted by the seller are available to all subscribers who have viewing rights to the seller's posted offering. For example, if the seller wants to use a particular P&S agreement with a pool that he is posting, he can link the P&S agreement to the pool for review by prospective buyers. The buyer can click on the link to the document and even upload it as a .pdf file. Similarly, the system will allow bidders to attach documents at the time they place their bid. Documents attached to a bid by a buyer will only be viewable to the seller. Further, buyers and sellers can remove a document associated with an offering at any time prior to the offering being sold.

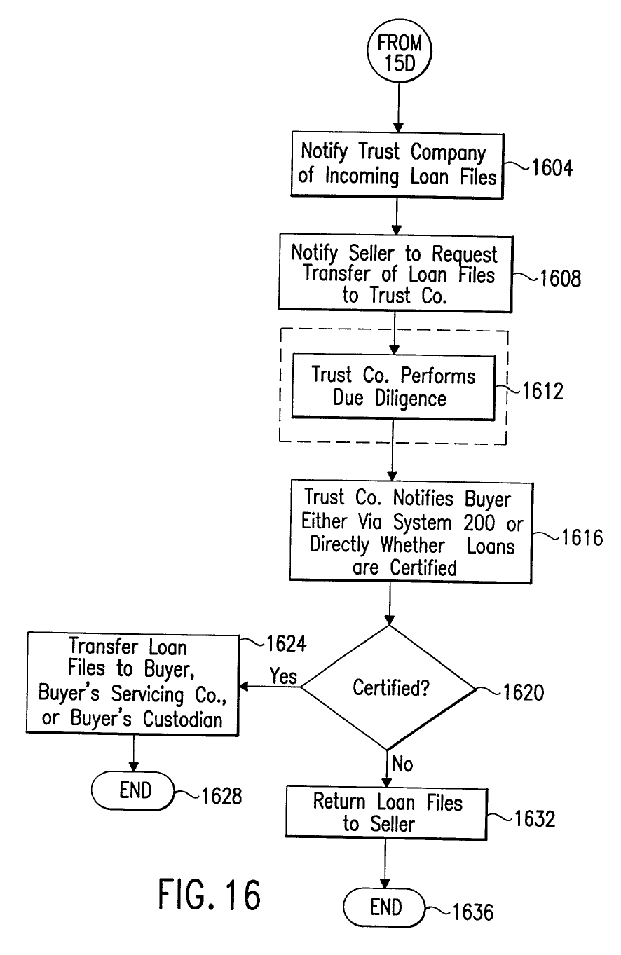

Returning now to FIG. 15D, if the buyer has not pre-registered with a trust company, then the files are transferred to the buyer or the buyer's choice in step 1586. After the initiation of step 1586, the flow ends at a step 1588. However, if the buyer is pre-registered, system 200 initiates a transfer of the purchased loan files to the designated trust company, as shown in a step 1592. The interaction between system 200 and the trust company is discussed in further detail below with reference to FIG. 16.

D. Trust (Due Diligence)

As shown in FIG. 16, system 200 notifies the trust company of incoming loan files in a step 1604. This notification can occur in several ways. For example, system 200 can notify the trust company via a letter, electronic mail, or other notification methods discussed herein.

System 200 further requests that the seller transfer the loan files directly to the trust company, as shown in a step 1608. As such, the buyer does not have to oversee this file transfer. This notification can be done simply by sending an electronic mail to seller, when the sale is completed, with the name and mailing address or electronic mail address of the trust company.

A hard copy of the loan files may be physically transferred via mail, courier or similar means to the trust company for review. In an alternate embodiment, as discussed above, the contents of the loan file are scanned and an electronic file containing the scanned documents is forwarded to the trust company via an electronic connection.

Then, independent of system 200, the trust company performs its due diligence review of the actual loan file, as shown in a step 1612. The dashed line in FIG. 16 represents that this step is being performed at the trust company site, outside of system 200. In another embodiment, the seller can transfer a loan file to the trust company prior to posting the loan on the exchange system for sale. The trust company would perform a due diligence analysis of the loan documents. If the loan passed the due diligence inspection, then the seller could mark the loan as certified on the exchange system.

Once the trust company completes its review of the loan files, it notifies this buyer whether the loans were certified, as shown in a step 1616. This notification is sent to system 200 via workstation 280c and may also be communicated directly by the trust company to the buyer.

If the loans are certified, as shown in a decision step 1620, the trust company transfers the loan files to the buyer or directly to the buyer's servicing company or loan file custodian, as shown in a step 1624. In one embodiment, system 200 may provide the trust company with notification of where to send the certified loan files via workstation 280c. For example, when the trust company notified system 200 that the loan files were certified in step 1616, system 200 may be programmed to automatically provide information to the trust company on where the loan files are to be sent. After this transfer has occurred, this interaction ends in a step 1628.

If the loans are not certified, the loan files are returned by the trust company to the seller, as shown in a step 1632 and the interaction ends in a step 1636. As would be apparent to one skilled in the relevant art, in an alternate embodiment, the loan files that are not certified could be forwarded to the seller's designee, e.g., loan file custodian.

E. Servicing

Once a loan or loan pool has been purchased by a buyer having a pre-registered servicing company, system 200 initiates a transfer of loan information to the servicing company via servicing gateway 250, as shown in a step 1704. This process is called “servicing released” in which both the loan(s) and servicing rights are sold together. However, in some circumstances, the seller may choose to sell the servicing rights to a loan or loan pool separate from the loan. In this case, referred to as “servicing retained”, the selling of the servicing rights to a loan or loan pool would be handled by system 200 in the same manner as discussed in FIGS. 15A-15D with respect to sales of loans. As such, the seller would publish the servicing rights to the loan or loan pool for sale, as shown in step 1506. The process for selling the servicing rights separately would continue as with the posting and selling of a loan. Thus, for example, in step 1704, exchange system 200 would transfer the information to the servicing company that purchased the servicing rights of a loan or loan pool. Users of the system have the choice of designating whether a pool contains whole loans without servicing (“servicing retained”), while loans with servicing (“servicing released”), or servicing rights only.

The type of data reviewed by a potential buyer of servicing rights is often different from the loan data set reviewed by a potential buyer of loan. Specifically, the purchase of servicing rights may want to see additional detail about the loan and loan history before submitting an offer to purchase the servicing rights for that loan. As such, the data points shown below in Table 4 may be added to those already described in Table 2.

TABLE 4
SERVICING RIGHTS CRITERIA
LOAN LEVEL DETAIL

Monthly Other Fees
Monthly Taxes
Monthly Insurance
Total Delinquencies (life of loan)
Total Delinquencies (last 12 months)
Currently delinquent status
Loan 120 Day Late
Interest on Escrow
Interest Paid Through
Lender Paid PMI
Late Fee Percentage
Late Fees Due
Payment Due Date (Day of month)
Remittance Type

As disclosed above, the system allows users to sell servicing rights to the loans sold on the system, either along with the sale of the loan or separately from the loan.

If the servicing rights are sold as a pool, the potential buyer of the pool may also want to review pool level data elements, such as the data points shown below in Table 5.

TABLE 5
SERVICING RIGHTS CRITERIA
POOL LEVEL DETAIL

Offering Type (e.g. whole loan retained,
whole loan released, servicing only)
Pool Insurance
Pool Margin
Recourse
Pool ID/CUSIP #
Security Type (e.g. FNMA Standard,
FNMA Express, FHLMC Gold, FHLCM
Arc, GNMA I, GNMA II, Private Label
MBS, Private Label ABS, Other)
FHA/VA Ratio
Data as of date _ [insert date]

Further, the potential buyer may also want to review data elements relating to the transfer of the pool of servicing rights. Examples of such data elements are shown below in Table 6.

TABLE 6
SERVICING RIGHTS CRITERIA
POOL TRANSFER DETAIL

Sale Type (e.g., Spot, Forward)
Delivery Option (e.g., Mandatory, Best
Efforts, Forward Commitment)
Delivery Period (days)
Data Transfer Method
Tax Service Provider
Master Servicer
Sub-Servicer
Document Custodian

Further, there are approximately twenty additional Pool Summary calculations required for a potential buyer to analyze a pool of servicing rights. Provided below in Table 7 is a list of each pool summary data element and a description of what is being calculated.

TABLE 7

| SERVICING RIGHTS | | | |
|---|---|---|---|
| CRITERIA POOL SUMMARY | | | |
| DATA ELEMENTS | | CALCULATION | |
| 1. | Current Escrow Balance | 1. | Total Current Escrow balance |
| | | | of all loans. |
| 2. | Monthly P & I Constant | 2. | Total P & I Payments of all |
| | | | loans |
| 3. | Monthly T & I Constant | 3. | Total T & I Payments of all |
| | | | loans |
| 4. | Weighted Average Servicing | 4. | Average from Servicing Fee |
| | Fee | | Pct data element |
| 5. | Weighted Average Original | 5. | Average # of months from |
| | Term | | Original Term data element |
| 6. | Weighted Average Remaining | 6. | Average # of months from |
| | Term | | Remaining Term data element |
| 7. | Weighted Average Age | 7. | Average age (years) from Age |
| | | | data element |
| 8. | FHA/VA Ratio | 8. | Ratio of number of GNMA- |
| | | | FHA loans to GNMA-VA |
| | | | loans |
| 9. | 30 Day Delinquency | 9. | Total number of loans with |
| | by # of Loans | | any value >0 in the loan 30 |
| | | | day late field. |
| 10. | 30 Day Delinquency | 10. | Total % of loans with any |
| | by % of Loans | | value >0 in the loan 30 day |
| | | | late field. |
| 11. | 60 Day Delinquency | 11. | Total number of loans with |
| | by # of Loans | | any value >0 in the loan 60 |
| | | | day late field. |
| 12. | 60 Day Delinquency | 12. | Total % of loans with any |
| | by % of Loans | | value >0 in the loan 60 day |
| | | | late field. |
| 13. | 90 Day Delinquency | 13. | Total number of loans with |
| | by # of Loans | | any value >0 in the loan 90 |
| | | | day late field. |
| 14. | 90 Day Delinquency | 14. | Total % of loans with any |
| | by % of Loans | | value >0 in the loan 90 day |
| | | | late field. |
| 15. | 120 Day Delinquency | 15. | Total number of loans with |
| | by # of Loans | | any value >0 in the loan 120 |
| | | | day late field. |
| 16. | 120 Day Delinquency | 16. | Total % of loans with any |
| | by % of Loans | | value >0 in the loan 120 day |
| | | | late field. |
| 17. | Foreclosures by # of Loans | 17. | Total number of loans where |
| | | | the value Y or Yes is in the |
| | | | Foreclosure Flag field. |
| 18. | Foreclosures by % of Loans | 18. | % of loans where the value |
| | | | Y or Yes is in the Foreclosure |
| | | | Flag field. |
| 19. | % of Properties Owner Occupied | 19. | % of loans where the value Y |
| | | | or Yes is in the Owner |
| | | | Occupied Flag field. |
| 20. | Total Delinquencies | 20. | Total of the data elements: |
| | | | 30 Day Delinquencies by # of |
| | | | loans + |
| | | | 60 Day Delinquencies by # of |
| | | | loans + |
| | | | 90 Day Delinquencies by # of |
| | | | loans + |
| | | | 120 Day Delinquencies by # |
| | | | of loans. |

Often, the amount of detail data that is needed to complete the sale of servicing rights separate from the underlying loans is greater than if the servicing rights were sold with the loans. Further, much of this data is in flux because typically the loan is being paid down by the borrower during negotiations over the sale of the servicing rights. As such, as soon as the seller posts the servicing rights detail information on the system for review by potential buyers, the data is stale. The same problem occurs with loan detail information. For example, if the seller posts a loan on the system on the first of the month, and the borrower makes a mortgage payment on the fifth of the month, information, such as the remaining loan balance, LTV and last payment date, are stale after that payment has been made.

One solution to this problem is referred to herein as base lining. Base lining allows a seller to post a loan(s) on the system, including loan detail information and servicing information, and then refresh the data at a later date. This updated information can be sent from the seller or could be imported from the servicing company for the loan directly. The system will keep track of how the data has been changed so that the potential buyer can see how the loan data has been altered over time.

When a potential buyer enters a price for a pool containing servicing rights, i.e. either a pool of servicing released loans or a pool of servicing rights only, the system displays the price using two different price types: Multiple and Servicing Premiums. If the user enters the price as a Multiple, the system calculates the Servicing Premium using the following equation:

Weight Average Servicing Fee (WASF)×Multiple=Servicing Premium,

where the WASF is weighted by UPB. Similarly, if the user enters a price as a Servicing Premium, the system can calculate the Multiple, using the above equation.

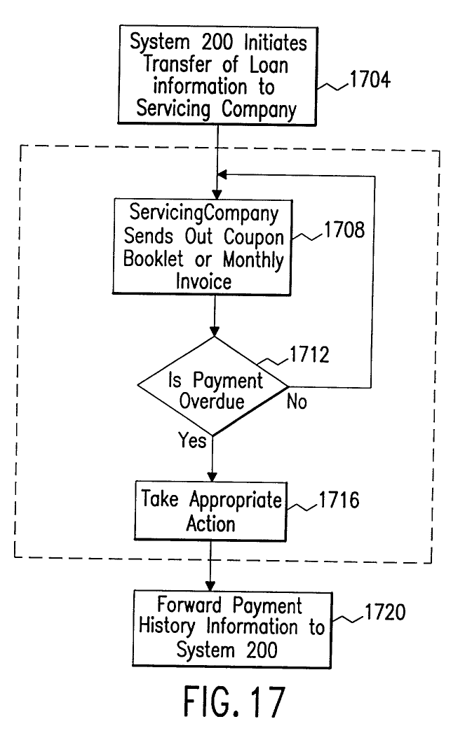

Returning to FIG. 17, the servicing company uses loan information provided by system 200 to send out coupon booklets or monthly invoices, as shown in a step 1708. The servicing company then monitors the borrowers monthly payments and archives history payment information. For example, the servicing company will store information indicating whether the borrower made a monthly payment on time.

If a payment is overdue, as shown in a decision step 1712, the servicing company decides what action is required, in a step 1716, such as filing a claim in bankruptcy, or filing a claim in court for overdue payments. Often, the servicing company will place several calls to the borrower to resolve any overdue payments before filing claims.

The servicing company can access system 200 via workstation 280h to periodically forward this payment history information back to the system 200 as shown in a step 1720. In particular, the servicing company sends servicing information back to system 200 via servicing gateway 250 to update the system. In one embodiment, this updating occurs nightly, however, it would be apparent to one skilled in the relevant art(s), that such updates could occur more or less frequently, as desired.

Many servicing companies employ mortgage service software such as the Mortgage Servicer Systems software available from Financial Industry Computer Systems (FICS) Group of Brussels, Belgium. The invention interfaces with such software to facilitate upload and download information from servicing gateway 250 to and from system 200.

F. Securitization

As shown by a block 320 in FIG. 3, the investors can access system 200 via workstation 280e look for loan pools for sale by mortgage bankers to purchase. Using trading subsystem 210, investors can make bids on loan pools for sale on the system 200. The investors then use collections of these purchased loan pools to create mortgage-backed securities, as discussed in detail above. The investors can publish these mortgage-backed securities on system 200 via workstation 280e for sale to interested buyers.

G. Brokerage

As explained above, brokerage firms may be employed by the investors to find buyers for the mortgage-backed securities. As shown by a block 324 in FIG. 3, these brokerage firms can access system 200 via workstation 280g to find out risk-return statistical information about the loans in the loan pool that are being used to back the mortgage-backed security. Further, the brokerage firms can access information from system 200 via the workstation 280h to find out payment history information for the loans in the loan pool.

H. Credit Rating

As shown by a block 336 in FIG. 3, a credit rating agency, typically hired by the brokerage firm to rate a mortgage-backed security, can access system 200 to review the payment history and risk-return information in system 200 in order to rate a particular security. For example, the credit rating agency can review the payment history of the loans used to back a particular mortgage-backed security, to determine whether the loans are likely to be prepaid or go into default.

I. Risk/Return

A risk-return module, represented by risk-return interface 332 in FIG. 3, is accessed via workstation 280g and is meant to provide the subscriber with quality control and risk analysis data as they use the exchange system 200 in their decision-making processes. In one embodiment, the risk-return module includes, for example, one or more of the following calculations typically known and used by one skilled in the relevant art to make a determination of risk associated with a particular loan or loan pool: prepayment calculations on a loan or loan pool, duration calculations on a loan or loan pool, convexity (γ distribution), vega, derivative with respect to total prepayment, housing turnover, refinancing, conditional prepayment rate (CPR), option adjusted spread (OAS), value at risk (VAR), cash flow, total rate of return, price/yield calculations, and scenario builders for cash flow analysis.

In one embodiment, the risk return module further includes an index of trade data from live transactions or trades that occur over the exchange system 200. This trade data may include, for example, volume of trades, weighted average coupon, average combined loan-to-value ratio, average FICO score, average term of loan, average rate and average debt ratio.

The risk return module may also incorporate other data points from externally running subsystems such as, but not limited to, the loan origination subsystem 240 and servicing subsystem 250. The risk-return module is designed to be very flexible in nature. This means that all processes read initialization files (*.ini) upon starting to set parameters. Command line arguments and GUI methods of setting variables during execution are also important functions.

The data contained in the risk-return module is important because it is shared across many different subsystems within exchange system 200. As outlined below, reports and visualizations, such as graphs, of data in the risk return module are provided for the subscribers. Through operation of the system 200 over time, the data in the risk return module allows for predictive modeling. The purpose of the risk return module is to use collect the data over time to build dependence from subscribers on the system 200 so that full trade-based decisions can be made based on the data available to the users in the risk return module, similar to data relied on by individuals involved in transactions on Wall Street today.

Neural-network technology can be used in the risk-return module. The network will train off of real-time trades that are occurring in trading subsystem 210 within the exchange system 200. The data in the risk-return module evolves over operation time of the system 200. Thus, as will be apparent to one skilled in the relevant art(s), necessary measures within the risk-return module must be taken in order to protect and secure the data used within it.

There is also statistical and scientific analyses conducted within the risk-return module. The results of these analyses are presented to the user in the form of graphs and other visualizations of the data. These graphs and other visualizations are more easily used by the subscribers than massive numerical reports. Massive reports can also be provided, however, to illustrate those details of the calculations that may not be readily apparent from the visualizations of the data.

In one embodiment of the invention, the risk-return module provides a graph similar to a NAV-type graph that is time focused, such that it correlates time with some value that changes over time. In the invention, this variable is often focused around money (e.g., volume of trades, value of trades, etc.). While time will be on one axis, the other axis will contain sellers or buyers. As such, a subscriber will be able to peruse (at-a-glance) what other companies within the exchange system 200 are doing.

In an embodiment of the invention, an index of the risk return module includes graphs of the following information: (1) single company number of trades over time; (2) multiple company number of trades over time; (3) volume of trades on the trading system over time; (4) total number of bids and sells over time; and (5) changes in company criteria over time. The preceding listing of graphs is provided by way of example only. It would be apparent to one skilled in the relevant art(s) that graphs depicting the change over time of other types of data may be useful as a predictor of risk.

In one embodiment, access to the risk-return module is provided over a secure public-key cryptosystem web connection (e.g., SSL). As such, the risk return module functions are limited to a service-based environment along with the actual trading platform (i.e., subsystem 210). This configuration allows for quick updates, and immediate updating with new functionalities. This is particularly important to the exchange service provider organization because it may test different prediction algorithms and the like, as they are discovered/developed, and the ability to swap and make new algorithm outputs available to subscribers in short order is needed.

The risk-return module interfaces with the following subsystems (as described in FIGS. 2A and 2B above), each with their own unique data repository: loan origination subsystem 240, trading subsystem 210, portfolio subsystem 220, and boarding relay server 225 conduit. Boarding relay server 225 conduit is a secure transport and relay mechanism that exists at the exchange system 200. The data that is piped through boarding relay server 225 conduit will be archived and usable by analyses processes of the risk return module. In one embodiment, this conduit is based in part on the open Extensible Markup Language (XML) specification maintained by the World Wide Web Consortium (W3C), whereby many other potential processes are able to read these files during integration with one of the several (freeware) publicly available XMU/DTD parsers.

In one embodiment, the risk-return module collects and presents data on the valuation of the Treasury Bill (T-Bill) from Wall Street. As more trades occur over the system 200, and more subscribers use the system 200, the data in the risk return module becomes an even more valuable predictor of risk.

The invention also may include a “ticker-tape” visualization of certain data in the risk return module. “Splash” or message screens can be utilized in the beginning of the exchange system 200 operation (i.e., as the data repositories are ramping up). These presentation formats can be used to highlight a certain subset of data points in real-time. Examples of such data include mean trade value, total volume of trades, etc.

The data within the risk-return module will be in a number of file formats, including, for example: flat file (XML), Relational Database Systems (RDBMS), and Object Database Systems (ODBMS). The system utilizes “adapters” to these different data repositories, and reuses them across all data repositories of that type.

VII. Environment

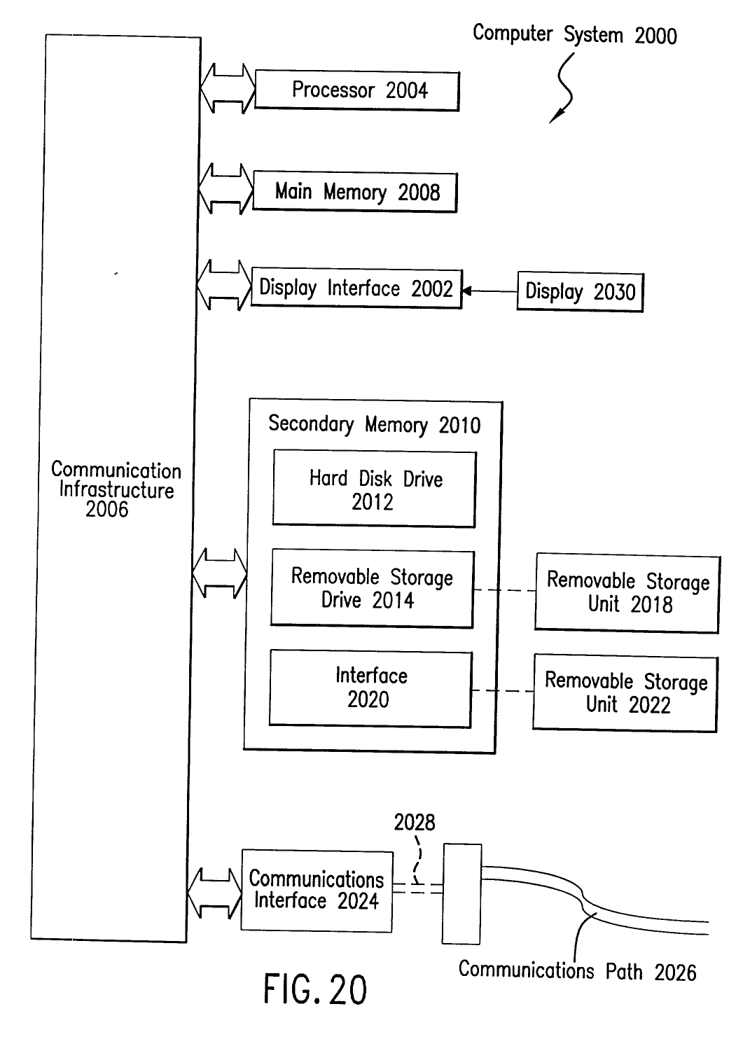

The invention (i.e., exchange system 200 or any part thereof) may be implemented using hardware, software or a combination thereof and may be implemented in a computer system or other processing system. In fact, in one embodiment, the invention is directed toward one or more computer systems capable of carrying out the functionality described herein. An example of a computer system 2000 is shown in FIG. 20. The computer system 2000 includes one or more processors, such as processor 2004. The processor 2004 is connected to a communication infrastructure 2006 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 2000 can include a display interface 2005 that forwards graphics, text, and other data from the communication infrastructure 2002 (or from a frame buffer not shown) for display on the display unit 2030.

Computer system 2000 also includes a main memory 2008, preferably random access memory (RAM), and may also include a secondary memory 2010. The secondary memory 2010 may include, for example, a hard disk drive 2012 and/or a removable storage drive 2014, representing a floppy disk drive, a magnetic tape drive, an optical disk drive, etc. The removable storage drive 2014 reads from and/or writes to a removable storage unit 2018 in a well-known manner. Removable storage unit 2018, represents a floppy disk, magnetic tape, optical disk, etc. which is read by and written to by removable storage drive 2014. As will be appreciated, the removable storage unit 2018 includes a computer usable storage medium having stored therein computer software and/or data.

In alternative embodiments, secondary memory 2010 may include other similar means for allowing computer programs or other instructions to be loaded into computer system 2000. Such means may include, for example, a removable storage unit 2022 and an interface 2020. Examples of such may include a program cartridge and cartridge interface (such as that found in video game devices), a removable memory chip (such as an EPROM, or PROM) and associated socket, and other removable storage units 2022 and interfaces 2020 which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a PCMCIA slot and card, etc. Software and data transferred via communications interface 2024 are in the form of signals 2028 which may be electronic, electromagnetic, optical or other signals capable of being received by communications interface 2024. These signals 2028 are provided to communications interface 2024 via a communications path (i.e., channel) 2026. This channel 2026 carries signals 2028 and may be implemented using wire or cable, fiber optics, a phone line, a cellular phone link, an RF link and other communications channels.

In this document, the terms “computer program medium” and “computer usable medium” are used to generally refer to media such as removable storage drive 2014, a hard disk installed in hard disk drive 2012, and signals 2028. These computer program products are means for providing software to computer system 2000. The invention is directed to such computer program products.

Computer programs (also called computer control logic) are stored in main memory 2008 and/or secondary memory 2010. Computer programs may also be received via communications interface 2024. Such computer programs, when executed, enable the computer system 2000 to perform the features of the invention as discussed herein. In particular, the computer programs, when executed, enable the processor 2004 to perform the features of the invention. Accordingly, such computer programs represent controllers of the computer system 2000.

In an embodiment where the invention is implemented using software, the software may be stored in a computer program product and loaded into computer system 2000 using removable storage drive 2014, hard drive 2012 or communications interface 2024. The control logic (software), when executed by the processor 2004, causes the processor 2004 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

VIII. Data Transformation and Mapping Process

The Data Transformation and Mapping (DTM) process is a method used by exchange systems 200 and 2700 to simplify the transfer of data between the exchange system and subscribers' computer systems. The DTM process allows loan information to be standardized into an Extensible Markup Language (XML) processing format which is a standard maintained by the World Wide Web Consortium (W3C). Before transferring data information back to the user, the DTM process can be used to translate the XML format into a user's predefined format when different from the XML standard. This DTM process eliminates the need for subscribers to create customized adaptations between different subscriber systems. For example, the seller no longer needs any proprietary communications expenditures to do proprietary business with a particular buyer. At the same time, the buyer's receipt of loans from many sellers is simplified and streamlined.

FIG. 25 is a flow diagram illustrating the DTM process and the data flow and formatting between exchange system 2700 and the subscriber. FIG. 25, as illustrated, is an example of flow trading where the exchange system 2700 functions as a correspondent delivery system.

As shown in FIG. 25, a correspondent subscriber uploads loan data into system 2700 in step 2502.

In a step 2504, before the loan data that was input by the correspondent subscriber is forwarded to exchange system 2700, the data undergoes a transformation using the DTM process to ensure that the data is in the correct, standardized processing format for the exchange system. In this transformation, the DTM process takes the individual pieces of loan data and ensures that the position and formatting of the information is in a standardized form. This processing includes the application of a preliminary, standard rules based filter, as discussed further below. For example, in the marketplace, there may be subtle differences in the way that the appraisal value of a property is determined. The DTM process is able to compensate for these differences and standardize loan data entries into a single format, such as XML.

In FIG. 26, the DTM process is illustrated where X, Y, and Z represent various pieces of loan information. For example, assume X=LTV, Y=Social Security Number (entered with dashes), and Z=FICO. For entry into exchange system 2700, it may be necessary to have the X and Z values in a different position, and the Y value displayed without dashes. The DTM process would transform the data in the standardized form as shown in the XML column of FIG. 26. After the loan information has been processed in exchange system 2700, the DTM process sends the data to the Buyer in the XML-format or in the Buyer's predefined format, if preferred by the Buyer.

Returning to FIG. 25, in a step 2506, the XML-formatted data is received and processed by exchange system 2700.

In a step 2508, the processed loan data is again translated using the DTM process into a pre-defined format for a particular buyer, if different from the standard XML format.

In a step 2510, a Rules Based Filter (RBF) is applied to the translated data. The RBF is made up of 2 components: (1) a standard and (2) customized filter. The standard filter component comprises basic logic checks and rules which are established by the exchange system 200. For example, the system may need to determine whether the interest rate been entered with two decimal places. The customized filter component is comprised of user-defined rules or criteria.

In step 2512, the processed and re-formatted (if necessary) loan data is transferred to the buyer. The loan data can then be processed by the buyer using its proprietary backoffice system.

This DTM process and the CDS platform, discussed above with reference to FIG. 28, have several advantages. First, the system shortens the acquisition cycle as data is immediately available for review by a buyer allowing for streamlined processing and faster funding. Second, the system ensures that the transferred data meets the data requirements of the buyer's backoffice systems. Third, the system can automatically validate submitted loan data against the buyer's own defined purchase criteria to ensure that the loans submitted to the buyer meet the buyer's product guidelines prior to delivery. Fourth, the system reduces costs of maintenance and training required at the buyer and seller. Fifth, the system provides reporting and monitoring to track loan volume and quality, thereby improving correspondent management.

The open platform, discussed above with reference to FIG. 28, also has several advantages. For example, the system allows buyers to expand market share and increase loan acquisition opportunities through development of relationships with new sellers. The system also allows sellers to enhance exit strategies for those loans which they have acquired and want to sell.

IX. Subscriber Tools

Various subscriber tools may be provided to the subscriber as enhancements of the present invention. For example, a work flow manager tool may be provided that allows a subscriber to assign, set up, and track tasks that need to be accomplished in, for example, settlement on the sale of a loan. The work flow manager tool may also allow the subscriber to notify each party of the assigned tasks.

Another tool that may be provided to the subscriber is a specialized calculator that allows the subscriber to calculate statistical information on a loan or set of loans selected by the subscriber.

Further, a reporting and data mining tool may be provided to enable subscribers to evaluate market data and decide on which loans to make a bid.

A loan workbench tool may be provided to the subscriber to allow seller to prepare loans for sale before they are posted to the Web site trading platform. The loan workbench will allow any user to press a button to import files containing data (e.g., loan detail data, servicing data, etc.) to the system. This universal import is performed by permitting storage of both common and unique data/file mapping configurations for use by users in either importing data to or exporting data from the system. These maps can support the import of ASCII data in a tab-delimited, comma-delimited, or XML (tagged) format, or support a proprietary file format. Once loans are imported, the user can manipulate groups of loans to create pools. Manipulation tools in the loan workbench include a criteria selection tool, the ability to add and delete members of a pool and the ability to add and edit pool summary information. The system also allows the user to directly edit loan data for loans in the workbench. The system also allows the user to select the fields that they wish to see consistently on the workbench and sort on any visible criteria.

A comparison tool allows a subscriber to compare program matrices of various buyers to determine the best price the subscriber may be able to obtain for a loan or loan pool.

Another tool that may be provided to the subscriber is a credit slotting and automated pricing tool. Currently, buyers of loan(s) have a program matrix that is used to decide whether to purchase a particular loan and a pricing model that is used to decide the pricing for each loan. This matrix includes ranges of criteria, for example, LTV between 105 and 125 and FICO score between 600 and 700. Similarly, the pricing model may include ranges, such as, LTV between 105 and 115 gets one price, and LTV between 116 and 125 gets a different price.

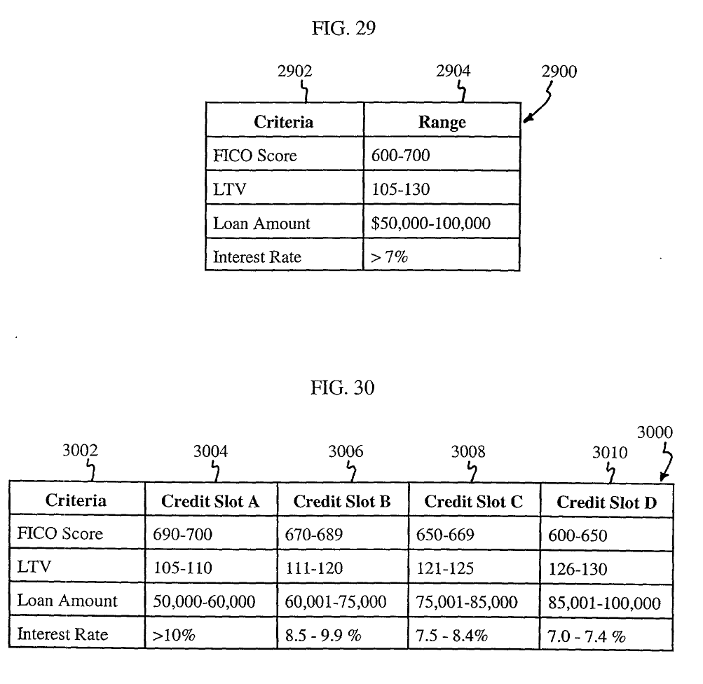

In one embodiment of the invention, the system of the present invention will allow users to set up program matrices using the predefined criteria available on the system. A sample program matrix is shown in FIG. 29. FIG. 29 includes a program matrix 2900 having a column 2902 for criteria, as defined by the user, and another column 2904 for the ranges of values for each criterion that the buyer will accept. The system will compare the loans in a pool against the user-defined criteria to determine which loans in the pool meet the criteria. Then, the buyer, with one action, such as a click of the mouse, can deselect all loans in the pool that fall outside of the user-defined criteria. This allows the user to perform more precise searching and analysis of pools. For example, the user can look for loans falling within a certain range of LTV for borrowers have FICO scores within a particular range.

In another embodiment, a more detailed analysis can be performed on the loan detail information. As shown, for example, in FIG. 30, the system can also perform a credit slotting analysis of the loans in a pool. FIG. 30 shows a chart 3000 having a first column 3002 for criteria, and four additional columns 3004, 3006, 3008 and 3010 for rating the loans as either A, B, C or D loans. The subscriber enters ranges for the values of each criterion for each credit slot. These overall rating of each loan is determined based on a comparison of the loan detail information with the user-defined credit slots. Further, the system allows the user to weight the different criteria. For example, the user may define a loan having an LTV of 110-125 as a B loan, but a loan made to a borrower having a FICO score of 600-610 as an A loan. Thus, the system will compare each loan in a pool with these credit slot criteria and tell the buyer, for example, that 80% of the loans in the pool meet his criteria and that of this 80%, 20% are A loans, 30% are B loans, 20% are C loans and 10% are D loans. If the subscriber weighted the FICO score more heavily than the LTV value, then a loan with an LTV of 115 but a FICO of 610 may be slotted as an A loan. If the two criteria were given equal weight by the subscriber, then the system would default to the least common denominator, and slot the loan as a B loan.

In a further refinement on this analysis, the system can use a decision-making structure, such as fuzzy logic, to provide the user with information on loans containing loan detail information that fell outside of that user's criteria, but that only fell outside a particular range by a small margin. For example, if the user defined the acceptable range of FICO scores as 600-700 and a loan has a borrower with a FICO of 595, the buyer may want to take a closer look at the remaining loan detail to decide whether place a bid to purchase the loan.

Finally, in a further embodiment, the system could attach a pricing engine to the credit slotting chart in order to automatically calculate a recommended price for a pool based on the results of its slotting analysis. In a first step, the system compares the loan detail information to the user-defined criteria and marks each loan with an “S” for select or a “D” for deselect. The selected loans are those loans that meet all of the buyers'criteria. The system then analyzes the selected loans to slot each loan as an A, B, C or D loan, based on user-defined slotting criteria. It would be apparent to one skilled in the art that other categories of loans could be used. For example, the user may define only two classes of loans, i.e. A and B.

Once the loans have been slotted, the system can then calculate a price for each loan by analyzing its rating and loan detail information and comparing that to a pricing model supplied by the buyer. Alternatively, the system could develop its own pricing model based on market information in order to provide the buyer with a recommended price. The system would then total the prices for each loan remaining in the pool to obtain a price for the total pool.

Because the buyer is buying in bulk, the pool price will not be a simple aggregate of the individual loan prices in the pool. Instead, it will be slightly discounted based on volume and other factors. The system can take this discounting into account, based on a system-defined formula or a user-supplied formula. As such, an intelligent agent provided by the system, can calculate a bid for a buyer using the buyer's own criteria and pricing model.

In another feature of this embodiment, the buyer could preauthorize the system to automatically bid on the pool using the calculated pool price or to notify the buyer about the pool and provide him with the calculated price. The buyer could then place a bid on that pool with a simple action.

Further, buyers can create different program types, using different criteria, depending on the type of pool being analyzed. For example, the buyer may have one program to analyze home equity pools and a different program to analyze car loan pools. The buyer may opt to keep these programs and matrices secret so that the buyers cannot view them. Alternatively, the buyer may select to show certain information on the matrices or the entire matrix to the sellers via the system Web site. Sellers can use this matrix information to pre-load their pools with loans that will match a particular buyer's criteria in order to ensure the highest possible price for their pool. Further, the buyer could share all or part of the program publically on the system, for example, posting a message that all members will see when they log on to the Web site, that states that particular buyer's goals for the month and criteria.

Another subscriber tool is a calculator that would allow the subscriber to perform yield calculations in order to place and/or accept a bid. The price of products that are sensitive to market factors such as interest rate are usually based on an index, rather than the absolute value of the product. In the case of loans, the absolute value of the pool would be the aggregation of the unpaid amounts of the loans in the pool. One index that is used to calculate price of loans is the Fannie Mae 30 index. Often bids are quotes in terms of basis points over the Fannie Mae 30. The system of the present invention provides a means for users to calculate a bid price based on the yield that the buyer wants to achieve out of the pool. For example, if the buyer wants a 9% yield on a pool, the buyer would look at the Fannie Mae 30 index, which could be fed into the system from an external service, and calculate what bid he must make in order to meet his yield requirements.

X. Value Added Services

The present invention may include links to several value added services that can be used by the subscriber to facilitate buying or selling a loan. These value added services include, for example, automated underwriting, automated pricing, rate locking, loan product comparison mapping, credit scoring, credit updates, CRA qualification and appraisal updates.

A. Automated Underwriting

Many companies in the business of purchasing loans use an automated underwriting engine which makes decisions on whether to purchase a loan based on predetermined underwriting guidelines. Examples of such decision support engines include, Good Decisions™, a product of GE Capital Mortgage Services, Inc. and AssetWise™, a product RFC Mortgage Services Ltd. In use, the system allows subscribers to select certain loans of interest to check against the decision support engine. Once the loans have been selected, the subscriber clicks or selects a decision support service option on the user interface. A query is then automatically sent to a decision engine resident on the system of the present invention or located on another Web site. The decision engine checks the information for the selected loans against the automated underwriting criteria and renders a decision to the subscriber on whether to purchase the loan. In another embodiment, the subscriber would be able to choose from among a variety of proprietary automated underwriting systems available through links on the exchange system Web site, or the subscriber could select his company's own proprietary automated underwriting engine.

B. Automated Pricing

Similar to the automated underwriting service, the present invention may also provide a value added pricing service to subscribers. This pricing service would automatically calculate the price for a particular loan based the loan data. This service would be helpful to subscribers selling a loan, who are not sure how to price the loan that they wish to post on the system. This service would also be helpful to subscribers interested in buying a loan, who are not sure how much to offer for the loan.

In one embodiment, the system allows subscribers to select certain loans of interest to send to the pricing service. Once the loans have been selected, the subscriber clicks or selects a pricing service option on the user interface. A query is then automatically sent to a pricing engine, either resident on the system of the present invention or linked to another Web site. The pricing engine passes the loan data through a pricing algorithm in order to render a suggested price to the subscriber for each selected loan. Similarly, the pricing service could be used to provide a suggested price on a pool of loans.

C. Rate Locking

The present invention may also provide a rate locking service. In this service, a subscriber can send a loan to a prospective buyer for sale. If the buyer makes an offer to purchase the loan, the rate locking service will allow the subscriber to accept this offer and lock the price on the system.

D. Loan Product Comparison Mapping

The present invention may also provide a loan product comparison mapping service. In this service, a subscriber can compare two different loan products by comparing each loan product to the subscriber's program matrix. In this way, each loan product is mapped against the subscriber's matrix so that the subscriber can more easily compare the different loan products to each other.

E. Credit Scoring/Credit Updates

The present invention may also provide a credit scoring/credit update service. In this service, subscribers can select certain loans of interest. Once the loans have been selected, the subscriber clicks or selects a credit update option on the user interface. A query is then sent a credit service bureau containing up-to-date credit scoring information. This information is then provided, via the system of the present invention, to the subscriber for each of the borrowers on the selected loans. This service may be used before a loan is closed to check the credit score of the loan applicant(s) or it may be used before buying or selling a closed loan to check and update the credit score information for the borrower(s).

F. CRA Qualification

In the case of the value added service for CRA qualification, a link may be provided to allow the subscriber to check to see how many loans in a particular pool are CRA qualifying.

The Community Reinvestment Act (CRA) is a federal regulation which was designed to encourage depository institutions to help meet the credit needs of the communities in which they operate, including low and moderate income neighborhoods. The Act requires that a certain number of loans which meet CRA criteria be acquired each year. The criteria used to determine possible CRA compliance includes: (1) whether the applicant has low or moderate income and the property is within a certain census tract; (2) whether the applicant has low or moderate income only; (3) whether the piece of property is on a particular census tract; and (4) whether neither (1)-(3) are met.

In response to the subscribers' need to comply with the CRA, the present invention may flag those loans which would allow the subscriber to fulfill part of their CRA purchase obligations. An independent, third party may be used by the exchange system to verify that the listed loan has met the federal guidelines and is indeed CRA compliant. The advantage to flagging CRA qualified loans is that it provides a centralized and quick tool for institutions to sell or buy these types of loans.

In one embodiment, the system marks or flags the loans appearing on the system as CRA qualified, if applicable. In another embodiment, the system allows subscribers to select certain loans of interest to check for CRA qualification. Once the loans have been selected, the subscriber clicks or selects a CRA option on the user interface. The query is then automatically sent to a CRA engine, either resident on the system of the present invention or linked on another Web site, which checks the CRA qualifications for the selected loans and returns a response to the subscriber on the status of each loan.

G. Appraisal Updates

Another value added service that may be provided to subscribers on the present invention is an appraisal service. In this service, subscribers can select certain loans of interest. Once the loans have been selected, the subscriber clicks or selects an appraisal option on the user interface. A query is then sent to an appraisal engine and/or database, either resident on the system of the present invention or linked on another Web site, which contains recent appraisal information. Updated appraisal information is then provided to the subscriber for each of the selected loan properties. This service is particularly useful for trading of “seasoned” loans, i.e., loans that were made several years ago such that the value of the underlying property may have changed since the original appraisal date at the time of closing.

XI. Conclusion

While various embodiments of the invention have been described above, it should be understood that they have been presented by way of example, and not limitation. It will be apparent to persons skilled in the relevant art(s) that various changes in form and detail may be made therein without departing from the spirit and scope of the invention. This is especially true in light of technology and terms within the relevant art(s) that may be later developed. Thus the invention should not be limited by any of the above-described exemplary embodiments, but should be defined only in accordance with the following claims and their equivalents.

What is claimed is:

1. A system for trading financial products in the secondary market, the system comprising:
means for receiving loan information for a loan from a subscriber;
means for storing said loan information in a database;
means for receiving from said subscriber a list of individuals to whom notifications of said loan information are to be sent;
means for notifying said individuals on said list that said loan information is available on the system;
means for allowing said individuals to access said loan information via the system;
means for allowing each of said individuals to submit a bid on said loan via the system; and
means for allowing said subscriber to accept one of said bids, wherein a trade is processed when said bid is accepted.

2. The system of claim 1, wherein said first subscriber is selected from the group consisting of at least one of the following: a broker, a mortgage bank correspondent, a servicing company, and a mortgage bank investor.

3. The system of claim 1, wherein said means for allowing each of said individuals to submit a bid further allows each of said individuals to submit a comment on said loan.

4. A system for trading financial products in the secondary market, wherein the system receives and stores loan information submitted by a plurality of sellers, the system comprising:
means for receiving from a subscriber a list of sellers with whom said subscriber wishes to engage in trading;
means for showing said subscriber loan information on loans in the system posted only by those sellers on said subscriber's list; and
means for allowing said subscriber to submit a bid on said loans via the system.

5. A system for evaluating financial products, comprising:
means for receiving loan information for a plurality of loans in a loan pool from a first subscriber;
means for receiving a program matrix including a list of criteria from a second subscriber;
means for comparing said loan information for said loans in said loan pool against said list of criteria in said program matrix;
means for providing results of said comparison to said second subscriber to show which loans in said loan pool meet said second subscriber's criteria.

6. The system of claim 5, wherein said program matrix includes a plurality of credit slots with a list of criteria for each of said credit slots, and wherein said means for providing results shows which loans in said loan pool fall within each of said credit slots.

7. The system of claim 5, wherein said means for comparing uses a decision-making structure to analyze loans that fall outside said list of criteria.

8. The system of claim 5, further comprising:
means for automatically selecting those loans in said loan pool that meet said second subscriber's criteria.

9. The system of claim 5, further comprising:
means for receiving a pricing model from said second subscriber; and
means for automatically pricing said selected loans in said loan pool based on said pricing model.

10. The system of claim 9, wherein said means for automatically pricing said selected loans generates a price based on a discounted aggregate price of each of said selected loans in said loan pool.

11. The system of claim 9, further comprising:
means for automatically submitting a bid on said selected loans in said loan pool based on said automatically generated price.

12. The system of claim 9, wherein said means for automatically pricing uses a yield calculation to generate a price for said selected loans in said loan pool.

13. The system of claim 5, wherein said second subscriber has a different program matrices for different types of loan products.

14. A system for trading servicing rights for loans, comprising:
means for receiving loan information and servicing information for a loan at a first time;
means for storing said loan information and said servicing information for said loan in a database;
means allowing a subscriber to refresh said loan information and said servicing information for said loan at a subsequent time;
means for receiving updated loan information and updated servicing information for said loan; and
means for storing said updated loan information and said updated servicing information for said loan in said database.

15. The system of claim 14, further comprising:
means for providing output of said loan information and said servicing information to a subscriber that shows how said information has changed over time.

16. A system for performing automated due diligence of a loan, comprising:
means for receiving electronic loan detail information for the loan from a subscriber;
means for receiving scanned loan information from loan documentation for the loan;
optical character recognition means for extracting loan detail information from said scanned loan information; and
means for comparing said extracted loan detail information with said electronic loan detail information to identify discrepancies.

17. A system for trading loans, comprising:
means for receiving weighted average loan information for a future loan pool from a first subscriber;
means for allowing a second subscriber to review said future loan pool and submit a bid on said future loan pool; and
means for allowing said first subscriber to accept said bid, wherein a trade is processed when said bid is accepted.
